(19) United States
(12) Patent Application Publication
(10) Pub. No.: US 2005/0023145 A1
(43) Pub. Date: Feb. 3, 2005

(54) Methods and apparatus for forming multi-layer structures using adhered masks

(75) Inventors: Adam L. Cohen, Los Angeles, CA (US); Jill R. Thomassian, Los Angeles, CA (US); Michael S. Lockard, Lake Elizabeth, CA (US); Marvin M. Kilgo III, Oakland, CA (US); Uri Frodis, Los Angeles, CA (US); Dennis R. Smalley, Newhall, CA (US)

Correspondence Address: MICROFABRICA INC.;DENNIS R. SMALLEY, 1103 W. ISABEL ST., BURBANK, CA, 91506, US

(73) Assignee: Microfabrica Inc.

(21) Appl. No.: 10/841,272

(22) Filed: May 7, 2004

Related U.S. Application Data
(60) Provisional application No. 60/468,741, filed on May 7, 2003.
(60) Provisional application No. 60/474,625, filed on May 29, 2003.

(51) Int. Cl. C25D 5/02; A01N 25/34

(52) U.S. Cl. 205/118; 205/135

(57) ABSTRACT

Numerous electrochemical fabrication methods and apparatus are provided for producing multi-layer structures (e.g. having meso-scale or micro-scale features) from a plurality of layers of deposited materials using adhered masks (e.g. formed from liquid photoresist or dry film), where two or more materials may be provided per layer where at least one of the materials is a structural material and one or more of any other materials may be a sacrificial material which will be removed after formation of the structure. Materials may comprise conductive materials that are electrodeposited or deposited in an electroless manner. In some embodiments special care is undertaken to ensure alignment between patterns formed on successive layers.

### RELATED APPLICATIONS

This application claims benefit of U.S. Provisional Application Nos. 60/468,741 and 60/474,625 filed on May 7, 2003 and May 29, 2003, respectively. These referenced applications are hereby incorporated herein by reference as is set forth in full herein.

### FIELD OF THE INVENTION

Embodiments of the invention relate generally to the field of electrochemical fabrication and the associated formation of three-dimensional structures (e.g. microscale or mesoscale structures). In particular, they relate to the formation of such structures using patterned masks that are temporarily adhered to substrates or to previously formed deposits that may be used for performing selective patterning of or on the substrates or previously deposited material.

### BACKGROUND OF THE INVENTION

A technique for forming three-dimensional structures (e.g. parts, components, devices, and the like) from a plurality of adhered layers was invented by Adam L. Cohen and is known as Electrochemical Fabrication. It is being commercially pursued by Microfabrica™ Inc. (formerly MEMGen® Corporation) of Burbank, Calif. under the name EFAB®. This technique was described in U.S. Pat. No. 6,027,630, issued on Feb. 22, 2000. This electrochemical deposition technique allows the selective deposition of a material using a unique masking technique that involves the use of a mask that includes patterned conformable material on a support structure that is independent of the substrate onto which plating will occur. When desiring to perform an electrodeposition using the mask, the conformable portion of the mask is brought into contact with a substrate while in the presence of a plating solution such that the contact of the conformable portion of the mask to the substrate inhibits deposition at selected locations. For convenience, these masks might be generically called conformable contact masks; the masking technique may be generically called a conformable contact mask plating process. More specifically, in the terminology of Microfabrica™ Inc. (formerly MEMGen® Corporation) of Burbank, Calif. such masks have come to be known as INSTANT MASKS™ and the process known as INSTANT MASKING or INSTANT MASK™ plating. Selective depositions using conformable contact mask plating may be used to form single layers of material or may be used to form multi-layer structures. The teachings of the '630 patent are hereby incorporated herein by reference as if set forth in full herein.

Since the filing of the patent application that led to the above noted patent, various papers about conformable contact mask plating (i.e. INSTANT MASKING) and electrochemical fabrication have been published:
(1) A. Cohen, G. Zhang, F. Tseng, F. Mansfeld, U. Frodis and P. Will, “EFAB: Batch production of functional, fully-dense metal parts with micro-scale features”, Proc. 9th Solid Freeform Fabrication, The University of Texas at Austin, p161, August 1998.
(2) A. Cohen, G. Zhang, F. Tseng, F. Mansfeld, U. Frodis and P. Will, “EFAB: Rapid, Low-Cost Desktop Micromachining of High Aspect Ratio True 3-D MEMS”, Proc. 12th IEEE Micro Electro Mechanical Systems Workshop, IEEE, p244, January 1999.
(3) A. Cohen, “3-D Micromachining by Electrochemical Fabrication”, Micromachine Devices, March 1999.
(4) G. Zhang, A. Cohen, U. Frodis, F. Tseng, F. Mansfeld, and P. Will, “EFAB: Rapid Desktop Manufacturing of True 3-D Microstructures”, Proc. 2nd International Conference on Integrated MicroNanotechnology for Space Applications, The Aerospace Co., April 1999.
(5) F. Tseng, U. Frodis, G. Zhang, A. Cohen, F. Mansfeld, and P. Will, “EFAB: High Aspect Ratio, Arbitrary 3-D Metal Microstructures using a Low-Cost Automated Batch Process”, 3rd International Workshop on High Aspect Ratio MicroStructure Technology (HARMST'99), June 1999.
(6) A. Cohen, U. Frodis, F. Tseng, G. Zhang, F. Mansfeld, and P. Will, “EFAB: Low-Cost, Automated Electrochemical Batch Fabrication of Arbitrary 3-D Microstructures”, Micromachining and Microfabrication Process Technology, SPIE 1999 Symposium on Micromachining and Microfabrication, September 1999.
(7) F. Tseng, G. Zhang, U. Frodis, A. Cohen, F. Mansfeld, and P. Will, “EFAB: High Aspect Ratio, Arbitrary 3-D Metal Microstructures using a Low-Cost Automated Batch Process”, MEMS Symposium, ASME 1999 International Mechanical Engineering Congress and Exposition, November, 1999.
(8) A. Cohen, “Electrochemical Fabrication (EFABTM)”, Chapter 19 of The MEMS Handbook, edited by Mohamed Gad-El-Hak, CRC Press, 2002.
(9) “Microfabrication—Rapid Prototyping's Killer Application”, pages 1-5 of the Rapid Prototyping Report, CAD/CAM Publishing, Inc., June 1999.

The disclosures of these nine publications are hereby incorporated herein by reference as if set forth in full herein.

The electrochemical deposition process may be carried out in a number of different ways as set forth in the above patent and publications. In one form, this process involves the execution of three separate operations during the formation of each layer of the structure that is to be formed:
1. Selectively depositing at least one material by electrodeposition upon one or more desired regions of a substrate.
2. Then, blanket depositing at least one additional material by electrodeposition so that the additional deposit covers both the regions that were previously selectively deposited onto, and the regions of the substrate that did not receive any previously applied selective depositions.
3. Finally, planarizing the materials deposited during the first and second operations to produce a smoothed surface of a first layer of desired thickness having at least one region containing the at least one material and at least one region containing at least the one additional material.

After formation of the first layer, one or more additional layers may be formed adjacent to the immediately preceding layer and adhered to the smoothed surface of that preceding layer. These additional layers are formed by repeating the first through third operations one or more times wherein the formation of each subsequent layer treats the previously formed layers and the initial substrate as a new and thickening substrate.

Once the formation of all layers has been completed, at least a portion of at least one of the materials deposited is generally removed by an etching process to expose or release the three-dimensional structure that was intended to be formed.

The preferred method of performing the selective electrodeposition involved in the first operation is by conformable contact mask plating. In this type of plating, one or more conformable contact (CC) masks are first formed. The CC masks include a support structure onto which a patterned conformable dielectric material is adhered or formed. The conformable material for each mask is shaped in accordance with a particular cross-section of material to be plated. At least one CC mask is needed for each unique cross-sectional pattern that is to be plated.

The support for a CC mask is typically a plate-like structure formed of a metal that is to be selectively electroplated and from which material to be plated will be dissolved. In this typical approach, the support will act as an anode in an electroplating process. In an alternative approach, the support may instead be a porous or otherwise perforated material through which deposition material will pass during an electroplating operation on its way from a distal anode to a deposition surface. In either approach, it is possible for CC masks to share a common support, i.e. the patterns of conformable dielectric material for plating multiple layers of material may be located in different areas of a single support structure. When a single support structure contains multiple plating patterns, the entire structure is referred to as the CC mask while the individual plating masks may be referred to as “submasks”. In the present application such a distinction will be made only when relevant to a specific point being made.

In preparation for performing the selective deposition of the first operation, the conformable portion of the CC mask is placed in registration with and pressed against a selected portion of the substrate (or onto a previously formed layer or onto a previously deposited portion of a layer) on which deposition is to occur. The pressing together of the CC mask and substrate occur in such a way that all openings, in the conformable portions of the CC mask contain plating solution. The conformable material of the CC mask that contacts the substrate acts as a barrier to electrodeposition while the openings in the CC mask that are filled with electroplating solution act as pathways for transferring material from an anode (e.g. the CC mask support) to the non-contacted portions of the substrate (which act as a cathode during the plating operation) when an appropriate potential and/or current are supplied.

An example of a CC mask and CC mask plating are shown in FIGS. 1(a)-1(c). FIG. 1(a) shows a side view of a CC mask 508 consisting of a conformable or deformable (e.g. elastomeric) insulator 510 patterned on an anode 512. The anode has two functions. FIG. 1(a) also depicts a substrate 506 separated from mask 508. One is as a supporting material for the patterned insulator 510 to maintain its integrity and alignment since the pattern may be topologically complex (e.g., involving isolated “islands” of insulator material). The other function is as an anode for the electroplating operation. CC mask plating selectively deposits material 522 onto a substrate 506 by simply pressing the insulator against the substrate then electrodepositing material through apertures 526a and 526b in the insulator as shown in FIG. 1(b). After deposition, the CC mask is separated, preferably non-destructively, from the substrate 506 as shown in FIG. 1(c). The CC mask plating process is distinct from a “through-mask” plating process in that in a through-mask plating process the separation of the masking material from the substrate would occur destructively. As with through-mask plating, CC mask plating deposits material selectively and simultaneously over the entire layer. The plated region may consist of one or more isolated plating regions where these isolated plating regions may belong to a single structure that is being formed or may belong to multiple structures that are being formed simultaneously. In CC mask plating as individual masks are not intentionally destroyed in the removal process, they may be usable in multiple plating operations.

Another example of a CC mask and CC mask plating is shown in FIGS. 1(d)-1(f). FIG. 1(d) shows an anode 512′ separated from a mask 508′ that includes a patterned conformable material 510′ and a support structure 520. FIG. 1(d) also depicts substrate 506 separated from the mask 508′. FIG. 1(e) illustrates the mask 508′ being brought into contact with the substrate 506. FIG. 1(f) illustrates the deposit 522′ that results from conducting a current from the anode 512′ to the substrate 506. FIG. 1(g) illustrates the deposit 522′ on substrate 506 after separation from mask 508′. In this example, an appropriate electrolyte is located between the substrate 506 and the anode 512′ and a current of ions coming from one or both of the solution and the anode are conducted through the opening in the mask to the substrate where material is deposited. This type of mask may be referred to as an anodeless INSTANT MASK™ (AIM) or as an anodeless conformable contact (ACC) mask.

Unlike through-mask plating, CC mask plating allows CC masks to be formed completely separate from the fabrication of the substrate on which plating is to occur (e.g. separate from a three-dimensional (3D) structure that is being formed). CC masks may be formed in a variety of ways, for example, a photolithographic process may be used. All masks can be generated simultaneously, prior to structure fabrication rather than during it. This separation makes possible a simple, low-cost, automated, self-contained, and internally-clean “desktop factory” that can be installed almost anywhere to fabricate 3D structures, leaving any required clean room processes, such as photolithography to be performed by service bureaus or the like.

An example of the electrochemical fabrication process discussed above is illustrated in FIGS. 2(a)-2(f). These figures show that the process involves deposition of a first material 502 which is a sacrificial material and a second material 504 which is a structural material. The CC mask 508, in this example, includes a patterned conformable material (e.g. an elastomeric dielectric material) 510 and a support 512 which is made from deposition material 502. The conformal portion of the CC mask is pressed against substrate 506 with a plating solution 514 located within the openings 516 in the conformable material 510. An electric current, from power supply 518, is then passed through the plating solution 514 via (a) support 512 which doubles as an anode and (b) substrate 506 which doubles as a cathode. FIG. 2(a), illustrates that the passing of current causes material 502 within the plating solution and material 502 from the anode 512 to be selectively transferred to and plated on the cathode 506. After electroplating the first deposition material 502 onto the substrate 506 using CC mask 508, the CC mask 508 is removed as shown in FIG. 2(b). FIG. 2(c) depicts the second deposition material 504 as having been blanket-deposited (i.e. non-selectively deposited) over the previously deposited first deposition material 502 as well as over the other portions of the substrate 506. The blanket deposition occurs by electroplating from an anode (not shown), composed of the second material, through an appropriate plating solution (not shown), and to the cathode/substrate 506. The entire two-material layer is then planarized to achieve precise thickness and flatness as shown in FIG. 2(d). After repetition of this process for all layers, the multi-layer structure 520 formed of the second material 504 (i.e. structural material) is embedded in first material 502 (i.e. sacrificial material) as shown in FIG. 2(e). The embedded structure is etched to yield the desired device, i.e. structure 520, as shown in FIG. 2(f).

Various components of an exemplary manual electrochemical fabrication system 532 are shown in FIGS. 3(a)-3(c). The system 532 consists of several subsystems 534, 536, 538, and 540. The substrate holding subsystem 534 is depicted in the upper portions of each of FIGS. 3(a) to 3(c) and includes several components: (1) a carrier 548, (2) a metal substrate 506 onto which the layers are deposited, and (3) a linear slide 542 capable of moving the substrate 506 up and down relative to the carrier 548 in response to drive force from actuator 544. Subsystem 534 also includes an indicator 546 for measuring differences in vertical position of the substrate which may be used in setting or determining layer thicknesses and/or deposition thicknesses. The subsystem 534 further includes feet 568 for carrier 548 which can be precisely mounted on subsystem 536.

The CC mask subsystem 536 shown in the lower portion of FIG. 3(a) includes several components: (1) a CC mask 508 that is actually made up of a number of CC masks (i.e. submasks) that share a common support/anode 512, (2) precision X-stage 554, (3) precision Y-stage 556, (4) frame 572 on which the feet 568 of subsystem 534 can mount, and (5) a tank 558 for containing the electrolyte 516. Subsystems 534 and 536 also include appropriate electrical connections (not shown) for connecting to an appropriate power source for driving the CC masking process.

The blanket deposition subsystem 538 is shown in the lower portion of FIG. 3(b) and includes several components: (1) an anode 562, (2) an electrolyte tank 564 for holding plating solution 566, and (3) frame 574 on which the feet 568 of subsystem 534 may sit. Subsystem 538 also includes appropriate electrical connections (not shown) for connecting the anode to an appropriate power supply for driving the blanket deposition process.

The planarization subsystem 540 is shown in the lower portion of FIG. 3(c) and includes a lapping plate 552 and associated motion and control systems (not shown) for planarizing the depositions.

In addition to teaching the use of CC masks for electrodeposition purposes, the '630 patent also teaches that the CC masks may be placed against a substrate with the polarity of the voltage reversed and material may thereby be selectively removed from the substrate. It indicates that such removal processes can be used to selectively etch, engrave, and polish a substrate, e.g., a plaque.

The '630 patent further indicates that the electroplating methods and articles disclosed therein allow fabrication of devices from thin layers of materials such as, e.g., metals, polymers, ceramics, and semiconductor materials. It further indicates that although the electroplating embodiments described therein have been described with respect to the use of two metals, a variety of materials, e.g., polymers, ceramics and semiconductor materials, and any number of metals can be deposited either by the electroplating methods therein, or in separate processes that occur throughout the electroplating method. It indicates that a thin plating base can be deposited, e.g., by sputtering, over a deposit that is insufficiently conductive (e.g., an insulating layer) so as to enable subsequent electroplating. It also indicates that multiple support materials (i.e. sacrificial materials) can be included in the electroplated element allowing selective removal of the support materials.

Another method for forming microstructures from electroplated metals (i.e. using electrochemical fabrication techniques) is taught in U.S. Pat. No. 5,190,637 to Henry Guckel, entitled “Formation of Microstructures by Multiple Level Deep X-ray Lithography with Sacrificial Metal layers”. This patent teaches the formation of metal structure utilizing mask exposures. A first layer of a primary metal is electroplated onto an exposed plating base to fill a void in a photoresist, the photoresist is then removed and a secondary metal is electroplated over the first layer and over the plating base. The exposed surface of the secondary metal is then machined down to a height which exposes the first metal to produce a flat uniform surface extending across the both the primary and secondary metals. Formation of a second layer may then begin by applying a photoresist layer over the first layer and then repeating the process used to produce the first layer. The process is then repeated until the entire structure is formed and the secondary metal is removed by etching. The photoresist is formed over the plating base or previous layer by casting and the voids in the photoresist are formed by exposure of the photoresist through a patterned mask via X-rays or UV radiation.

Further teachings concerning the formation of microstructures from electroplated metals (i.e. using electrochemical fabrication techniques) is taught in U.S. Pat. No. 5,718,618 by Henry Guckel, entitled “Lapping and Polishing Method and Apparatus for Planarizing Photoresist and Metal Microstructure Layers”. This patent teaches a method and apparatus for planarizing photoresist and/or metal microstructure layers. Planarization is achieved by removing material from a workpiece by lapping using a diamond containing lapping slurry. A lapping machine is furnished with a lapping plate made of a soft metal material. The lapping plate is furnished with ridges of controlled height using a diamond conditioning ring with a specified grit size. Free diamonds in a liquid slurry are then sprayed onto the plate and embedded therein by a second conditioning ring. After the lapping plate is conditioned, the piece to be lapped is mounted on the lapping plate. A vacuum hold fixture or flat steel or glass mounting plate may be used. During lapping, additional diamond slurry is sprayed onto the lapping plate and driven into the plate by a ceramic conditioning ring. The size of diamonds in the diamond slurry is selected to control the shear forces applied to the surface being lapped and to achieve a desired surface finish. Polishing, using a cloth covered hard metal polishing plate and loose diamond slurry, may be employed after lapping to provide a smooth optical surface finish. The lapping and polishing method and apparatus described may be used for z-dimension height control, re-planarization, and surface finishing of precise single or multiple level photoresist-metal layers, or of individual preformed photoresist sheets or laminates thereof.

Further teachings concerning the formation of microstructures from electroplated metals is taught in U.S. Pat. Nos. 5,378,583, 5,496,668, and 5,576,147 by Henry Guckel, and each entitled “Formation of Microstructures Using a Preformed Photoresist Sheet”. These patents teach the formation of microstructures using a preformed sheet of photoresist, such as polymethylmethacrylate (PMMA), which is strain free, and that may be milled down before or after adherence to a substrate to a desired thickness. The photoresist is patterned by exposure through a mask to radiation, such as X-rays, and developed using a developer to remove the photoresist material which has been rendered susceptible to the developer. Micrometal structures may be formed by electroplating metal into the areas from which the photoresist has been removed. The photoresist itself may form useful microstructures, and can be removed from the substrate by utilizing a release layer between the substrate and the preformed sheet which can be removed by a remover which does not affect the photoresist. Multiple layers of patterned photoresist can be built up to allow complex three dimensional microstructures to be formed.

Further teachings concerning the formation of microstructures from electroplated metals (i.e. using electrochemical fabrication techniques) is taught in U.S. patent (Another method for forming microstructures from electroplated metals (i.e. using electrochemical fabrication techniques) is taught in U.S. Pat. Nos. 5,866,281 and 5,908,719 by Henry Guckel, both entitled “Alignment Method for Multi-Level Deep X-Ray Lithography Utilizing Alignment Holes and Posts”. These patents teach a procedure for achieving accurate alignment between an X-ray mask and a device substrate for the fabrication of multi-layer microstructures. A first photoresist layer on the substrate is patterned by a first X-ray mask to include first alignment holes along with a first layer microstructure pattern. Mask photoresist layers are attached to second and subsequent masks that are used to pattern additional photoresist layers attached to the microstructure device substrate. The mask photoresist layers are patterned to include mask alignment holes that correspond in geometry to the first alignment holes in the first photoresist layer on the device substrate. Alignment between a second mask and the first photoresist layer is achieved by assembly of the second mask onto the first photoresist layer using alignment posts placed in the first alignment holes in the first photoresist layer that penetrate into the mask alignment holes in the mask photoresist layers. The alignment procedure is particularly applicable to the fabrication of multi-layer metal microstructures using deep X-ray lithography and electroplating. The alignment procedure may be extended to multiple photoresist layers and larger device heights using spacer photoresist sheets between subsequent masks and the first photoresist layer that are joined together using alignment posts.

Even though electrochemical fabrication methods as taught and practiced to date, have greatly enhanced the capabilities of microfabrication, and in particular added greatly to the number of metal layers that can be incorporated into a structure, electrochemical fabrication can still benefit from improved methods and apparatus for forming multi-layer structures.

### SUMMARY OF THE DISCLOSURE

It is an object of some aspects of the invention to provide enhanced masking materials for use in electrochemically fabricating multi-layer structures.

It is an object of some aspects of the invention to provide enhanced techniques for electrochemically fabricating multi-layer structures that include more than two materials on at least some layers.

It is an object of some aspects of the invention to reduce costs of electrochemically fabricating multi-layer structures.

It is an object of some aspects of the invention to provide more reliable electrochemically fabricated multi-layer structures.

It is an object of some aspects of the invention to provide electrochemically fabricated multi-layer structures having improved structural properties.

It is an object of some aspects of the invention to reduce the fabrication time of producing electrochemically fabricated multi-layer structures.

Other objects and advantages of various aspects of the invention will be apparent to those of skill in the art upon review of the teachings herein. The various aspects of the invention, set forth explicitly herein or otherwise ascertained from the teachings herein, may address any one of the above objects alone or in combination, or alternatively it may not address any of the objects set forth above but instead address some other object of the invention which may be ascertained from the teachings herein. It is not intended that all of these objects be addressed by any single aspect of the invention even though that may be the case with regard to some aspects.

In a first aspect of the invention a process for forming a multilayer three-dimensional structure, comprising: (a) forming and adhering a layer of material to a substrate or previously formed layer; and (b) repeating the forming and adhering operation of (a) a plurality of times to build up a three-dimensional structure from a plurality of adhered layers, where successive layers are adhered to previously formed layers; wherein the formation of at least one layer comprises: (i) forming and adhering a desired pattern of masking material on the substrate or previously formed layer, wherein the patterning of the masking material results in at least one void in the material that exposes a portion of the substrate or of a previously formed layer; (ii) depositing a conductive material into the at least one void in the masking material; and wherein the masking material comprises a dry film photoresist.

In a second aspect of the invention a carrier for holding a substrate, the carrier including a carrier body being perforated by at least one aperture formed through the carrier body, wherein the substrate is bonded to the carrier body by a material formed in the at least one aperture.

In a third aspect of the invention a carrier for holding a substrate during formation of at least one layer of material on the substrate, the carrier including a carrier body having a fixed reference surface for controlling a thickness of the at least one layer of material formed on the substrate.

In a fourth aspect of the invention a carrier for holding a substrate during formation of one or more layers of material on the substrate, the carrier including a carrier body having a surface that provides a reference for measuring a thickness of the one or more layers of material formed on the substrate.

In a fifth aspect of the invention a system for electrodepositing layers of material on a substrate, the system including: an electrodeposition tank having electrodeposition bath therein; a carrier acting as a first electrode having a first polarity, the carrier having a carrier body to which the substrate is electrically connected, the substrate being immersed in the electrodeposition tank; a second electrode having a second polarity opposite from the first polarity, the second electrode being immersed in the electrodeposition tank; and a power source electrically connected to the carrier and the second electrode such that material from the second electrode is electrodeposited onto the substrate through the electrodeposition bath.

In a sixth aspect of the invention a system for controlling thickness of layers formed on a substrate, including: a carrier for holding the substrate during formation of one or more layers of material on the substrate, the carrier including a carrier body having a surface that provides a reference for measuring a thickness of the one or more layers of material formed on the substrate; and a planarization fixture for supporting the carrier body during planarization of the one or more layers of material, the planarization fixture having at least one surface adapted to mate with the reference surface of the carrier body such that surfaces of the one or more layers of material formed on the substrate are parallel to the reference surface after planarization.

In a seventh aspect of the invention a method for forming one or more layers of material on a substrate, including providing a carrier for holding the substrate during formation of the one or more layers of material on the substrate, the carrier including a carrier body having a surface providing a reference for measuring a thickness of the one or more layers of material formed on the substrate.

In an eighth aspect of the invention a method for forming one or more layers of material on a layer formation surface of a substrate, including providing a carrier for holding the substrate during formation of the one or more layers, the carrier including a carrier body having a surface that is substantially coplanar with the layer formation surface.

In a ninth aspect of the invention an imaging system for target alignment, including: a first imaging device for focusing on a first target to produce a first image; a second imaging device for focusing on a second target to produce a second image; and means for comparing the first and second images to determine a degree of misalignment between the first and second targets.

In a tenth aspect of the invention a method for aligning targets, including: providing a first imaging device for focusing on a first target to produce a first image; providing a second imaging device for focusing on a second target to produce a second image; and comparing the first and second images to determine a degree of misalignment between the first and second targets.

In an eleventh aspect of the invention a method for determining a priority for forming a sacrificial material and a structural material on a substrate, including: (a) analyzing features to be formed on the substrate; (b) determining whether a feature to be formed on the substrate has a predefined characteristic; (c) determining whether a feature determined in (b) to have the predefined characteristic is a positive feature or a negative feature; (d) forming the structural material first if it is determined in (c) that the feature is a negative feature; and (e) forming the sacrificial material first if it is determined in (c) that the feature is a positive feature.

In a twelfth aspect of the invention a method for forming both small positive and negative features in the same layer of a substrate, including: (a) depositing a first patternable mold material on the layer; (b) patterning the first patternable mold material to form a first pattern; (c) depositing a first material in the first pattern formed in (b); (d) removing the first patternable mold material to expose areas of the layer not having the first material deposited thereon; (e) depositing a second patternable mold material over the layer; (f) patterning the second patternable mold material to form a second pattern; (g) depositing a second material in the second pattern formed in (f); (h) removing the second patternable mold material to expose areas of the layer not having the first or second materials deposited thereon; (i) blanket depositing the first material over the second material and the exposed areas of the layer; and (j) planarizing the layer.

In a thirteenth aspect of the invention a method for forming more than two materials on the same layer, including: (a) depositing a first patternable mold material on the layer; (b) patterning the first patternable mold material to form a first pattern; (c) depositing a first material in the first pattern formed in (b); (d) removing the first patternable mold material to expose areas of the layer not having the first material deposited thereon; (e) depositing a second patternable mold material over the layer; (f) patterning the second patternable mold material to form a second pattern; (g) depositing a second material in the second pattern formed in (f); (h) removing the second patternable mold material to expose areas of the layer not having the first or second materials deposited thereon; (i) blanket depositing a third material over the second material and the exposed areas of the layer; and (j) planarizing the layer.

In a fourteenth aspect of the invention a method for forming more than two materials on the same layer wherein two or more different materials are adjacent to each other, including: (a) depositing a first patternable mold material on the layer; (b) patterning the first patternable mold material to form a first pattern; (c) depositing a first material in the first pattern formed in (b); (d) removing the first patternable mold material to expose areas of the layer not having the first material deposited thereon; (e) depositing a second patternable mold material over the layer; (f) patterning the second patternable mold material to form a second pattern, the second pattern including an aperture adjacent to the first material and exposing a top portion of the first material; (g) depositing a second material in the second pattern formed in (f) and over the exposed top portion of the first material; (h) removing the second patternable mold material to expose areas of the layer not having the first or second materials deposited thereon; (i) blanket depositing a third material over the first and second materials and over the exposed areas of the layer; and (j) planarizing the layer.

In a fifteenth aspect of the invention a method for forming more than two materials on the same layer wherein two or more different materials are adjacent to each other, including: (a) depositing a first patternable mold material on the layer; (b) patterning the first patternable mold material to form a first pattern; (c) depositing a first material in the first pattern formed in (b); (d) depositing a second patternable mold material over the first material and the first patternable mold material; (e) patterning the first and second patternable mold materials to form a second pattern, the second pattern including an aperture adjacent to the first material and exposing a top portion of the first material; (f) depositing a second material in the second pattern formed in (e) and over the exposed top portion of the first material; (g) removing the first and second patternable mold materials to expose areas of the layer not having the first or second materials deposited thereon; (h) blanket depositing a third material over the first and second materials and over the exposed areas of the layer; and (i) planarizing the layer.

In a sixteenth aspect of the invention a method for forming more than two materials on the same layer wherein two or more different materials are adjacent to each other, including: (a) depositing a patternable mold material on the layer; (b) patterning the patternable mold material a first time to form a first pattern; (c) depositing a first material in the first pattern formed in (b); (d) patterning the patternable mold material a second time to form a second pattern, the second pattern including an aperture adjacent to the first material; (e) depositing a second material in the second pattern formed in (d); (f) removing the patternable mold material to expose areas of the layer not having the first or second materials deposited thereon; (g) blanket depositing a third material over the first and second materials and over the exposed areas of the layer; and (h) planarizing the layer.

In a seventeenth aspect of the invention a method for forming more than two materials on the same layer wherein two or more different materials are adjacent to each other, including: (a) forming an ablatable material on the layer; (b) ablating the ablatable material a first time to form a first pattern; (c) depositing a first material in the first pattern formed in (b); (d) ablating the ablatable material a second time to form a second pattern, the second pattern including an aperture adjacent to the first material and exposing a top portion of the first material; (e) depositing a second material in the second pattern formed in (d) and over the exposed top portion of the first material; (f) removing the ablatable material to expose areas of the layer not having the first or second materials deposited thereon; (g) blanket depositing a third material over the first and second materials and over the exposed areas of the layer; and (h) planarizing the layer.

In an eighteenth aspect of the invention a method for forming more than two materials on the same layer wherein two or more different materials are adjacent to each other, including: (a) depositing a first patternable mold material on the layer; (b) patterning the first patternable mold material to form a first pattern; (c) depositing a first material in the first pattern formed in (b); (d) depositing a second patternable mold material over the first material and the first patternable mold material; (e) patterning the first and second patternable mold materials to form a second pattern, the second pattern including an aperture adjacent to the first material and exposing a top portion of the first material.

In a nineteenth aspect of the invention a method for preparing a layer having formed thereon a feature consisting of a first material for deposition of a second material adjacent to the first material, including: (a) depositing a patternable mold material over the first material; and (b) patterning the patternable mold material to form an aperture adjacent to the first material, the aperture exposing a side portion and a top portion of the first material.

In a twentieth aspect of the invention a method for forming an alignment target on a substrate, including: forming a first patternable mold material on the substrate; patterning the first patternable mold material to form a first aperture; forming a first material in the first aperture to form an alignment target within the first aperture; removing the first patternable mold material; forming a second patternable mold material on the substrate so as to cover the alignment target; and forming the second patternable mold material to form a second aperture wider than and fully enclosing the alignment target.

In a twenty-first aspect of the invention a method for forming an alignment target, including: providing a substrate having a non-conductive surface; forming a conductive layer over the non-conductive surface; and forming a target portion of the conductive layer such that the target portion is electrically isolated from the remainder of the conductive layer by the non-conductive surface.

In a twenty-second aspect of the invention an alignment target formed from a conductive layer deposited on a non-conductive surface of a substrate such that the alignment target is electrically isolated from the remainder of the conductive layer by the non-conductive surface.

In a twenty-third aspect of the invention a method for forming an alignment target, including: providing a substrate; forming a non-conductive material on a portion of a surface of the substrate; forming a conductive layer over the non-conductive material; and forming a target portion of the conductive layer such that the target portion is electrically isolated from the remainder of the conductive layer by the non-conductive material.

In a twenty-fourth aspect of the invention a method for electroplating a layer of material on a substrate, including: forming a conductive layer over a non-conductive surface of the substrate; forming a target in the conductive layer such that the target is electrically isolated from the remainder of the conductive layer by the non-conductive surface of the substrate; and electroplating the layer of material over the conductive layer such that the conductive layer is plated and the target is un-plated.

In a twenty-fifth aspect of the invention a method for patterning odd and even layers of patternable material formed sequentially on a substrate, including: patterning the odd layers using first photomasks having a first layout of alignment shapes and new target shapes, the first layout having a first orientation relative to the substrate; and patterning the even layers using second photomasks having a second layout of alignment shapes and new target shapes, the second layout having a second orientation relative to the substrate different from the first orientation.

In a twenty-sixth aspect of the invention a photomask used in patterning layers on a substrate, the photomask including a plurality of patterns for a corresponding plurality of layers to be patterned on the substrate, at least two of the plurality of patterns having orientations different from each other relative to an orientation of the substrate, each of the different orientations being alignable with the orientation of the substrate.

In a twenty-seventh aspect of the invention a method for selecting a patternable mold material used in patterning a layer formed on a substrate, including: (a) analyzing geometrical characteristics of features to be formed on the layer; and (b) selecting a patternable mold material for patterning the layer based on the results of the analysis performed in (a).

In a twenty-eighth aspect of the invention a method for forming layers on a substrate, including: providing a first patternable mold material of a first type to be used in forming a first layer on the substrate; and providing a second patternable mold material of a second type used in forming a second layer on the substrate.

In a twenty-ninth aspect of the invention a template for carrying a substrate having layers formed thereon, the template including an upper surface with an aperture formed therein for receiving the substrate such that an uppermost layer formed on the substrate is substantially flush with the upper surface.

In a thirtieth aspect of the invention a method for laminating layers formed on a substrate, including providing a template for carrying through a laminator a substrate having layers formed thereon to be laminated, the template including an upper surface with an aperture formed therein for receiving the substrate.

In a thirty-first aspect of the invention a method for laminating layers formed on a substrate using a laminator, including: (a) determining a thermal mass of the layers formed on the substrate; and (b) adjusting parameters of the laminator based the thermal mass determined in (a).

In a thirty-second aspect of the invention a method for forming layers on a substrate, including: forming a first layer of a patternable mold material on the substrate; forming at least one additional layer of the patternable mold material on the first layer; and patterning the first layer and the at least one additional layer.

In a thirty-third aspect of the invention a method for forming layers on a substrate, including: forming a layer of dry film resist having a first thickness on a substrate; and thinning the layer such that the layer has a second thickness less than the first thickness.

In a thirty-fourth aspect of the invention a method for fabricating a multi-layer structure, including patterning at least one layer of the multi-layer structure using a dry film resist.

In a thirty-fifth aspect of the invention a method for fabricating a Microelectromechanical System (MEMS), including patterning at least one layer used to fabricate the Microelectromechanical System (MEMS) using a dry film resist.

In a thirty-sixth aspect of the invention a method for forming on a surface a layer of material having an object incorporated therein, the method including: forming a first layer of patternable mold material on a first surface; forming a first aperture in the first layer of patternable mold material for receiving an object; placing the object in the first aperture; and forming a first material in the first aperture such that the first material encases the object.

In a thirty-seventh aspect of the invention a structure formed on a substrate, including a plurality of layers of structural material formed one over another, at least one of the plurality of layers having an object incorporated therein.

In a thirty-eighth aspect of the invention a structure, including: a first layer of material formed on a substrate, the first layer of material having a first aperture formed therein; at least one object held loosely within the first aperture; and a second layer of material formed over the first layer of material for securing the object in the first aperture.

In a thirty-ninth aspect of the invention a structure, including: a first layer of material formed on a substrate, the first layer of material having a track formed therein; a plurality of objects held loosely within the track; and a second layer of material formed over the first layer of material for securing the objects in the track.

In a fortieth aspect of the invention a method for forming on a surface a layer of material for incorporating an object therein, including: forming a first patternable mold material on the surface; patterning apertures in the first patternable mold material; depositing a first material into the apertures to form at least two portions of the first material separated by the first patternable mold material; removing the first patternable mold material to form a cavity between the at least two portions of the first material for receiving the object; forming a second patternable mold material to provide a barrier against deposition of a second material into the cavity; depositing the second material; and removing the second patternable mold material.

In a forty-first aspect of the invention a method for forming a structure on a surface, including: building a plurality of layers on the surface, the plurality of layers including both a structural material and a sacrificial material; and after building the plurality of layers, removing the sacrificial material from the plurality of layers; wherein the sacrificial material is a patternable mold material.

In a forty-second aspect of the invention a method for forming a structure on a surface, including: forming a first layer of patternable mold material; patterning first apertures in the first layer of patternable mold material; depositing a first structural material into the first apertures; forming a second layer of patternable mold material over the first layer of patternable mold material and the first structural material; patterning second apertures into the second layer of patternable mold material; and depositing a second structural material into the second apertures.

In a forty-third aspect of the invention a method for forming a structure on a surface, including: forming a first layer of patternable mold material; patterning first apertures in the first layer of patternable mold material; depositing a first conductive material into the first apertures; applying a coating of conductive particles over the first layer of patternable mold material; forming a second layer of patternable mold material; patterning second apertures in the second layer of patternable mold material to expose portions of the coating of conductive particles and the first conductive material; and depositing a second conductive material into the second apertures.

In a forty-fourth aspect of the invention a method for forming a structure on a surface, including: forming a first layer of patternable mold material; patterning first apertures in the first layer of patternable mold material; depositing a first conductive material into the first apertures; forming a second layer of patternable mold material; patterning second apertures in the second layer of patternable mold material to expose areas of the first layer of patternable mold material and areas of the first conductive material; depositing a coating of conductive particles into the second apertures such that they are secured in the exposed areas of the first layer of patternable mold material; and depositing a second conductive material into the second apertures.

In a forty-fifth aspect of the invention a method for forming a structure on a surface, including: forming a first layer of patternable mold material; patterning apertures in the first layer of patternable mold material; depositing a first metal into the apertures; removing the first layer of patternable mold material; and depositing a non-metallic conductive material such that the non-metallic conductive material electrically couples portions of the first metal to each other to form a plating base for plating a second metal.

In a forty-sixth aspect of the invention a method for forming a structure on a surface, including: forming a first layer of patternable mold material having conductive particles dispersed therein; and driving the conductive particles to an upper surface of the first layer of patternable mold material to form a plating surface for plating a subsequent layer of material.

In a forty-seventh aspect of the invention a method for forming structures and dicing lanes on a substrate, including: forming a first layer of patternable mold material on a surface; patterning first apertures in the first layer of patternable mold material; forming a first material in the first apertures; and removing the first layer of patternable mold material to expose portions of the surface, a plurality of the exposed portions of the surface functioning as dicing lanes.

In a forty-eighth aspect of the invention a method for forming an array of structures, including: forming a first layer of patternable mold material on a surface; exposing the first layer of patternable mold material using a first photomask to form a first pattern of soluble and insoluble portions of the first layer of patternable mold material, the first pattern for forming an array of structures having a first number of structures; and exposing the first pattern using a second photomask different from the first photomask to form a second pattern of soluble and insoluble portions of the first layer of patternable mold material from the first pattern, the second pattern for forming an array of structures having a second number of structures different from the first number of structures.

In a forty-ninth aspect of the invention a method for forming structures, including: forming a first layer on a surface, the first layer including first portions of structural material and first portions of sacrificial material; forming a second layer over the first layer, the second layer including second portions of structural material and second portions of sacrificial material, some of the second portions of structural material being formed over the first portions of structural material and others of the second portions of structural material being formed over the first portions of sacrificial material; and removing the first and second portions of sacrificial material such that the second portions of structural material being formed over the first portions of sacrificial material are also removed.

In a fiftieth aspect of the invention a method for forming an array of structures, including exposing a layer of patternable mold material using a first photomask having a first pattern for forming an array of structures having a first number of structures and a second photomask having a second pattern for forming an array of structures having a second number of structures different from the first number of structures, the first and second photomasks being used simultaneously to expose the first layer of patternable mold material.

In a fifty-first aspect of the invention a process for forming a multilayer three-dimensional structure, comprising: (a) forming and adhering a layer of material to a substrate or previously formed layer; and (b) repeating the forming and adhering operation of (a) a plurality of times to build up a three-dimensional structure from a plurality of adhered layers, where successive layers are adhered to previously formed layers; wherein the formation of at least one layer comprises: (i) forming and adhering a desired pattern of masking material on the substrate or previously formed layer, wherein the patterning of the masking material results in at least one void in the material that exposes a portion of the substrate or of a previously formed layer; (ii) depositing a conductive material into the at least one void in the masking material; and wherein the formation of the at least one layer additionally comprises removing the masking material, depositing a second material, and planarizing the deposited first and second materials to a desired height.

In a fifty-second aspect of the invention a process for forming a multilayer three-dimensional structure, comprising: (a) forming and adhering a layer of material to a substrate or previously formed layer; and (b) repeating the forming and adhering operation of (a) a plurality of times to build up a three-dimensional structure from a plurality of adhered layers, where successive layers are adhered to previously formed layers; wherein the formation of at least one layer comprises: (i) forming and adhering a desired pattern of masking material on the substrate or previously formed layer, wherein the patterning of the masking material results in at least one void in the material that exposes a portion of the substrate or of a previously formed layer; (ii) depositing a conductive material into the at least one void in the masking material; and wherein the formation of the at least one layer additionally comprises removing the masking material and depositing a dielectric material, and wherein the formation of a subsequent layer comprises depositing a seed layer on at least a portion of the at least one layer.

In a fifty-third aspect of the invention a process for forming a multilayer three-dimensional structure, comprising: (a) forming and adhering a layer of material to a substrate or previously formed layer; and (b) repeating the forming and adhering operation of (a) a plurality of times to build up a three-dimensional structure from a plurality of adhered layers, where successive layers are adhered to previously formed layers; wherein the formation of at least one layer comprises: (i) forming and adhering a desired pattern of masking material on the substrate or previously formed layer, wherein the patterning of the masking material results in at least one void in the material that exposes a portion of the substrate or of a previously formed layer; (ii) depositing a conductive material into the at least one void in the masking material; and wherein the formation of the at least one layer additionally comprises depositing a seed layer on the substrate, or previously formed layer, which comprises only conductive material, prior to forming and adhering the mask material.

In a fifty-fourth aspect of the invention a process for forming a multilayer three-dimensional structure, comprising: (a) forming and adhering a layer of material to a substrate or previously formed layer; and (b) repeating the forming and adhering operation of (a) a plurality of times to build up a three-dimensional structure from a plurality of adhered layers, where successive layers are adhered to previously formed layers; wherein the formation of at least one layer comprises: (i) forming and adhering a desired pattern of masking material on the substrate or previously formed layer, wherein the patterning of the masking material results in at least one void in the material that exposes a portion of the substrate or of a previously formed layer; (ii) depositing a conductive material into the at least one void in the masking material; and wherein the at least one layer, after it is completed, comprises at least three different materials located in different lateral positions on the layer.

In a fifty-fifth aspect of the invention a process for forming a multilayer three-dimensional structure, comprising: (a) forming and adhering a layer of material to a substrate or previously formed layer; and (b) repeating the forming and adhering operation of (a) a plurality of times to build up a three-dimensional structure from a plurality of adhered layers, where successive layers are adhered to previously formed layers; wherein the formation of at least one layer comprises: (i) forming and adhering a desired pattern of masking material on the substrate or previously formed layer, wherein the patterning of the masking material results in at least one void in the material that exposes a portion of the substrate or of a previously formed layer; (ii) depositing a conductive material into the at least one void in the masking material; and wherein the formation of the at least one layer additionally comprises optically aligning a position of the patterning of the dielectric material by using a focused image of an alignment mark that is located at on least one of (1) the substrate, (2) a carrier on which the substrate sits, or (3) previously deposited material that is located on the substrate.

Further aspects of the invention will be understood by those of skill in the art upon reviewing the teachings herein. Other aspects of the invention may involve combinations of the above noted aspects of the invention and/or addition of various features of one or more embodiments. Other aspects of the invention may involve apparatus that are configured to implement one or more of the above method aspects of the invention. These other aspects of the invention may provide various combinations of the aspects presented above as well as provide other configurations, structures, functional relationships, and processes that have not been specifically set forth above.

### BRIEF DESCRIPTION OF THE DRAWINGS

FIGS. 1(a)-1(c) schematically depict side views of various stages of a CC mask plating process, while FIGS. 1(d)-(g) schematically depict a side views of various stages of a CC mask plating process using a different type of CC mask.

FIGS. 2(a)-2(f) schematically depict side views of various stages of an electrochemical fabrication process as applied to the formation of a particular structure where a sacrificial material is selectively deposited while a structural material is blanket deposited.

FIGS. 3(a)-3(c) schematically depict side views of various example subassemblies that may be used in manually implementing the electrochemical fabrication method depicted in FIGS. 2(a)-2(f).

FIGS. 4(a)-4(i) schematically depict the formation of a first layer of a structure using adhered mask plating where the blanket deposition of a second material overlays both the openings between deposition locations of a first material and the first material itself.

FIGS. 5(a)-5(ii) illustrate an apparatus and method, according to an embodiment of the invention where a carrier is used to hold a substrate during at least part of the process of forming a three-dimensional structure.

FIGS. 6(a)-6(c) depict side views of an alternative carrier body configuration that allows interlocked bonding between the carrier and a substrate.

FIGS. 7(a)-7(b) each depict a top, side, and perspective view of a carrier body, respectively, having a conical shaped aperture or an elongated v-shaped aperture.

FIG. 8 depicts a side view of rollers of a dry film laminator along with a sheet of dry film that is wrapped around one of the rollers and a substrate that will be feed between the rollers.

FIGS. 9(a) and 9(b) depict perspective view of circular substrates and rectangular templates for holding the substrates when being feed into a laminator.

FIGS. 10(a)-10(b) depict sectional side views of the substrate and template of FIG. 9(b) along with shims that may be located beneath the substrate to ensure appropriate matching of the upper surfaces of the substrate and the template.

FIGS. 11(a)-11(e) depict side views of various stages of an example process where multiple layers of photoresist are added to a substrate prior to patterning them.

FIGS. 12(a)-12(b) depict, respectively, examples of a small positive feature and a small negative feature resulting from a selective deposition of material.

FIG. 13 depicts a side view of a narrow feature that exists in a first deposited material into which a blanket deposited material does not complete fill as a result, at least in part, of the aspect ratio (i.e. height/width) of the feature.

FIGS. 14(a)-14(h) depict schematic side views of various states of a process for forming a narrow positive feature such as that shown in FIG. 12(a).

FIGS. 15(a)-15(e) depict schematic side views of various states of a process for forming a narrow negative feature such as that shown in FIG. 12(b).

FIG. 16 provides a flowchart of a process for determining priority of deposition based on the existence of certain features on a layer.

FIGS. 17(a)-17(g) depict schematic side views of various states of a process for forming a layer containing both narrow negative and narrow positive features where the patternable mold material cannot generally produce small features of both types.

FIGS. 18(a)-18(k) depicts a process for depositing more than two materials on a single layer.

FIGS. 19(a)-19(k) depicts a process of a first exemplary embodiment for depositing more than two materials on a single layer where two or more different materials are adjacent to each other.

FIGS. 20(a)-20(j) depicts a process of a second exemplary embodiment for depositing more than two materials on a single layer where two or more different materials are adjacent to each other.

FIGS. 21(a)-21(i) depicts a process of a third exemplary embodiment for depositing more than two materials on a single layer where two or more different materials are adjacent to each other.

FIGS. 22(a)-22(i) depicts a process of a fourth exemplary embodiment for depositing more than two materials on a single layer where two or more different materials may be adjacent to each other.

FIGS. 23(a)-23(b) depict, respectively, side views of structures that expand and contract with the formation of successive layers forming at least part of a multi-layer structure.

FIGS. 24(a)-24(g) depict schematic side views of various states of a process for forming an expanding structure, such as that shown in FIG. 23(a), where photoresist is exposed in a plurality of layer operations but where development occurs only after exposure of multiple layers of photoresist occur and then back filling of the created void with a structural material occurs.

FIGS. 25(a)-25(g) illustrate an embodiment of a process for forming a contracting structure like that shown in FIG. 23(b).

FIG. 26 depicts a side view of a plurality of offset layers.

FIG. 27 provides a flowchart of a process for analyzing features on a layer to determine if a seed layer needs to be deposited.

FIGS. 28(a)-28(b) provide side views of two operations involved in an embodiment that uses backside alignment to ensure registration of patterning masks

FIGS. 29(a)-20(x) depict various stages of an embodiment of the invention where alignment targets may be formed by electrodepositing material.

FIGS. 30(a)-30(r) depict various stages of an embodiment of the invention where alignment targets are formed in an adhesion layer and/or in a seed layer.

FIG. 31 shows a top view of a substrate, layer, and alignment targets according to an embodiment of the invention.

FIGS. 32(a)-32(c) show examples, respectively, of an alignment target that may be located on a previous layer, an alignment target that may be located on an alignment mask, and an overlaying of the two.

FIGS. 33(a)-33(d) depicts a series of mask and layer alignment targets that may be used on alternating layers according to some embodiments of the invention.

FIGS. 34(a)-34(b) depict a substrate, FIG. 34(a), having a single quadrant on which useful structures will be formed and a mask, FIG. 34(b), having differently oriented patterns in each of four quadrants, such that upon each 90° rotation of the mask a different portion of the photomask may be used in patterning the substrate which may reduce the net number of photomasks needed to produce small quantities of structures.

FIGS. 35(a)-35(b) depict how substrate and mask alignment targets may be aligned upon rotation according to some embodiments of the invention.

FIG. 36(a)-36(d), schematically depict side views of various relationships between a carrier and a substrate that may be used in some embodiments of the invention.

FIGS. 37(a)-37(p) show a process for incorporating objects within layers formed on a substrate.

FIGS. 38(a)-38(p) show another embodiment of the invention for incorporating foreign objects within layers formed on a substrate.

FIG. 39 shows a top view of a step in the formation of a ball bearing structure formed according to some embodiments of the invention.

FIG. 40 shows a completed ball bearing structure formed according to some embodiments of the invention.

FIGS. 41(a)-41(k) show another embodiment of the invention for incorporating foreign objects within layers formed on a substrate.

FIGS. 42(a)-42(p) provide a schematic illustration of various stages of a process for forming multi-layer structures where the patternable mold material is used as the sacrificial material.

FIGS. 43(a)-43(r) show an alternative embodiment for using patternable mold material as the sacrificial material.

FIGS. 44(a)-44(i) show another alternative embodiment for using patternable mold material as the sacrificial material.

FIGS. 45(a)-45(m) show an embodiment of the invention for building layers on large substrates in such a manner as to minimize stresses to a large substrate that may result from deposited materials.

FIGS. 46(a)-46(q) show an embodiment of the invention for fabricating customized arrays of devices without needing to use an entirely new set of photomasks for each customized array configuration.

FIGS. 47(a)-47(q) show another embodiment of the invention for fabricating customized arrays of devices without needing to use a different set of photomasks for each customized array configuration.

FIGS. 48(a)-48(b) show a sample multi-element structure which is formed using a structural material and a sacrificial material and where the sacrificial material has been removed as shown in FIG. 48(b).

FIGS. 49(a)-49(b) show a sample multi-element structure where individual elements have different lengths before and after removal of sacrificial material.

FIGS. 50(a)-50(d) show two sample multi-element structures where individual elements have different lengths before and after removal of sacrificial material and where a second substrate is added to the build so as to retain elements of the second structure that would otherwise have been lost.

FIGS. 51(a)-51(b) illustrate an embodiment similar to that of FIGS. 49(a) and 49(b) with the exception structural material elements that are to be removed are held together by a bridging structure.

FIGS. 52(a)-52(g) show an embodiment of the invention for pre-patterning a patternable mold material on a temporary substrate before using the temporary substrate to form a pattern for depositing other materials on a separate substrate.

FIGS. 53(a)-53(f) show another embodiment of the invention for transferring a pattern from a temporary substrate to a build substrate.

FIGS. 54(a)-54(f) show another embodiment of the invention for transferring a pattern from a temporary substrate to a build substrate.

FIGS. 55(a)-55(i) show an embodiment of the invention for depositing more than one material in an aperture formed in a patternable mold material such that a layered deposit of materials are formed on a single layer.

FIGS. 56(a)-56(i) show an alternative embodiment of the invention for depositing more than one material in an aperture formed in a patternable mold material such that a layered deposit of materials are formed on a single layer.

FIGS. 57(a)-57(g) show an embodiment of the invention for using a patternable mold material to perform a patterned etch.

FIGS. 58(a)-58(j) show an embodiment of the invention for using a patternable mold material both to etch a pattern in a first material and to plate a second material in the etched pattern.

FIGS. 59(a)-59(i) show a further embodiment of the invention for forming a target on a substrate.

### DETAILED DESCRIPTION OF THE PREFERRED EMBODIMENTS

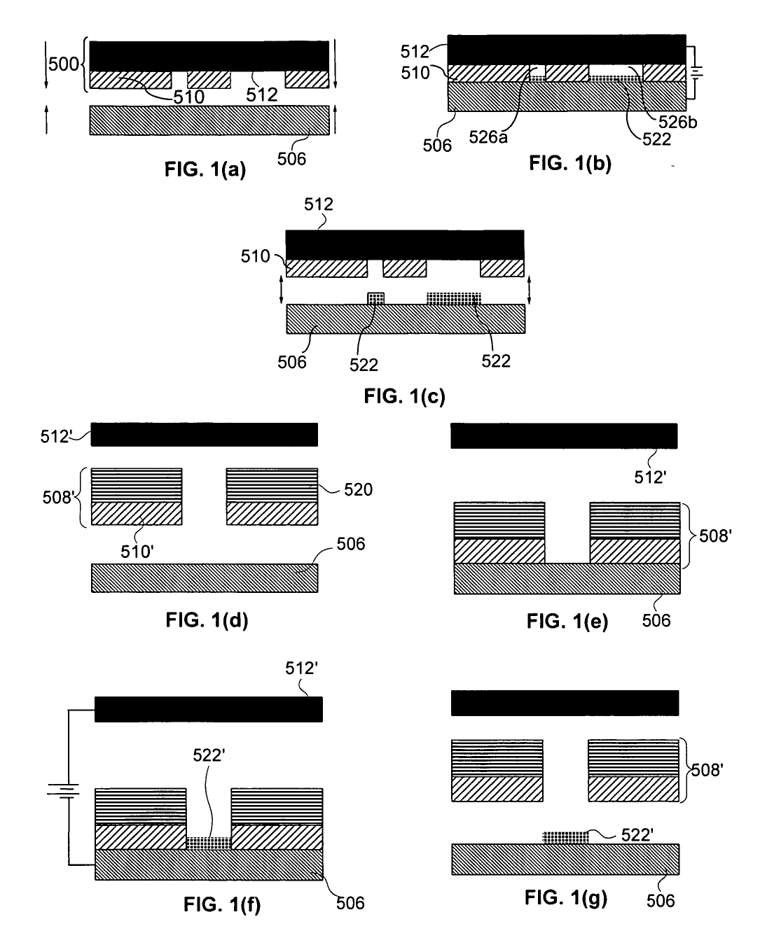

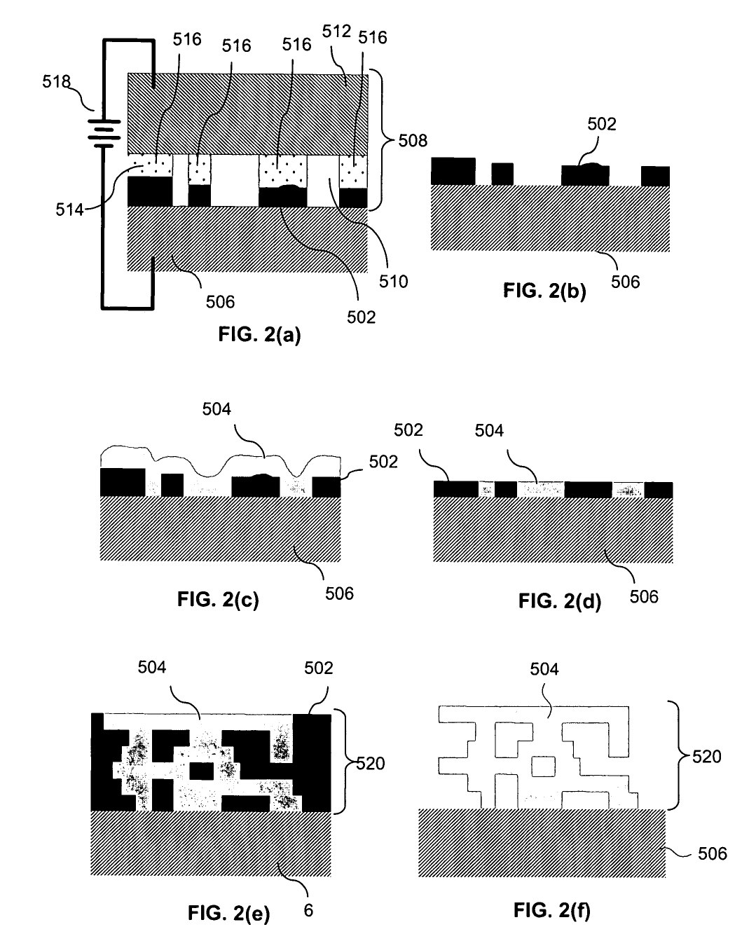

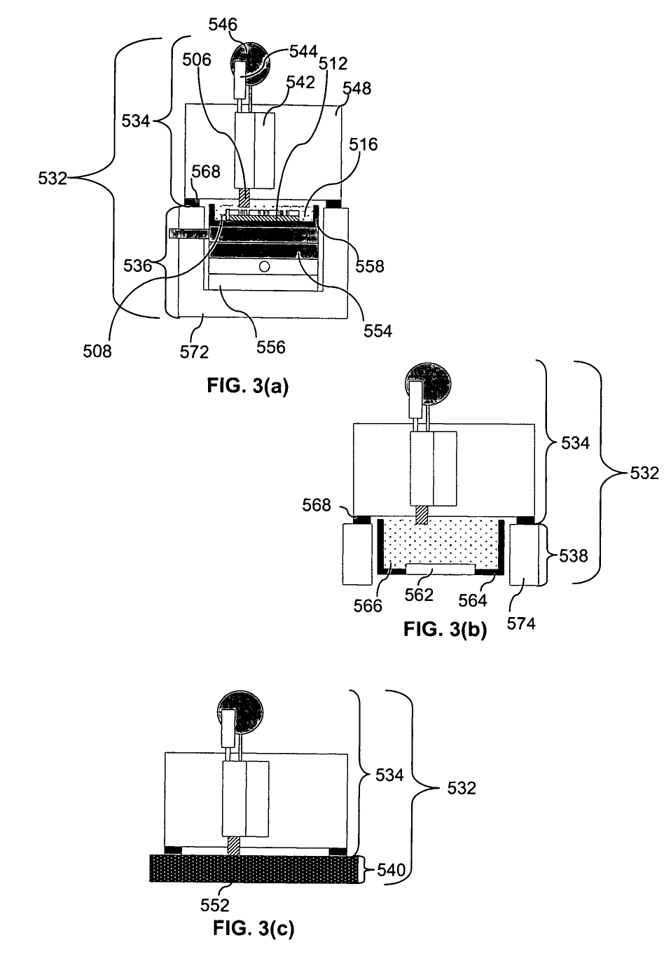

FIGS. 1(a)-1(g), 2(a)-2(f), and 3(a)-3(c) illustrate various features of one form of electrochemical fabrication that are known. Other electrochemical fabrication techniques are set forth in the '630 patent referenced above, in the various previously incorporated publications, in various other patents and patent applications incorporated herein by reference, still others may be derived from combinations of various approaches described in these publications, patents, and applications, or are otherwise known or ascertainable by those of skill in the art from the teachings set forth herein. All of these techniques may be combined with those of the invention explicitly set forth herein to yield enhanced embodiments. Still other embodiments may be derived from combinations of the various embodiments explicitly set forth herein.

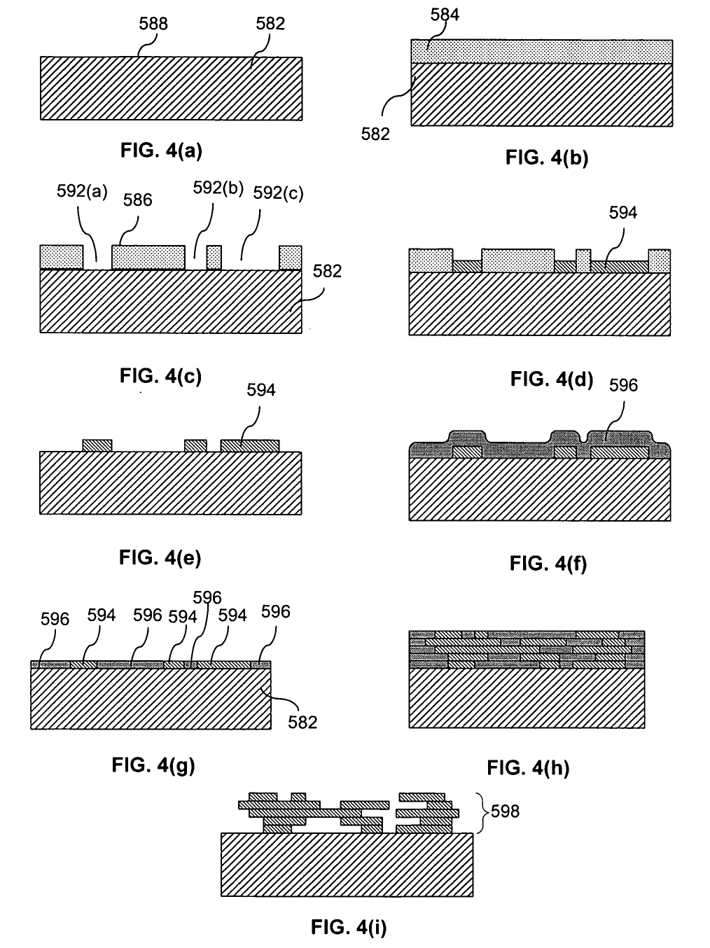

FIGS. 4(a)-4(i) illustrate various stages in the formation of a multi-layer three-dimensional structure formed using a fabrication process that involves the deposition of first and second metals on a layer-by-layer basis so as to build up the structure from a plurality of adhered layers. In some embodiments, the first and/or second materials may be electrodeposited (e.g. using electroplating or electrophoretic deposition) while in some embodiments, the one or both of the materials may be deposited via an electroless deposition, via thermal spraying, sputtering, spreading, and the like. A first metal is deposited to selected locations via openings in a mask that is adhered to the substrate (which may include previously deposited materials or layers) while a second metal is deposited so as to fill voids in the layer located between locations of the first metal. Successive layers are deposited on immediately preceding layers to build up desired structures from multiple adhered layers.

In FIG. 4(a), a side view of a substrate 582 is shown, onto which patternable photoresist 584 (i.e. a patternable mold material) is applied as shown in FIG. 4(b). The photoresist may be supplied and applied in the form of a liquid or in the form of a dry film. Photoresists may be of the negative or positive types. In FIG. 4(c), a pattern of resist is shown that results from the curing (if applied as a liquid) or adhering (if applied as a dry film), exposing (e.g. via UV radiation applied through a photomask), and developing of the resist. The patterning of the photoresist 584 results in openings or apertures 92(a)-92(c) extending from a surface 586 of the photoresist through the thickness of the photoresist to surface 588 of the substrate 582.

In FIG. 4(d), a metal 594 (e.g. copper, silver, an alloy of copper, or the like) is shown as having been deposited (e.g. electroplated) into the openings 592(a)-592(c). In FIG. 4(e), the photoresist has been removed (i.e. chemically stripped) from the substrate to expose regions of the substrate 582 which are not covered with the first metal 594. In FIG. 4(f), a second metal 596 (e.g., nickel, gold, tin, zinc, an alloy of nickel, or the like) is shown as having been blanket deposited (e.g. electroplated) over the entire exposed portions of the substrate 582 (which is conductive) and over the first metal 594 (which is also conductive). FIG. 4(g) depicts the completed first layer of the structure which has resulted from the planarization of the first and second metals down to a height that exposes the first metal and sets a thickness for the first layer. The planarization operations may also set the flatness of the formed layer and its surface finish.

FIG. 4(h) shows an example of the result of repeating the process steps shown in FIGS. 4(b)-4(g) several times, with a different masking pattern on each layer, to form a multi-layer structure. Each layer includes two metals. For most applications, one of these metals is removed as shown in FIG. 4(i) to yield a desired 3-D structure 598 (e.g. component or device).

In some alternative embodiments, as will be discussed herein later, more than two materials may be used. In such embodiments, each material may be a metal, or some of them may be dielectrics. In various embodiments, one or more of the materials used in building up layers of the structure may be a structural material (i.e. a material that will form part of the structure itself) while one or more of the other materials may be a sacrificial material (i.e. a material that will be removed prior to putting the structure (e.g. object, device, or component) to its intended use.

Various embodiments of some aspects of the invention are directed to formation of three-dimensional structures from materials some of which may be electrodeposited. Some of these structures may be formed form a single layer of one or more deposited materials while others are formed from a plurality of layers of deposited materials (e.g. 2 or more layers, more preferably five or more layers, and most preferably ten or more layers). In some embodiments structures having features positioned with micron level precision and minimum features size on the order of tens of microns are to be formed. In other embodiments structures with less precise feature placement and/or larger minimum features may be formed. In still other embodiments, higher precision and smaller minimum feature sizes may be desirable.

Various embodiments to be discussed herein after may be focused primarily on a particular type of masking technique for selective patterning of deposited materials. However, each embodiment may have alternatives that are implementable with other patterning techniques. For example, some embodiments may have alternatives that may use contact masks and contact masking operations, such as conformable contact masks as described above, or non-conformable masks and masking operations (i.e. masks and operations based on masks whose contact surfaces are not significantly conformable). Other alternatives may make use of proximity masks and masking operations (i.e. operations that use masks that at least partially selectively shield a substrate by their proximity to the substrate even if contact is not made). Still other alternatives may make use of various types of adhered masks and masking operations (masks and operations that use masks that are adhered to a substrate onto which selective deposition or etching is to occur as opposed to only being contacted to it). Adhered masks may be formed in a number of ways including, for example (1) by application of a photoresist, selective exposure of the photoresist, and then development of the photoresist, (2) selective transfer of pre-patterned masking material, and/or (3) direct formation of masks from computer controlled depositions of material. Selective patterning using masks may occur by depositing a selected material into voids or openings in the masks or it occur by selectively etching a surface of an already deposited material using the mask. In other applications, selective patterning may not involve a significant height of deposition of material or significant depth of etching of material but instead may involve treating a surface in a selective manner, e.g. selective microetching of a surface (e.g. to improve adhesion between it and a material), selective oxidization of a surface (e.g. to change its conductivity), selective chemical treatment of a surface (e.g. in preparation for an electroless deposition), and the like.

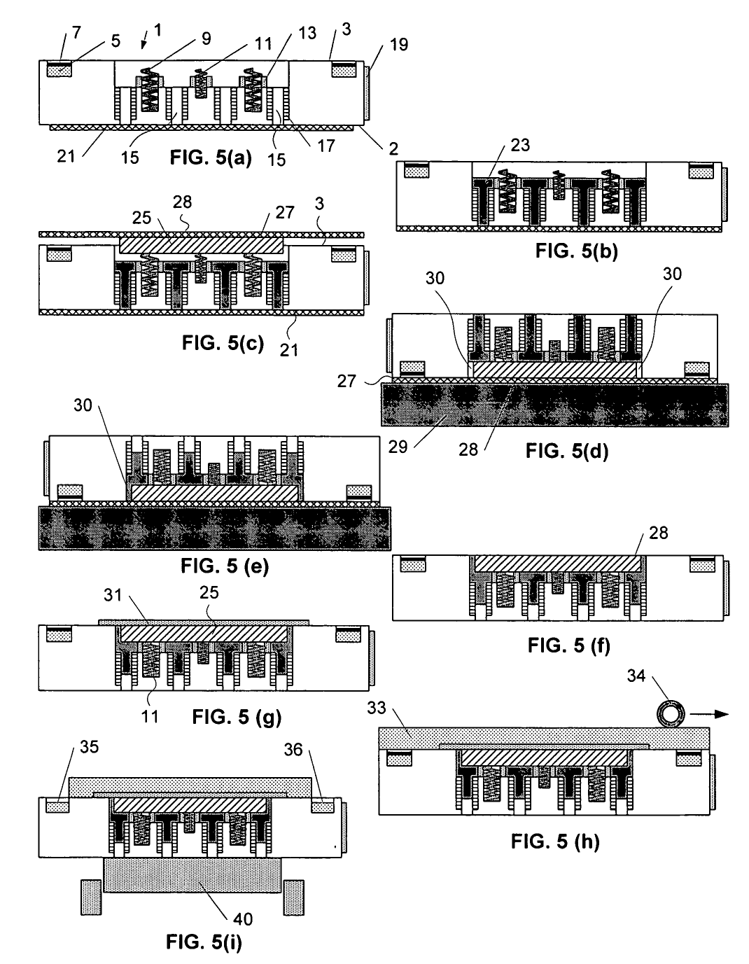

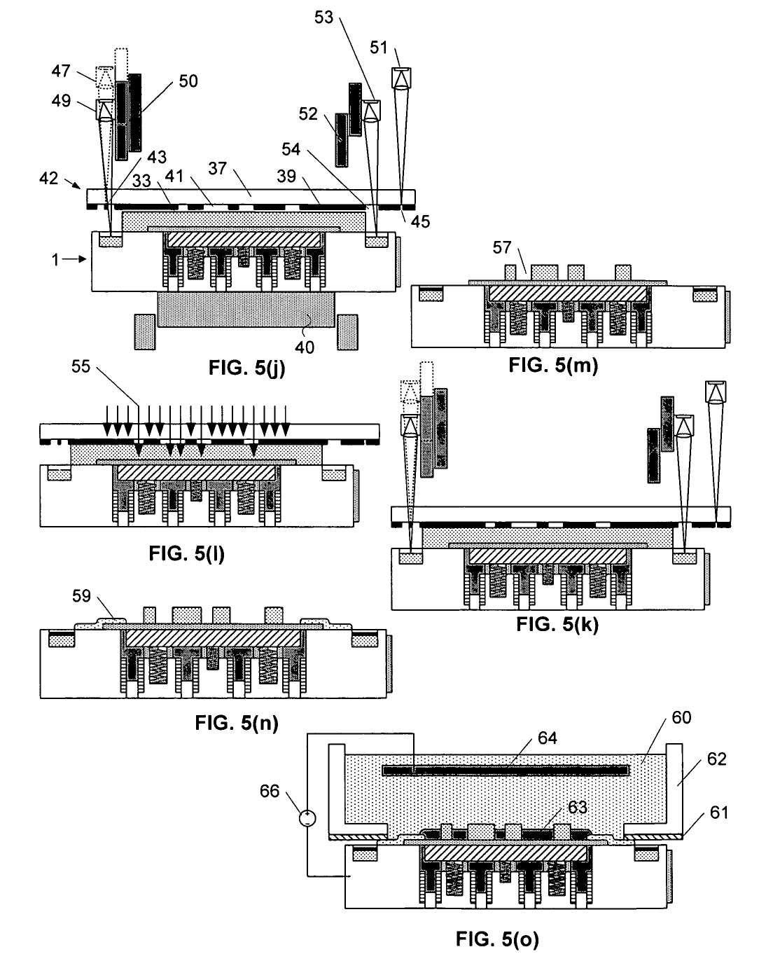

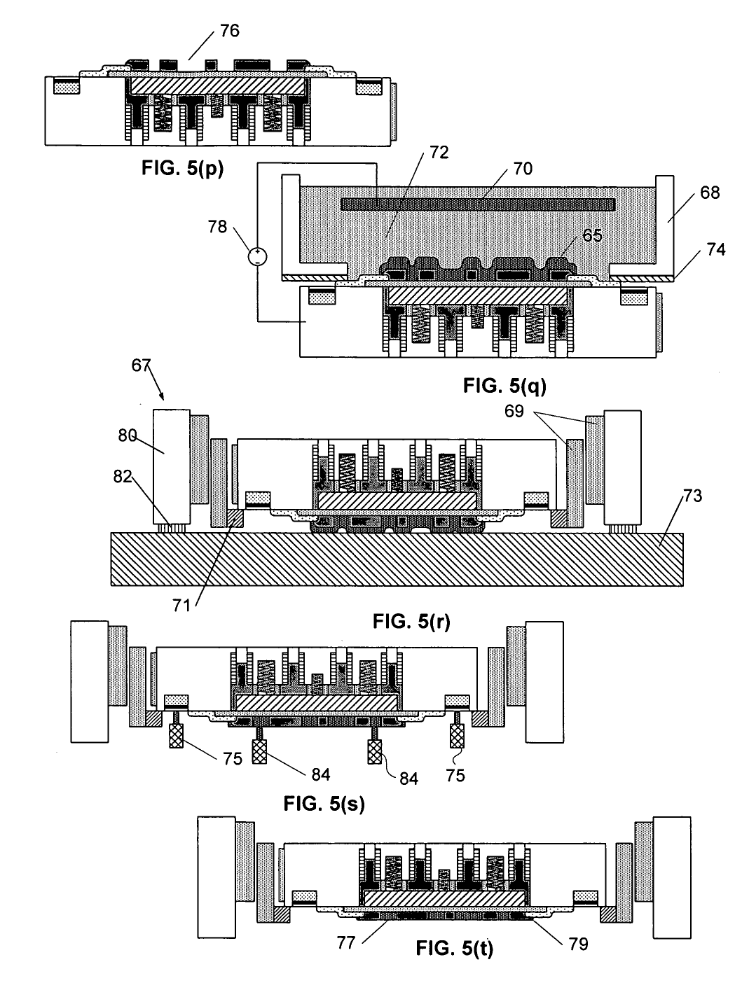

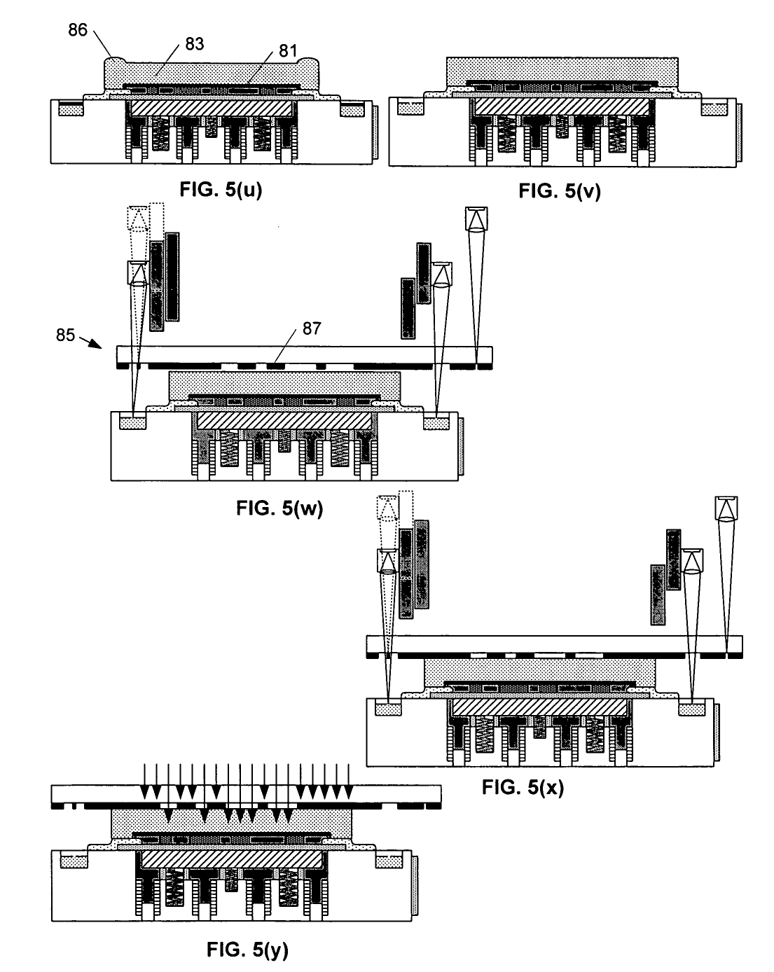

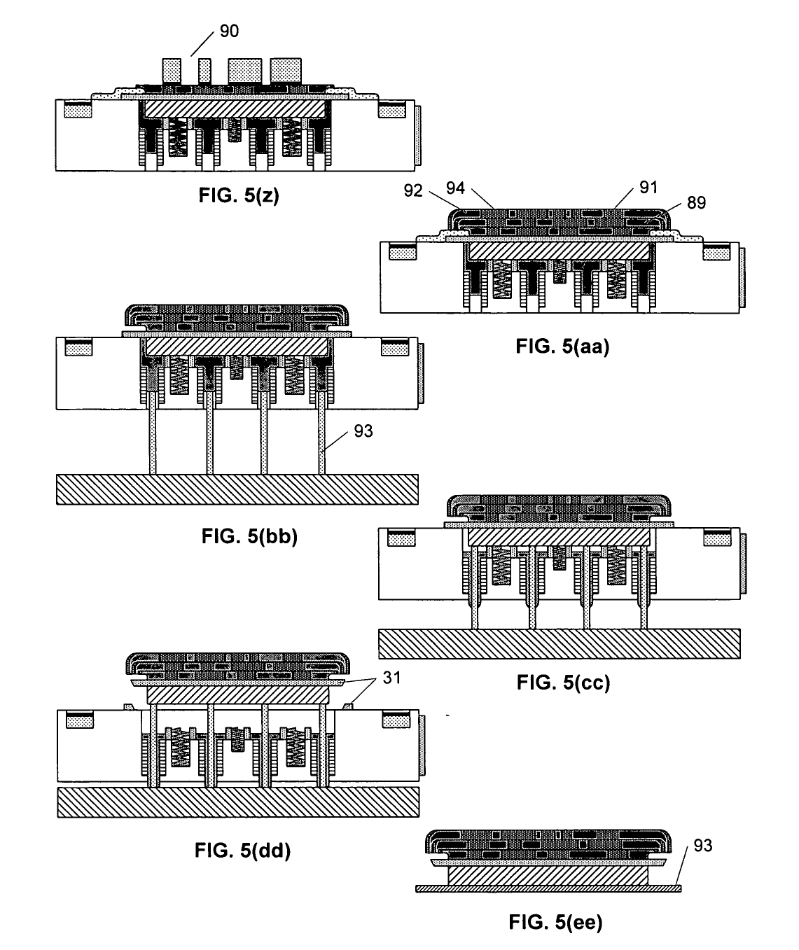

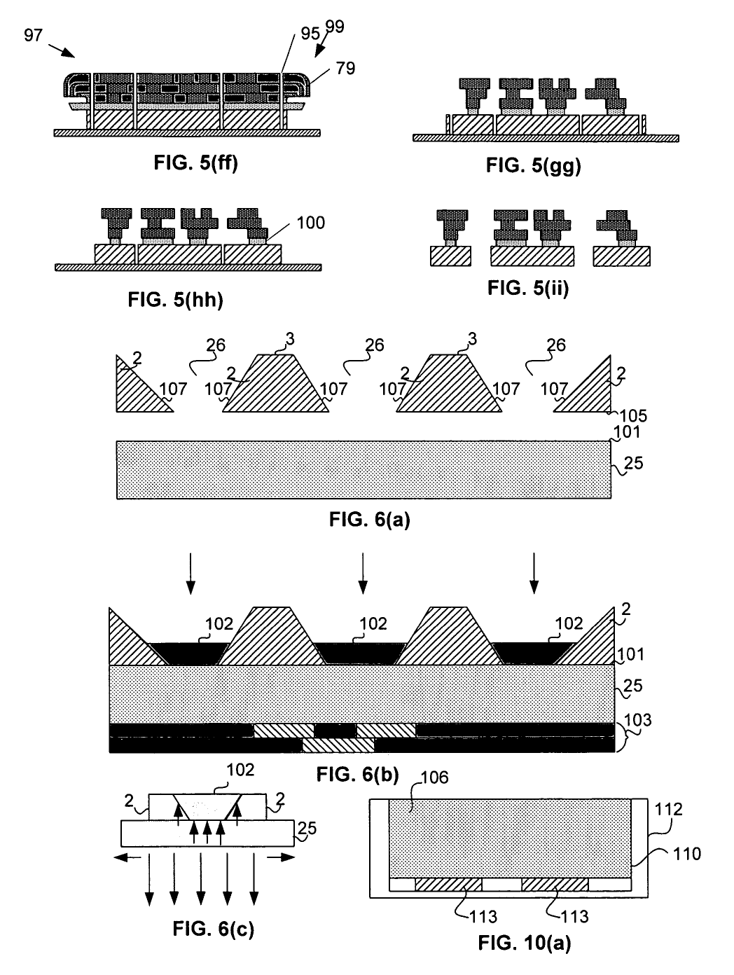

FIGS. 5(a)-(ii) illustrate schematic side views of the states of the process and apparatus components involved in forming a sample structure according to a first embodiment of the invention. In this embodiment, a carrier is provided for carrying a substrate on which layers of material will be formed during fabrication of a structure.

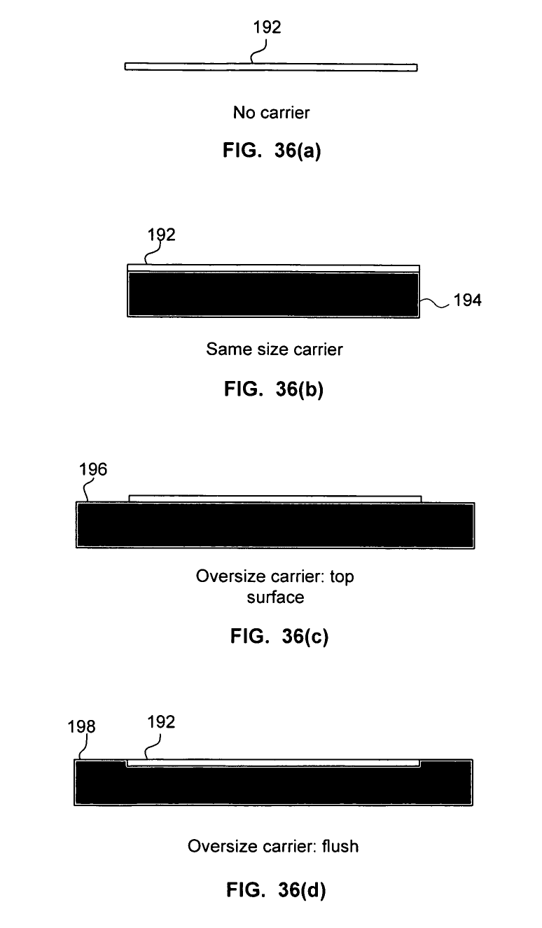

FIG. 36(a)-(d), schematically depict side views of various relationships between a carrier and a substrate that may be used in some embodiments of the invention. FIG. 36(a) depicts a substrate without a carrier and thus indicates that in some embodiments of the invention, a substrate 192 may be used without a carrier. FIGS. 36(b)-36(c) depict some other relationships that may exist in other embodiments. In some embodiments a carrier 194 may have the same size as the substrate 192, as shown in FIG. 36(b). Other embodiments may use a carrier 196 that is larger than the substrate 192, as shown in FIG. 36(c). Still other embodiments, may be use or include a carrier 198 that has a recess for receiving substrate 192, as shown in FIG. 36(d).

Turning back to FIG. 5(a), a carrier 1 may include a carrier body 2 having a highly planar surface 3. Carrier 1 may further include two or more alignment target inserts 5 covered by removable protective covers 7. Carrier body 2 may further include pressing means 9 for applying pressure to a substrate 25 as shown in FIG. 5(c). According to some embodiments of the invention, the pressing means 109 may be any suitable means for applying pressure such as, but not limited to, one or more springs, as shown in FIG. 5(a), one or more air cylinders, one or more inflatable bladders, and the like. According to some other embodiments, the weight of substrate 125 may be sufficient to make use of a pressing means 9 unnecessary.

According to some embodiments of the invention, the carrier 1 may further include contacting means 11 for making electrical contact with conductive substrates. The contacting means 11 may be any suitable means for making electrical contact such as, but not limited to, one or more springs, as shown in FIG. 5(a), one or more ‘fuzz buttons’, one or more ‘pogo pins’, and the like. Carrier 1 may further include damming means 13 (for example, an elastomeric or conformable gasket). Furthermore, carrier 1 may include holes 15 for use in the eventual removal of substrate 25 and to serve as reservoirs or risers for adhesive material 23 as shown in FIG. 5(b), and heating elements 17 preferably in close proximity to holes 15. The carrier 1 may further include a carrier identification device 19 (such as, but not limited to, a bar code label or radio frequency identification tag (RF ID tag). The carrier identification device 19, in addition to or alternatively to identifying the carrier or substrate, may encode a partial or complete process sequence for a particular substrate, for example indicating type of operations to perform and operations already performed. For example, a sequence of operations may be readable from an RF ID tag 19 along with an indication as to which operations have been completed and any comments associated with them. In other words, this RF ID tag may not only act as an identification tag but also as a production traveler that accompanies the structure as it is being formed and indicates the state of the process and next operations to perform.

Referring to FIG. 5(a), the carrier 1 is shown without substrate 25. As shown in FIG. 5(b), according to some embodiments of the invention, meltable adhesive material 23 has been applied to fill holes 15 before substrate 25 is loaded into the carrier. Material 23 should be extremely rigid after solidification, preventing any relative motion of substrate 25 and carrier body 2. Material 23 should also be removable, for example, by melting or chemical dissolution. Material 23 should withstand multiple cycles of temperature cycling that substrate 25 may be exposed to while being coated with photoresist, being immersed in electrodeposition baths, and the like. Suitable meltable adhesive materials include, but are not limited to, a mounting wax such as CrystalBond™ 509 made by Aremco Products of Valley Cottage, N.Y. and Staystik™ 571 made by Cookson Electronics of Alpharetta, Ga.

Heating elements 17 are preferably activated in order to facilitate the material 23 filling operation. Removable film 21 has been attached to the bottom of carrier 1. Film 21 may be, for example, wafer dicing tape. The flow of material 23 is limited by film 21 and by damming means 13, the latter preventing material 23 substantially from reaching contacting means 11 (which if material 23 is an insulator might impair electrical contact between contacting means 11 and substrate 25). As depicted, damming means 13 also prevents material 23 from reaching and interfering with the operation of pressing means 9.

Referring to FIG. 5(c), substrate 25—onto which one or more multi-layer structures is to be fabricated—has been placed into carrier 1. In some embodiments carrier 1 includes a recess or pocket (as shown) for receiving substrate 25 such that the top surface 28 of substrate 25 may be made parallel and coplanar (i.e., flush) with the planar surface 3 of the carrier 1 (see FIG. 5(f)). Substrate 25 may be covered with a thin removable film 27 preferably of uniform thickness (for example, wafer dicing tape). In FIG. 5(d), carrier 1 and substrate 25 have been inverted and placed on planar surface 29 (for example, a granite surface plate) with film 27 between substrate 25 and surface 29. Pressure is applied to carrier 1 (if its own weight is insufficient) to press substrate 25 via film 27 against pressing means 9 so that top surface 28 of substrate 25 is forced to be coplanar with planar surface 3 of carrier 1. Also as may be seen in FIG. 5(d), film 21 has been removed (this may be done after the step shown in FIG. 5(b)).

In FIG. 5(e), material 23 has been melted by activation of heating elements 17, causing material 23 to flow and fill gaps, e.g. to fill gap 30 of FIG. 5(d)) between substrate 25 and carrier 1, and causing substrate 25 to become rigidly adhered to carrier 1 when material 23 is allowed to cool and solidify. According to other embodiments, heating elements 17 may be omitted and the entire assembly may be placed in an oven, for example, in order to melt material 23. In FIG. 5(f), film 27 has been removed, leaving material 23 substantially co-planar with surface 3.

Other embodiments of the invention may use other methods for securing the substrate 25 to the carrier. For example, according to some embodiments, a low melting point solder may be used to secure substrate 25 to carrier 1. According to one embodiment, an indium-based solder may be used. The solder may be applied, for example, as a thin foil placed between the substrate 25 and the carrier 1 and subsequently heated (for example, in an oven) to melt the thin foil. Alternatively, the solder may be plated onto one or more surfaces. In some embodiments, a layer of metal (for example, gold) may be applied to the one or more surfaces to allow the surfaces to be soldered. In the case of using a conductive bonding material, it may be possible to remove damming means 13, as the solder may be made to flow around pressing means 9 and prior to pressing, the solder may be made flowable then pressing made to occur such that pressing means and planar surface 9 bring carrier surface 3 and substrate surface 28 flush, the solder, or other conductive bonding material, may then be allowed to solidify locking the substrate 25 and carrier 1 into fixed positions relative to one another.

Referring to FIGS. 6(a)-(c), according to other embodiments, carrier 1 may include apertures formed through the carrier body 2 that may be filled with, for example, a plated or melted metal such that the substrate 25 may be mounted to the carrier body 2 and secured due to the adhesion of the plated or melted metal to the substrate 25 and/or due to mechanical interlocking after the plated or melted metal has solidified.

A cross section of carrier body 2 is shown in FIG. 6(a). As shown, carrier body 2 has tapered apertures 26 in several places extending from surface 3 of carrier body 2 through the carrier body to surface 105. Also shown in FIG. 6(a) is substrate 25 before attachment to carrier body 2. According to some embodiments of the invention, substrate 25 may be either a metal substrate or may be coated with metal on a least surface 101 such that metal may be plated onto surface 101. In addition, according to some embodiments where carrier body 2 is not metal, surfaces 107 may also be coated with metal (e.g. by sputtering) such that metal may be plated onto surfaces 107.

As shown in FIG. 6(b), while surface 101 of substrate 25 is held against carrier body 2, material 102 is plated or melted such that it at least partially fills apertures 26 and makes contact with surface 101 and surfaces 107. When material 102 is deposited or solidifies it forms a good bond with surfaces 101 of substrate 25 and/or surfaces 107 of carrier body 2. According to some embodiments, surfaces 101 and surfaces 107 may be roughened to enhance adhesion.

In addition to the bonding of the material 102 to surface 101 and/or surfaces 107 as a result of plating or melting material 102 into apertures 26, some embodiments of the invention also advantageously provide a strong mechanical bond as a result of the geometrical shape of the apertures 26. FIG. 6(c) shows an example of the mechanical bond. The downward and sideways pointing arrows shown in FIG. 6(c) represent a force that potentially could cause movement or separation of substrate 25 relative to carrier body 2. The upward pointing arrows represent both the bond formed between material 102 and surface 101 and the mechanical bond resulting from the dovetail joint-like configuration formed by material 102 (the tenon of the dovetail joint) and carrier body 2 (the mortise of the dovetail joint). Due to the increased strength of the bond between substrate 25 and carrier body 2 achieved by embodiments of the invention, substrate 25 becomes more rigidly adhered to carrier 1.

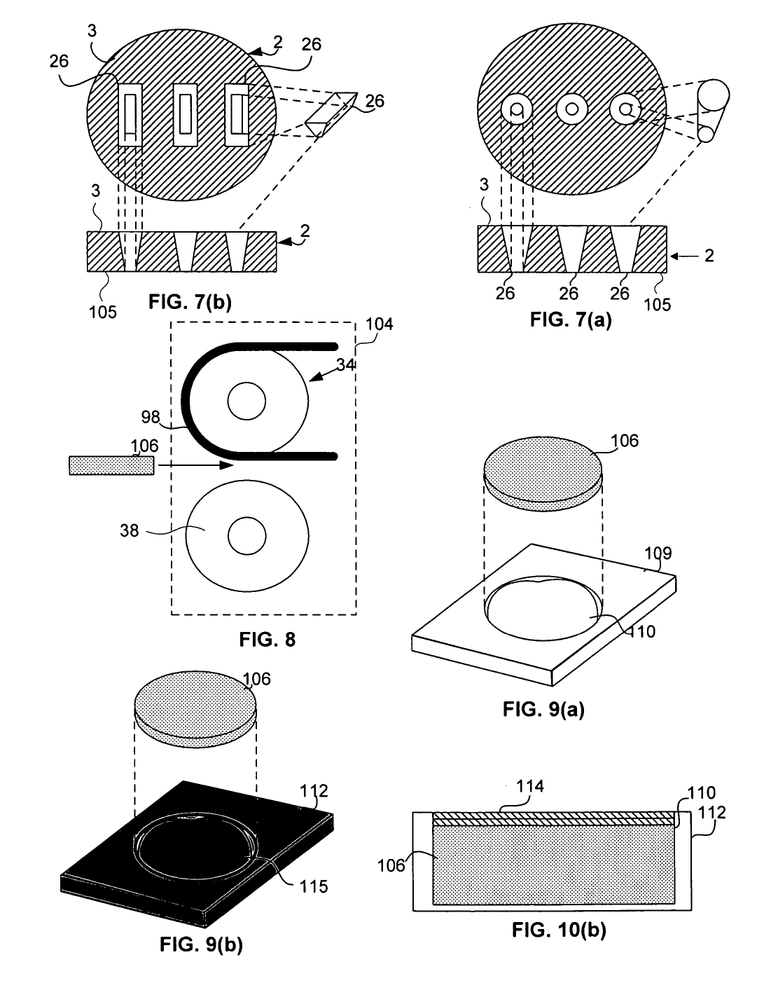

A top view (looking toward surface 3) and a side cross-section view of carrier body 2, according to some embodiments of the invention, are shown in FIG. 7(a). The top view is shown in the upper portion of the FIG. 7(a) while the side view is shown in the lower portion of FIG. 7(a). In FIG. 7(a), apertures 26 have a conical shape similar to that shown in FIG. 6(a)-(b) such that the dovetail joint-like configuration described above may be achieved. Also shown in FIG. 7(a) is a perspective view of one of apertures 26 (shown on the right side of the figure).

According to some embodiments of the invention, apertures 26 may have any suitable geometric shape that provides a strong mechanical bond between carrier body 2 and substrate 25 after material 102 is formed in the apertures. Some preferred embodiments of the invention use a reentrant geometry, as shown in FIG. 7(a). FIG. 7(b) shows a top view (upper most portion of the figure), looking toward surface 3, and a side section view of carrier body 2 (lower-most portion of the figure, and a perspective view in the right most portion of the figure. As an example of an additional suitable reentrant geometric shape, FIG. 7(b) shows an aperture 26 having a v-shaped bar shape. As shown in the side view, the dovetail joint-like configuration described above may be achieved with the v-shaped bar.

According to yet other embodiments, the aperture may have other suitable shapes. For example, the aperture may have a diameter or width at surface 105 that is smaller than a diameter or width of the aperture at surface 3, but wherein the shape of the aperture is not the smoothly tapered shape shown in FIG. 7(a). For example, a large portion of the aperture may have substantially vertical walls and a smaller portion that widen or narrow as they approach surface 105 and/or surface 3, respectively.

If adhesion bonding of material 102 to surface 101 and/or surfaces 107 is sufficient, then in some cases there is no need for a mechanical bond such as that provided by the reentrant or other geometrical shapes formed by material 102 and carrier body 2. Thus, in some embodiments, apertures 26 may have, for example, vertical walls. On the other hand, in embodiments where a mechanical bond is provided, the adhesive bonding of the material 102 to surface 101 and/or surfaces 107 may be unnecessary. Still other embodiments may use both types of bonding.

A build 103 of material layers may then be added to surface 28 of substrate 25 during the electrodeposition process, as shown in FIG. 6(b). After the electrodeposition process, substrate 25 may be separated from carrier body 2 by removing material 102. Material 102 may be removed, for example, by dissolving, melting, chemically etching or electro-chemically etching material 102 away. According to some preferred embodiments of the invention, material 102 may be nickel or copper. However, material 102 may also be a low temperature metal such as indium, tin, or tin-lead. In still other embodiments, material 102 may be a wax-like material, a thermal polymer, or even a thermoset or photocurable polymer that may be eventually be removed, e.g. by burning it out. According to some embodiments, material 102 may be the same as the sacrificial material used in the build, such that it may be removed (and the carrier 1 released) during the process for removing the sacrificial material. In some embodiments where the sacrificial material is used as material 102, it may be undesirable to remove material 102 while the sacrificial material is removed. In that case, material 102 may be masked during, for example, an etching process for removing the sacrificial material.

In order to avoid distortion of the bond between carrier 1 and substrate 25 due to mismatched coefficients of thermal expansion (CTE), some embodiments of the invention may substantially match the CTE of the materials used to form the carrier 1 and the substrate 25. For example, if substrate 25 is formed from a metal, carrier 1 may also be formed from a metal. If, on the other hand, substrate 25 is formed from a ceramic or polymer, carrier 1 may be also be formed from a ceramic or polymer, respectively. In some embodiments, the adhesive materials and/or plating materials used to bond the carrier 1 to the substrate 25 may also be chosen to have a suitable CTE, i.e., if carrier 1 and substrate 25 are formed from metal, the adhesive may also be a metal.

In some embodiments, the adhesive may be chosen to allow for a mismatch of the CTEs of carrier 1 and substrate 25, i.e., when one of the carrier 1 or the substrate 25 expands more than the other, the adhesive will maintain its bond between the two. In some embodiments, the adhesive may be a conformable material or an elastomeric material. The CTE of the material 102 may also be matched to the CTE of the substrate and the materials used to form the carrier 1, or may be chosen to allow for a mismatch of the CTEs of carrier 1 and substrate 25 in embodiments wherein the carrier 1 has apertures as described above. If for example, the substrate and carrier are made of metals, material 102 may take the form of a glass (lower CTE) filled polymer (higher CTE) such that the CTE of the combination more closely matches that of the metals

According to yet other embodiments of the invention, substrate 25 may be made very thick. The increased thickness of substrate 25 may provide enough stability such that a process flow like that shown in FIGS. 4(a)-(i) may be performed without the need for a carrier, such as carrier 1. In addition, the increased thickness of substrate 25 may make it less fragile. After a build of layers has been completed on the substrate 25, backgrinding or other machining processes (for example, lapping, milling, electrical discharge machining, chemical milling, fly cutting) of the substrate 25 may be performed to thin the substrate 25. Thinning of substrate 25 may be performed prior to dicing into individual die if desired.

Referring to FIG. 5(g), if substrate 25 is sufficiently conductive and of a suitable composition to allow for electrodeposition of material used in making the desired multi-layer structure—either throughout its bulk (as would be the case with solid metal) or by virtue of a conductive coating on surface 28 (e.g. a seed layer or seed layer and adhesion layer combination) and preferably one other surface (for example, the bottom surface directly opposite top surface 28 (in which case the edges of substrate 25 may need to be coated to electrically connect surface 28 with the bottom surface)—then electrical contact with surface 28 may be made through contacting means 11 (or even pressing means 9). As shown, contacting means 11 make contact with substrate 25 on its bottom surface; however, contact through the side of substrate 25 is another option, and contact with other surfaces is also possible. In other cases, substrate 25 may be covered on top surface 28 by one or more layers of material 31 (for example, sputtered or evaporated gold in the range of 0.1-3.0 micrometers thickness on top of sputtered or evaporated titanium or chromium in the range of 0.01-0.1 micrometers in thickness).

In FIG. 5(g) it is assumed that conductive material 31 is required, and material 31 has been deposited so as to cover surface 28 and extend across material 23 and form an electrical connection to carrier 1. Carrier 1 is here presumed to be composed of a conductive material (for example, electroless nickel-plated cast iron with low residual stress); if this is not the case, a conductive insert may be provided at the top of carrier 1 onto which material 31 can be deposited. By virtue of either contacting means 11 and conductive substrate 25, or else material 31; surface 28 is now conductive and capable of receiving electrodeposited material. In embodiments where conductive material 31 is added, the substrate need not be conductive and contact means 11 need not exist as electric connection is made directly by material 31 to the carrier 1 and electrical connection between the carrier and an external power supply may be made in any appropriate way. In embodiments where electroplating solution is located only on the upper surface of material 31, no shielding of other portions of the carrier from electrodepositions may be necessary but when no such limitation is placed on the electroplating solution, it may be necessary to shield the rest of the carrier in some manner.

In FIG. 5(h), a patternable mold material 33 has been applied to material 31. The patternable mold material 33 is assumed to be a dry film photoresist. However, some embodiments of the invention may use other types of photoresist such as, but not limited to, liquid or electrodepositable (electrophoretic) photoresists. In FIG. 5(h) the patternable mold material 33 is shown being applied by a lamination roller 34. However, other embodiments of the invention may apply the patternable mold material 33 by other means such as, but not limited to, vacuum laminating, roller coating, spraying, spin coating, ink-jet printing, silk screening and the like.

According to some embodiments of the invention, different patternable mold materials (for example, photoresists) may be chosen for different layers based on their different properties. For example, some photoresists may allow for thicker layers while others may allow for the patterning of smaller features. Other photoresists may have better chemical resistance to particular plating or etching baths. Thus, some embodiments of the invention may use a dry film photoresist on some layers and a liquid or electrodeposited photoresist on other layers. Also, positive resist may be used on some layers, while negative resist may be used on other layers. A single layer may also use more than a single type of resist for patterning of a deposit.

The choice of photoresists may be based on such additional factors as wall geometries, different minimum feature capabilities of the photoresist, whether a small positive feature or a small negative feature is desired (for example, a small aperture or else a narrow wall or small post). Thus, some embodiments of the invention may analyze a geometry of a device or structure on a layer by layer basis in order to determine the type of features that are present on a particular layer. Based on the results of that determination, a particular photoresist may be chosen to pattern that layer. The geometry analysis may be performed, for example, by a suitable processing device running a suitable software program, or may be performed by hardware, firmware or a combination thereof. For example, 3-D CAD software may be used to analyze the geometry of a device by cross-sections. Based on this analysis, one type of photoresist may be used for a cross-section having one thickness, while another photoresist might be used for a different cross-section having a different thickness. Similarly, the software might analyze feature sizes on different layers of the device and different photoresists may be chosen for different layers based on the analysis.

Some embodiments of the invention may also modify patternable mold material (e.g. dry film or liquid photoresist) development parameters on a layer-by-layer basis based on, for example, the wall geometries, different minimum feature capabilities of the photoresist, whether a small positive feature or a small negative feature is desired. Exemplary modifiable development parameters include, for example, developer and rinse droplet size, the pressures under which the developer and rinse are applied, and the like.

In addition, after a patternable mold material development and/or stripping process, residue of the patternable mold material may be more likely to remain where particular geometries or feature sizes are present. Thus, some embodiments of the invention may determine on a layer by layer basis, for example, using software, whether there is likely to be a residue of patternable mold material remaining after development and/or stripping of the patternable mold material based on particular geometries or feature sizes. In this manner, removal of residue, or focused removal operations, may be performed only on those layers or portions of a layer where it is required. The residue of patternable mold material may be removed, for example, by a plasma etch.

As discussed above, one method for applying a photoresist is to use a dry film laminator incorporating lamination roller 34 and secondary roller 38 shown in FIG. 5(h). A schematic diagram of a laminator used according to some embodiments of the invention, is shown in FIG. 8. As shown, a roll of dry film resist 98 is located around one roller 34 which is spaced from a second roller 38. As shown, the upper roller 34 (adjacent to resist 98) would normally be heated. Substrate 106 (e.g. a circular disk) is pushed between the two rollers to apply the dry film resist. Because of a non-uniform feeding effect that may occur due to the non-rectangular shape of substrate 106 as it enters between the two rollers, the resist applied to the substrate 106 may be wrinkled or otherwise distorted.

Thus, some embodiments of the invention provide a carrying template for holding the substrate 106 (or substrate 106 in a carrier such as carrier 1) as it is passed through the hot roll laminator 104. An exemplary embodiment of a template 109 for this purpose is shown in FIG. 9(a). Template 109 comprises a plate including an aperture 110 passing entirely through the plate for holding the substrate 106. Aperture 110 may be of a suitable size to properly receive and hold substrate 106. In some embodiments, the template thickness is sized such that the top surface of substrate 106 will be substantially flush with the top surface of the template 109 (i.e., either flush with the top surface or within a small amount of being flush, for example, within one millimeter). While secured in device 109, the lamination applied to the substrate 106 will be substantially undistorted as it enters between the rollers because the rectangular front edge of the template 109 will be grabbed by the rollers rather than the wafer itself.

FIG. 9(b) shows another embodiment of a carrying template 112 that may be used to hold substrate 106 during the lamination process. Carrying template 112 differs from carrying template 109 shown in FIG. 9(a) in that aperture 115 does not pass entirely through carrying template 112, but instead has a bottom as shown. The depth of aperture 115 may be chosen such that the top surface of substrate 106 will be substantially flush with the top surface of the template 109.

According to embodiments wherein multiple layers are added to the substrate during a process flow like that shown in FIGS. 4(a)-(i), it may be required to use multiple templates for the lamination process. Each template may have a different thickness or aperture depth corresponding to a new height of the substrate after an additional layer or layers has been added. According to other embodiments, the template may include shims or other height adjustment members that are used for the initial layers. The shims may be removed or interchanged as the height of the substrate increases. According to embodiments wherein the top surface of substrate 106 is lower by a small amount than the top surface of the template 109 (for example, by one millimeter) template thickness or aperture depth may not require adjustment each time a new layer is added (i.e., a given thickness or depth may cover a range of substrate thicknesses).

An exemplary embodiment using shims is shown in FIGS. 10(a)-(b). In FIG. 10(a), template 112 holds substrate 106 before the addition of any layers to the substrate. The substrate 106 sits on a suitable number of shims 113 such that the top surface of the substrate is substantially flush with the top surface of the template 112. FIG. 10(b) shows substrate 106 after a build 114 of layers has been added to the substrate. Shims 113 have been removed since the new height of the substrate allows the top surface of the substrate to be substantially flush with the top surface of the template 112 without the shims.

According to further embodiments, a screw adjustment, spring loader, or other suitable mechanism may be used in place of the shims in order to keep the substrate 106 (or the top surface of build 114) substantially flush with the top of the template 112 or in another suitable position, for example, some distance above the top surface of the template 112.

According to yet other embodiments of the invention, the substrate may itself have a rectangular shape. In this case, a template such as template 112 may not be required to avoid wrinkling or other distortion of the resist applied to the substrate.

When multiple layers are added to the substrate during a process flow like that shown in FIGS. 4(a)-(i), as additional layers are added to a substrate and laminated, the conditions of the lamination process may be altered. As an example, as additional metal layers are added to the substrate, a point may be reached where the mass built on the substrate begins to pull excessive heat away from the resist (by means of conduction and the increase in thermal mass) and thereby results in poor adhesion of the resist to the substrate or other problems.

Therefore, according to some embodiments of the invention, the conditions of lamination (for example, feed rate, roller temperature, pressure, and the like) may be altered during the process of forming multi-layer structures (e.g. based on a determination of the thermal mass and conductivity of build 114 or more simply based on the total layer height added). One embodiment of the invention provides a method for operating a lamination system wherein the identity of a substrate about to enter the system is determined (for example, using the carrier identification device 19 discussed above). Then, a determination of thermal mass and conductivity is determined for the identified substrate based on, for example, determining the number of layers on the substrate, the total thickness of the layers, percentages and types of metals in the layers, and the like. Alternatively, in some embodiments, it may be sufficient to determine simply the total current layer height and to adjust process parameters accordingly.

The lamination parameters are then adjusted to achieve optimal adhesion of the patternable mold material to the layer being laminated based on the determined thermal mass and conductivity. According to some embodiments of the invention, the determination of thermal mass and conductivity and adjustment based thereon may be performed manually or automatically, for example, by a suitable processing device running a suitable software program, or may be performed by hardware, firmware or a combination thereof.

To enhance adhesion of photoresist to material 31 or to any of the materials that may be present on a previous layer of a multilayer structure built according to some embodiments of the invention, microetches may be used. For example, microetchants suitable for enhancing adhesion to copper include CE-100 Copper Etchant (Transene Company Inc., Danvers, Mass.). Microetchants suitable for enhancing adhesion to nickel include TFB Nickel Etchant, Type 1 Nickel Etchant and TFG Nickel Etchant (Transene Company Inc., Danvers, Mass.). Microetchants suitable for enhancing adhesion to gold include GE-8148 Gold Etchant (Transene Company Inc., Danvers, Mass.). Alternatively, mechanical roughening (e.g., application of abrasive such as pumice) may be used to enhance adhesion. Alternatively, an adhesion promoter (e.g., HMDS (hexamethyldisilazane) may be applied to the surface to be coated with resist, in which case special treatments (e.g., plasma etching) to remove traces of adhesion promoter after developing or stripping and before deposition of structural or sacrificial material may be required.

In some embodiments, structures will be formed using nickel or a nickel alloy as a structural material and using copper as a sacrificial material. It is known that some dry film photoresists adhere better to copper than nickel. As adhesion is important to successful layer patterning, in some embodiments it may be desirable to enhance adhesion between a dry film, or other photoresist, and the substrate or previously formed layer. Such adhesion enhancement may occur in a variety of ways, for example (1) by roughening the surface of the substrate or previous layer to enhance mechanical bonding between the dry film, or other photoresist, and the surface, and/or (2) by applying a material to the substrate that adheres well to the materials of the previous layer and which can also chemically bond with the photoresist. For example, if the previous layer comprises regions of a first material (e.g. copper) and a second material (e.g. nickel), a dry film may chemically bond with first material upon pressing and/or heating whereas it may only mechanically bond with the second material. If a thin seed layer of the first material or of another material that has similar adhesion properties may be applied to at least the regions of the previous layer occupied by the second material, then good adhesion between the photoresist and the entire previous layer or substrate may be achieved.

Depending on how the seed layer is applied; depending on whether it is acceptable for the seed layer material to exist between layers of the structural material, between layers of the sacrificial material, and/or between layers of different materials; depending on the order of depositing the structural material and the sacrificial material; and/or depending on the order of deposition of the first material and the second material different process flows may be defined which allow for successful fabrication where good adhesion between photoresist and substrates and/or previously formed layers may be obtained.

For example, one such embodiment may contain the following steps or operations: (0) assume the sacrificial material is the first material and is the material that is to be deposited first; (1) apply a thin seed layer (e.g. less than 1 micron, more preferably less than 0.5 microns, and even more preferably less than 0.2 microns) of sacrificial material to the previously formed layer; (2) apply and pattern the photoresist, (3) deposit the sacrificial material to a height at least as great as the layer thickness, which may for example be 2 microns or less, 5 microns or less, 10 microns or less, and even 50 microns or more, (4) remove the photoresist, (5) perform a flash etch to remove a thickness of sacrificial material equal to or somewhat greater than the height of the seed layer to exposure regions of structural material that exist on the previous layer, and (6) selectively or blanket deposit the structural material to a height at least as great as the layer thickness, and (7) planarize the deposited material to complete formation of the layer.

Another such embodiment might involve the following steps or operations: (0) assume the structural material is the second material and is the material that is to be deposited first; (1) apply a thin seed layer of sacrificial material to the previously formed layer; (2) apply and pattern the photoresist, (3) perform a flash etch to remove exposed regions of the seed layer, (4) deposit the structural material to a height of at least one layer thickness, (5) remove the photoresist, and (6) selectively or blanket deposit the sacrificial material to a height at least as great as the layer thickness, and (7) planarize the deposited material to complete formation of the layer. Other alternative embodiments based on other build option selections are possible and will be apparent to those of skill in the art upon reviewing the teaching herein.

In some alternative embodiments, steps or operations (5) and (4) (the seed layer removal operations) of the above two outlined embodiments, respectively, may be eliminated if the depositions are very thin to begin with, or they may be partially eliminated by not necessarily trying to eliminate all exposed seed layer material. It may not be necessary to completely remove all seed layer material if it is thin enough or made to be thin enough as extremely limited access to any sacrificial material located between successive regions of structural material on adjacent layers may substantially eliminate risk of etching resulting in delamination. Such alternatives may also require that any sandwiched sacrificial material (i.e. located between layers of structural material) not have any other negative impact (e.g. reduction in strength of the structure, reduction in conductivity, or the like) on the structure as it is intended to be used.

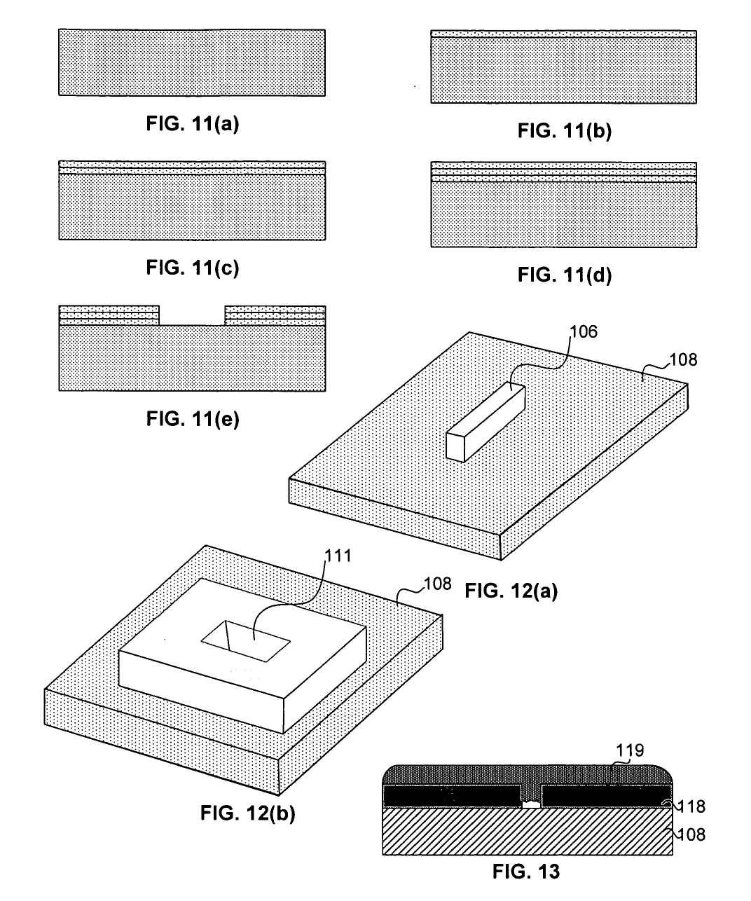

According to some embodiments of the invention, multiple layers of photoresist may be added in succession to the substrate to obtain a thicker photoresist before any patterning of the photoresist is performed. FIG. 11(a)-(e) shows an embodiment of this process. In FIG. 11(a), a substrate 115 is provided. In FIG. 11(b), a first layer of photoresist is applied, for example by the lamination roller 104 shown in FIG. 8(a). This process is repeated and a second layer of photoresist is applied, as shown in FIG. 11(c). This process is repeated again and a third layer of photoresist is applied, as shown in FIG. 11(d). After a final layer has been applied, patterning of the thick photoresist may be performed, as shown in FIG. 11(e). In some alternative embodiments, exposure (i.e. latent patterning) may occur after all layers of photoresist have been accumulated or exposure may occur one or more times prior to accumulating all layers of photoresist. In either alternative, development of photoresist is preferably delayed until after all layers of photoresist are formed.

Dry film resists may be used as the patternable mold material, according to some embodiments of the invention. Dry film resists typically come in layers having a thickness between 10 and 50 microns. A thinner resist may allow for smaller feature sizes. Thus, according to some embodiments of the invention, after a single layer of dry film resist is applied to the substrate, for example by the lamination roller 104 shown in FIG. 8(a) but before patterning the resist, the layer is thinned to a desired thickness. Thinning of the dry film resist layer may be done in any suitable manner, for example by plasma etching. Alternatively or additionally, a suitable dilute chemical stripper may be used to thin the dry film resist layer.

Alternatively, rollers or plates may be used to thin the dry film resist layer by the application of pressure. It may desirable to have the roller or plate heated. In addition, because of the aqueous nature of the dry film resist layer, moisture may make the film more flowable. Thus, it may also be desirable to wet the dry film resist layer if a roller or plate is used. Also, the dry film resist layer may be thinned by cutting with a tool, for example a diamond fly cutter. Further, the dry film resist layer may be thinned by abrading, for example by sandblasting or by lapping.

If a dry film resist is used, the supplied top cover sheet (not shown) may be removed to improve resolution capability. Exposure to oxygen may then however inhibit polymerization, in which case the sheet may be removed just prior to exposure. Some embodiments of the invention may replace the sheet with a thinner oxygen barrier, or exposure may be conducted in an inert gas such as nitrogen.

In some embodiments that use dry film or liquid based resists, non-planarities in the surface of an applied film or cured liquid resist may be removed by a planarization operation prior to any exposure of the photoresist, if it is believed that the surface irregularities may lead to irregularities in exposure of the resist. If it is difficult to achieve a planar coating of resist as a result of depressions or protrusions on a surface to which the resist is applied, it is possible that two or more applications of resist, (e.g. liquid resist) possibly with one or more intermediate curing operations, will lead to more uniform, or planar, resist surfaces.

Referring now to FIG. 5(i), according to some embodiments of the invention, material 33 has been removed (for example, by trimming) if necessary so it does not cover up alignment target pattern 35 on insert 5. Trimming may be done, for example, by a mechanical knife or other suitable cutting tool. Alternatively, trimming may be done by applying pressure to an area adjacent to the area to be trimmed (i.e. to the area of targets) and then tearing the material 33 away. Pressure may be applied, for example, by a plate or tool having a sharp or serrated edge. In some embodiments, the plate may contact material 33 only in areas adjacent to the desired tear but not in other areas, to prevent damage. According to other embodiments, the material 33 to be trimmed may be isolated from the remainder, for example, by an elastomeric seal, and chemically dissolved by stripping or developing the material 33 to be trimmed.

According to other embodiments, trimming of material 33 may be avoided in several ways. For example, in some embodiments the roll of material 33 may be slit to a width such that it will not cover alignment target pattern 35 when applied. Further, roller 34 may be sized such that its contact area is only as wide as the area to be laminated. In this case, the roller does not apply heat and pressure to the area of the carrier or substrate that includes the alignment targets. According to other embodiments, a release film may be used to cover the targets. The material 33 would then stick to the release film rather than to alignment target pattern 35. The release film may be, for example, mylar, and may be peeled away after lamination of the material.

In other embodiments, it may not be required to trim material 33 if vacuum applied between substrate and photomask is used to temporarily draw the material 33 up against the photomask surface to verify alignment. In this case, material 33 may become flat against the mask and may not substantially distort or displace the image of the target.

Patterns 35 and 36 may be protected by coating inserts with a hard protective layer. Cover 7 has been removed to expose patterns 35 and 36. Patterns 35 and 36 are each a diamond, cross, circle, square, or other pattern suitable for precise optical alignment, preferably using automated machine vision equipment. According to some embodiments of the invention, patterns 35 and 36 may be formed on inserts 5, the latter being rigidly mounted to carrier 1 (for example, as a press fit or with a suitable adhesive), or else may be formed directly on carrier 1 (for example, by engraving or etching).

Referring to FIGS. 5(i)-(j), carrier 1 is affixed to stage 40 such that photomask 42—consisting of substrate 37 (for example, glass or quartz) and non-transmitting coating 39 that is patterned to form clear regions 41 representing the cross-section of the first layer of the desired structure (or its complement)—is above patternable material 33. Photomask 42 is preferably arranged with coating 39 in close proximity to material 33. Photomask 42 may be coated with a non-adherent film such as Teflon®, SYTOP® (Asahi Glass Co., Ltd.) or parylene to reduce the risk of material 33 adhering to it, especially if material 33 is dry film resist from which the cover sheet has been removed. To reduce diffraction and improve resolution, some embodiments of the invention provide an index matching liquid (for example, water, not shown) in the gap between photomask 42 and material 33 to provide a refractive index more closely matching that of photomask substrate 37 and/or patternable material 33.

Referring to FIG. 5(j), according to some embodiments of the invention, the coating portion of mask 42 and the surface of material 31 are adjusted to be highly parallel. Since material 33 is relatively uniform in thickness, this can be accomplished by temporarily allowing pitch and roll motion of carrier 1 on stage 40, raising carrier on stage 40 until coating 39 and material 33 are in contact, then preventing further pitch and roll motion and lowering carrier 1 again to produce a gap which will allow for relative alignment. Parallelism is required to obtain the best resolution, to produce sidewalls that are substantially orthogonal to the surface of substrate 25, and other distortions. According to some embodiments of the invention, various methods of aligned patterning may be used, including, but not limited to, contact alignment, proximity alignment, stepper alignment, scanner alignment, or projection alignment.

As shown in FIG. 5(j), photomask 42 is provided with alignment targets such as 43 and 45. For purposes of illustration, alignment target 43 is shown as necessarily having a clear field (i.e., free of coating 39 except in a small area), while target 45 is shown optionally as having a dark field (i.e., having coating 39 everywhere except in a small region); however, a clear field target is also suitable for target 45. Initially targets 43 and 35, and targets 45 and 36, respectively, are not aligned, as shown in FIG. 5(j). Photomask and substrate targets are designed so that both remain visible when the photomask and target are well-aligned.

FIG. 5(j) illustrates two alternative embodiments for imaging the alignment targets on both carrier 1 and photomask 42. The first embodiment is illustrated by the imaging system 47 shown on the left side of the figures. The second embodiment is illustrated by the two imaging systems 51 and 53 shown on the right side of the figures. However, it should be understood that during the following discussion of the first and second embodiments, it is assumed that both the left and the right side of the figures include the imaging systems of the embodiment under discussion.

Both embodiments allow for alignment of each successive photomask pattern to carrier 1 (i.e., to substrate 25) rather than to the previously-deposited layer, to advantageously avoid the accumulation of errors that can lead to poor registration of layers. In the first approach, imaging system 49 (here assumed to be an electronic camera with microscope optics, though direct observation is also possible with the second embodiment) can be moved vertically on precision stage 50, preferably having excellent straightness of travel with minimal roll, pitch, and yaw or translation other than axial. Stage 50 is preferably aligned so that its axis of travel is both extremely parallel to the optical axis of system 49, and extremely perpendicular to the photomask bottom surface (i.e., coating 39).

In the position shown, system 49 can focus on target 35 in its current position. As layers are added and carrier 1 descends gradually, system 49 can be lowered on stage 50 in order to remain focused on target 35 even if the amount of motion of carrier 1 exceeds the depth of focus of the optics of system 49 (for example, several microns or tens of microns). System 49 can also be raised (shown as phantom lines 47) to focus on photomask target 43. It should be noted that the directions indicated (raised, lowered, etc.) refer to the figures and that other embodiments are possible in which the apparatus moves in other directions than those shown. It should also be noted that although in the embodiment shown the photomask is stationary while the substrate moves, other embodiments may keep the substrate stationary, while the photomask moves. In this case, the optics of system 49 looking at photomask may move with the photomask.

According to the second embodiment, two imaging systems 51 and 53 are used to independently (and if desired, simultaneously) focus on targets 45 and 36, respectively. Thus, there are two different focal points. If desired, the optical axes of systems 51 and 53 can be made coaxial (not shown) through the use of, for example, a beamsplitter or similar device. System 53 can be lowered on stage 52 (similar to stage 50 in terms of precision and alignment, but optionally with shorter travel) in order to remain focused on target 36. System 51 may remain fixed and focused on target 45. Both embodiments are shown by way of illustration. However, normally one embodiment or the other may be used for alignment of all targets that are used (the minimum number of targets needed to obtain alignment in X, Y, and theta (rotation) is two).

Assuming that the first embodiment is being used and that there are two targets each on both photomask 42 and carrier 1, then in FIG. 5(j) the focused images of targets 43 (now assumed to be two distinct targets) are formed by imaging systems 49 (now assumed to be two distinct imaging systems) when raised into focus (as shown by phantom lines 47) using stage 50. When systems 49 are at a lower position of stage 50, the focused images of targets 35 are formed by them.

Images are recorded of targets 43 and 35 and compared (for example, by superimposing them) by an operator or by a machine vision system to determine the degree of misalignment, and carrier 1 is repositioned in X, Y, and theta to achieve alignment, as is shown in FIG. 5(k). Note that target 43 must be designed so as to allow target 35 to be viewed through it.

Assuming that the second embodiment is being used and that there are two targets each on both photomask 42 and carrier 1, then in FIG. 5(j) the focused images of targets 45 (now assumed to be two distinct targets) are formed by imaging systems 51 (now assumed to be two distinct systems). When imaging systems 53 (now assumed to be two distinct systems, for a total of four imaging systems, i.e. two on the left and two on the right of the FIGS.) are at a lower position of stage 52, the focused images of targets 36 (now assumed to be two distinct targets) are formed by them.

Images are recorded of targets 45 and 36 and compared (for example, by superimposing them, which can be done electronically even though the targets are not physically overlapping) by an operator or by a machine vision system to determine the degree of misalignment, and carrier 1 is repositioned in X, Y, and theta to achieve alignment, as is shown in FIG. 5(k). Note that photomask 42 requires a clear region 54 through which to view target 36, but target 45, which is not coincident with region 54, can have any suitable geometry and be either clear or dark field.

According to some embodiments of the invention, as layers are added to substrate 25, the focus of the imaging systems may be adjusted automatically by lowering the imaging system by an amount that is based on data regarding the thickness of the layer that has been added. In addition, the data regarding the thickness of the layer may be used to verify that an expected thickness of a layer that has been added actually has that thickness. For example, when the imaging system is lowered a specified amount based on the thickness data, the imaging system should be focused properly. If the imaging system is not focused properly, this may indicate that the layer does not have the expected thickness. Such a determination may require that a patternable mold material layer thickness is consistent. The automatic adjustment and determination may be performed, for example, by a suitable processing device running a suitable software program, or may be performed by hardware, firmware or a combination thereof.

According to other embodiments, an imaging system including a camera using a large depth of focus, such as a long-working distance lens or a telecentric lens may be used in place of the cameras discussed above. In this case, movement of the imaging system may be avoided, as the large depth of focus of the lens may be sufficient to cover a large gap between targets 43 or 45 and targets 35 or 36.

According to another embodiment of the invention, backside alignment may be performed by placing targets on the back side of carrier 1. Referring to FIGS. 28(a)-(b), photomask 144 is provided with alignment targets 145 and 146. Carrier 1 is provided with alignment targets 147 and 148, which are formed on the backside of the carrier 1 (for example, as a press fit), or else may be formed directly on carrier 1 (for example, by engraving or etching). As shown in FIG. 28(a), back-side imaging system 149 includes two cameras which face upward towards the photomask 144.

Initially, imaging system 149 stores the images of alignment targets 145 and 146 on photomask 144. Then, as shown in FIG. 28(b), carrier 1 is placed between imaging system 149 and photomask 144. The live images of the alignment targets 147 and 148 are aligned with the previously stored images of alignment targets 145 and 146.

Backside target alignment as described above is advantageous for various reasons. For example, because the targets 147 and 148 are isolated from the patternable mold material being applied, they cannot be obscured by the patternable mold material. Also, the targets 147 and 148 cannot be damaged by lapping or other abrading operations performed on the opposite side of carrier 1 or by plating baths to which the targets may be exposed. In addition, when using back side alignment, as more layers are added to carrier 1, there is no limitation to the number of layers that may be added to the substrate because the photomask will not come in contact with the imaging system, as it might in the front side alignment system previously described.

The embodiments described above for performing alignment in relation to alignment targets located on the carrier are equally applicable to embodiments of the invention having alignment targets located on the substrate, as will be discussed below.

Whatever embodiment is used for alignment, once photomask 42 and carrier 1 are in alignment, carrier 1 is preferably raised on stage 40 so that coating 39 is in contact with material 33, as shown in FIG. 5(k), prior to exposing material 33. Vacuum may be applied between photomask 42 and carrier 1 to increase contact pressure, and carrier 1 may be provided with specialized means of obtaining a vacuum seal against photomask 42, such as an elastomeric seal. Alternatively, a seal entirely made from elastomer or at least whose upper surface is elastomeric may be provided on stage 40, surrounding carrier 1. Similarly, contact between coating 39 and the surface of material 33 can be improved by applying gas pressure to force the two together.

In FIG. 5(l), material 33 is being exposed to light (for example, ultraviolet) that is preferably highly-collimated and which passes through photomask 42 in clear regions 41. In FIG. 5(m), photomask 42 has been removed and material 33 has been developed to yield a pattern corresponding to that of coating 39, with regions 57 no longer covering material 31. Note that in the example illustrated, material 33 behaves as a negative-working resist, becoming insoluble to the developer in those regions exposed to light. According to other embodiments, a material with the opposite (positive-working) characteristics may also be used.

Development, in the case of a dry film photoresist, may be performed by, for example, spraying an alkaline aqueous developer at coating 33 in a controlled and uniform fashion and at the correct temperature, followed by rinsing. To develop dry film photoresist so as to achieve good yield on small features and as uniform development as possible, a closely-spaced array of direct-fan or atomizing nozzles (for example, air-atomizing nozzles behaving like an airbrush) with a narrow spray angle (for example, 15 degrees) may be used for both developing and rinsing. These nozzles may be arranged in several closely-spaced staggered rows if they cannot be closely enough spaced in a single row. Some overlap between the nozzles may be provided to improve uniformity. If nozzles with a fan-type spray pattern are used, the major axis of the fan may be rotated by a small angle (for example, 15 degrees) from the normal to the direction of travel of the resist to minimize interference and turbulence of one nozzle with its neighbor. The use of a narrow spray angle and close spacing of nozzles provides an angle of incidence of the developer or rinsing solution that is as uniformly orthogonal as possible to the resist surface. This is in contrast to developing and rinsing equipment commonly used in the fabrication of printed circuit boards, in which a few, widely-spaced nozzles with large spray angles (for example, 45 degrees or more) are common. Also, in contrast to normal processing wherein resist is moved slowly and unidirectionally with respect to the nozzles, some embodiments of the invention may move resist bidirectionally and quickly with respect to the array of nozzles so as to improve uniformity of processing and yield, minimizing the processing that occurs with pooled (vs. ejected) liquid. If all of coating 33 is not removed in regions 57 (for example, a thin residue remains), this may be removed by methods such as plasma etching (for example, in an oxygen plasma), mechanical abrasion, and the like, such that material may be electrodeposited onto material 31 and excellent adhesion obtained.

In FIG. 5(n), optional insulating material 59 has been applied over the edge of material 31 to prevent electrodeposited material from being deposited near the edge of material 31. Preferably material 59 is easily removable (for example, by melting or chemical dissolution). In FIG. 5(o), substrate 25 has been immersed in an electrodeposition tank. Conventionally, the substrate itself may seal against the electrodeposition tank. However, some embodiments of the invention, as shown in FIG. 5(o), allow carrier 1 to seal against tank 62. Gasket 61 makes contact with material 31 or, as shown, with material 59, forming a seal which prevents deposition in the vicinity of insert 5 or on any other portion of carrier 1. As shown, the carrier is located on the floor of the electrodeposition tank; however, the carrier may also be located in the ceiling or wall of the tank, or in a fixture that is placed into the tank. According to some embodiments of the invention, the plating bath in the electrodeposition tank may include a filler material along with a plating material. The filler material may accelerate the deposition rate of a plating material during the plating process. For example, when the plating material is copper, the filler material may be copper particles. In addition to metal particles, hollow or solid polymer spheres, ceramic particles, and other materials which displace volume and can be co-deposited with plating material so as to increase deposition rate may be used. Such particles may also be incorporated into an anode used during the plating process.

According to some embodiments of the invention wherein an adhered patterned material is used as the patternable mold material, in order to improve uniformity of deposition rate counter electrode 64 may be located at a closer proximity to the surface of the mold material in the bath 60 than is shown in FIG. 5(o), in some embodiments being in contact or near-contact with the mold material.

Tank 62 is filled with electrodeposition bath 60 and counter electrode 64 is placed inside bath 60. Current is applied through bath 60 using power supply 66. As shown, supply 66 provides a direct current of a specific polarity which may be continuous or pulsed. However, if the material to be deposited requires a cathode counter electrode the polarity would be reversed. Also, some embodiments of the invention may use a supply of ‘pulse-reverse’ current in which the current changes polarity periodically. By the application of current from supply 66, deposit 63 of a first material is created in regions 57.

In FIG. 5(p), the remaining regions of material 33 are removed, leaving a patterned deposit of material 63 with blank regions 76. Such ‘stripping’, in the case of a dry film photoresist, may be performed by spraying an appropriate alkaline aqueous ‘stripper’ at coating 33 in a controlled and uniform fashion and at the correct temperature. If all of coating 33 is not removed by the stripper (for example, a thin residue remains in regions 76), this may be removed by methods such as plasma etching (for example, in an oxygen plasma), mechanical abrasion, and the like, such that material may be electrodeposited in regions 76 of material 31 and excellent adhesion obtained.

In FIG. 5(q), substrate 25 has been immersed in an electrodeposition tank. As shown, carrier 1 forms the floor of tank 68. Gasket 74 makes contact with material 31 or, as shown, with material 59, advantageously forming a seal which prevents deposition in the vicinity of insert 5 or on any other portion of carrier 1. Tank 68 is filled with electrodeposition bath 72 and counter electrode 70 is placed inside bath 72. Current is applied through bath 72 using power supply 78. As shown, supply 78 provides a direct current of a specific polarity which may be continuous or pulsed. However, if the material to be deposited requires a cathode counter electrode the polarity would be reversed. Also, a supply of ‘pulse-reverse’ current may also be used in which the current changes polarity periodically. By the application of current from supply 78, deposit of a second material 65 is created in regions over material 63, contacting material 31 in regions 76.

According to some embodiments of the invention, one of the first and second materials is a structural material, while the other is a sacrificial material. The patternable mold material used (for example, photoresist or solder mask) may be one that is capable of achieving only small positive features (for example, walls or posts). Alternatively, the patternable mold material may be one that is capable of achieving only small negative features (for example, holes or slots). Some embodiments of the invention may select the order in which the sacrificial and structural materials are deposited for a particular layer having a particular patternable mold material deposited thereon, based on characteristics of features that are to be patterned on the layer and whether the particular patternable mold material produces smaller positive or negative features with better yield or quality (if both are not produced equally). For example, the order of deposition may be selected based on whether small negative or small positive features of structural material are to be patterned on the layer. Referring to FIG. 12(a), as an example of a small positive feature, a small narrow wall of metal (for example nickel) is shown after patterning. Referring to FIG. 12(b), as an example of a small negative feature, a small narrow aperture surrounded by a metal (for example nickel) is shown after patterning.

Furthermore, the order of deposition may be selected based on an aspect ratio of a feature or features. As an example, as shown in FIG. 13, sacrificial material 118 is deposited on substrate 108 in a pattern. Structural material 119 is blanket deposited over sacrificial material 118 and into the aperture as shown. If the aspect ratio of the aperture is too high, there may be a void, i.e., structural material 119 may not penetrate to the bottom of the aperture due to deposition on the sidewalls of material 118 competing with deposition onto substrate 108. In such a case, it would be desirable to first deposit the structural material 119 rather than the sacrificial material 118, since the first deposition would be within an insulating material (for example, photoresist or solder mask).

As another example, the order of deposition may be determined on a layer by layer basis based on a desired grain structure for a structural material. The grain structure of the structural material may vary based on whether the structural material is deposited before or after the sacrificial material is deposited. If the structural material is deposited into an aperture wherein the walls of the aperture are patternable mold material and thus non-conductive, a particular grain structure will occur wherein the grains grow from the bottom of the aperture in an upward direction. However, if the structural material is deposited into an aperture wherein the walls of the aperture are a conductive material that was deposited first (for example, the sacrificial material), a different grain structure will occur wherein the grains grow laterally from the walls of the aperture as well as from the bottom of the aperture in an upward direction. Either grain structure may be desirable for particular applications.

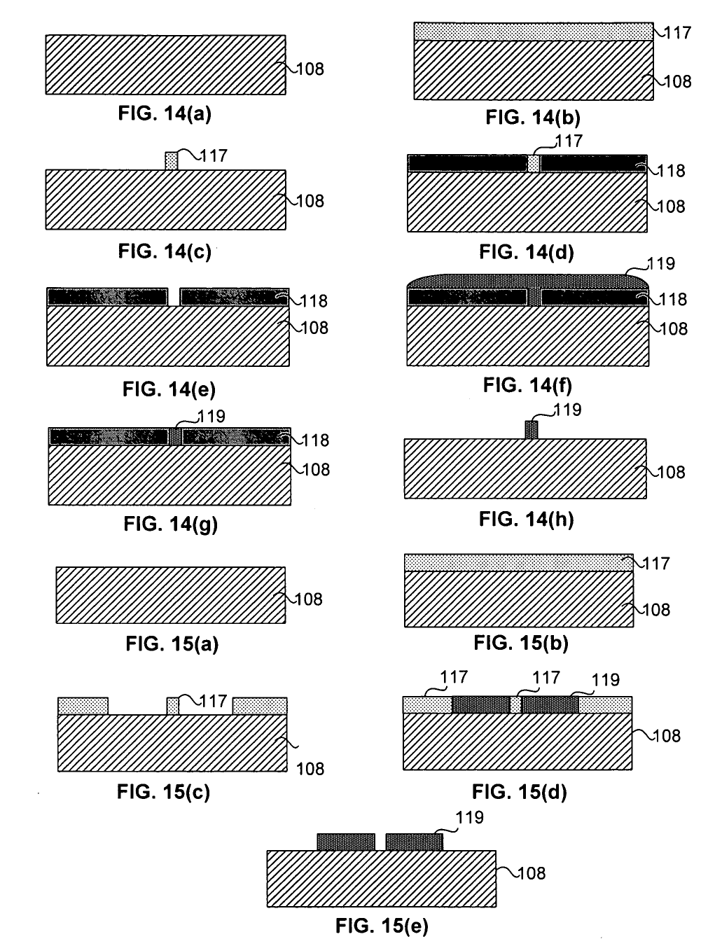

As an example of a process for patterning a small positive feature of structural material—the small narrow wall shown in FIG. 12(a)—using a patternable mold material that produces better or higher-yielding positive features, some embodiments of the invention may, for a particular patternable mold material, deposit a sacrificial material first and then deposit a structural material, as illustrated in FIGS. 14(a)-(h). FIGS. 14(a)-(h) show an embodiment of a process for forming the narrow wall shown in FIG. 12(a). In FIG. 14(a), a substrate 108 is shown, onto which patternable mold material 117 (for example, photoresist or solder mask) has been deposited as shown in FIG. 14(b). In FIG. 14(c), material 117 has been patterned (for example, if a photoresist, by use of a photomask, developing, etc., by laser direct imaging, a pattern generator and the like or, a combination of these methods) to produce a small wall of material 117. In FIG. 14(d), sacrificial material 118 (for example, a metal such as copper) has been deposited around the small wall of material 117 (for example, by electrodeposition).

In FIG. 14(e), material 117 has been removed (for example, by use of a chemical stripper) to expose regions of the substrate 108 which are not covered with sacrificial material 118, leaving an aperture having the desired pattern. In FIG. 14(f), structural material 119 (for example, a metal such as nickel) has been deposited over the entire substrate 108 and into the aperture. In FIG. 14(g), the layer has been planarized to a sufficient depth to remove all of structural material 119 overlying sacrificial material 118, and also to establish a layer of the desired thickness, flatness, and surface finish. The sacrificial material 118 is then ultimately removed, as shown in FIG. 14(h), leaving the desired narrow wall of structural material 119.

As an example of a process for patterning a small negative feature of structural material (for example, the small narrow aperture shown in FIG. 12(b)) using a patternable mold material that produces better or higher-yielding positive features, some embodiments of the invention may, for a particular patternable mold material, deposit a structural material first and then deposit a sacrificial material, as illustrated in FIGS. 15(a)-(e). FIGS. 15(a)-(e) show an embodiment of a process for forming the narrow aperture shown in FIG. 12(b). In FIG. 15(a), a substrate 108 is shown, onto which patternable mold material 117 (for example, photoresist or solder mask) has been deposited as shown in FIG. 15(b).

In FIG. 15(c), material 117 has been patterned (for example, if a photoresist, by use of a photomask, developing, etc., by laser direct imaging, a pattern generator and the like or, a combination of these methods) to produce a small wall of material 117. In FIG. 15(d), structural material 119 (for example, a metal such as nickel) has been deposited around the small wall of material 117 (for example, by electrodeposition). The photoresist is then removed, as shown in FIG. 15(e), leaving an aperture in the nickel. Sacrificial material (for example, a metal such as copper) (not shown) may then be blanket deposited (for example, by electrodeposition) over the substrate to form other structures if necessary.

The determination of whether the structural or sacrificial material is deposited first may be performed, for example, by a suitable algorithm that analyzes cross sections of each layer and makes the determination. The determination may be made based on various factors. For example, some embodiments of the algorithm may determine whether a predefined minimum feature size for positive or negative features exists (for example, 10 or 20 microns) on a layer being analyzed. Other embodiments of the algorithm may determine whether a predefined number of positive or negative features on a layer have a predetermined minimum feature size (for example, 10 or 20 microns). Yet other embodiments of the algorithm may assess the importance of having accurate features on a particular layer. Further embodiments of the algorithm may determine the aspect ratios of features on an analyzed layer. The algorithm may be performed by software, hardware, firmware or a combination thereof.

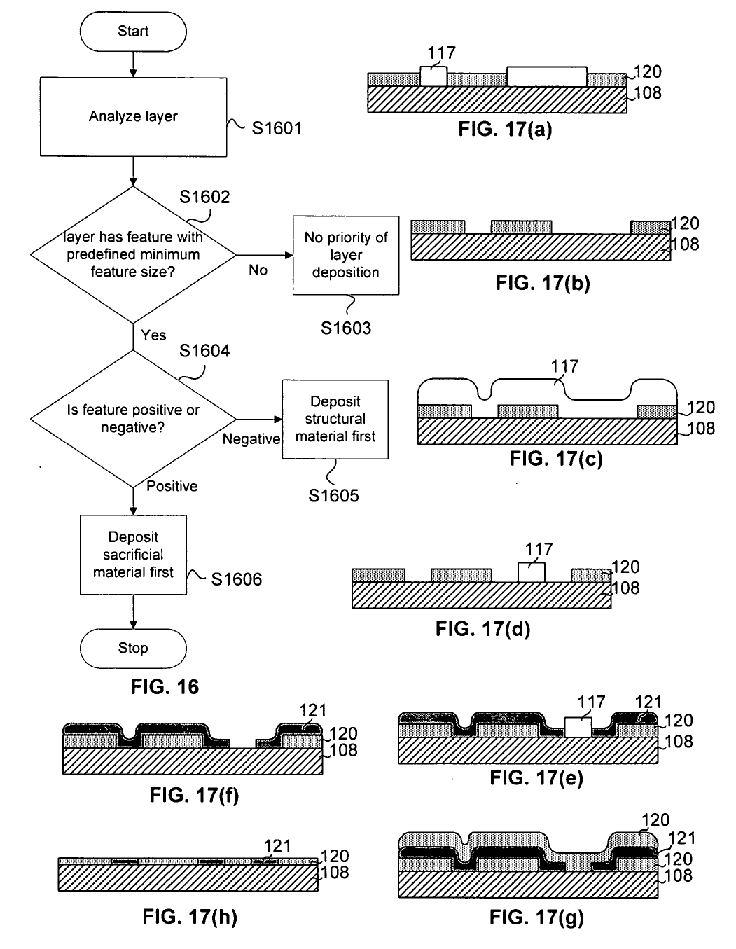

A flowchart of an exemplary embodiment of an algorithm for determining priority of deposition is shown in FIG. 16, assuming in this case that on the layer being considered one is using a patternable mold material that produces better or higher-yielding positive features. At S1601, the layer of interest is analyzed. At S1602, it is determined whether the layer has a feature with the predefined minimum feature size. If there is not such a feature, then no determination of priority of deposition of the sacrificial and structural materials is made (S1603). If there is such a feature, then at S1604 it is determined whether the feature is a positive feature or a negative feature in the structural material for that layer. If the feature is negative, then at S1605 the structural material is deposited first. If the feature is positive, then at S1606 the sacrificial material is deposited first.

The dimensions of the actual negative and positive features (for example those shown in FIGS. 12(a)-(b)) may not be the same as the nominal, i.e., specified dimensions, selected using, for example, computer aided design software. As an example, the nominal width of a positive feature may be designed to be 20 microns, but the actual feature may have a width of 18 microns, while an actual negative feature may have an width of 22 microns, or vice versa. The deviation or offset of the actual dimension from the nominal dimension may not be symmetric in relation to the nominal dimension. In other words, an actual negative feature having a nominal width of 20 microns may have an actual width of 23 microns, while an actual positive feature having a nominal width of 20 microns may have an actual width of 18 microns.

Some embodiments of the invention may determine in advance what the dimension offset will be and may pre-scale edges of a feature, for example using computer aided design software, in order to compensate for any anticipated offsets. Photomasks may thus be created wherein the patterns for patterning positive and negative features include asymmetrical offsets.

Referring now to FIG. 5(r), according to some embodiments of the invention, carrier 1 is placed in planarization fixture 67. Fixture 67 consists of ring 80 with hard stops 82, sliding stages 69, and support 71. Stops 82 are co-planar and formed from a material (for example, polycrystalline diamond, silicon carbide, cubic boron nitride, or aluminum oxide) that wears slowly on plate 73. As shown, surface 3 of carrier 1 mates with support 71. The mating surface of support 71 is adjusted to be extremely parallel with the bottom surface of stops 82, such that as stages 69 descends, materials 63 and 65 will become planarized such that their surface will be very parallel to surface 3. Stages 69 are distributed on the inside of fixture 67 preferably at uniform intervals (e.g., 3 stages 120 degrees apart, 4 stages 90 degrees apart). Alternatively, it is possible to make the surface of carrier 1 that is opposite surface 3 (i.e., the backside of the carrier) highly parallel to surface 3, and provide in fixture 67 a support analogous to support 71 which mates with the backside of carrier 1. Stages 69 may also be replaced by a single stage or linear bearing above carrier 1 and mounted to its backside.

The mating surface of support 71 or its analog may be aligned to be parallel with the bottom of stops 82 by various methods, including the use of an autocollimator. This alignment may also be performed once carrier 1 is held in fixture 67, a more direct and probably more reliable method for achieving the desired parallelism between surface 3 and the bottom of stops 82. In this case, a region of a surface of carrier 1 (for example, the rear surface opposite surface 3) may be given optical smoothness and flatness, as well as a high degree of parallelism to surface 3, to allow alignment using an autocollimator calibrated to establish perpendicularity to the plane of stops 82.

With carrier 1 in fixture 67, materials 63 and 65 are planarized by the use of an abrasive (for example, diamond, aluminum oxide) applied to plate 73, which may be, for example, a lapping plate made of materials such as copper, tin-antimony, cast iron, and copper-resin composite. Alternatively, plate 73 may be composed of an abrasive material and planarization performed by the application of an appropriate lubricant. The planarization process is stopped before materials 63 and 65 are reduced to their final desired thickness.

As shown in FIG. 5(s), according to some embodiments of the invention, measurement sensors 75 are used to measure the thickness of materials 63 and 65 (hereinafter called ‘the layer’). Such sensors may be, for example, dial indicators with high resolutions, LVDT (linear variable differential transformer)-based distance gauges, and the like. Alternatively, non-contact sensors based on light, eddy currents, capacitance, and so forth may be used. Measurements of layer thickness are made by comparing the readings of sensors 75 which measure the position of surface 3 with that of sensors 84 which measure the position of the current as-planarized surface, with both sensors preferably connected to a common support.

Alternatively, if mechanical contact is used, either sensors 75 or 84 (but not both) may be replaced by a fixed-length ball or other probe tip which is mechanically connected to the sensor, reducing the total length of material between sensor and ball so as to minimize variation due to temperature fluctuations and mechanical deflection. Additional sensors similar to sensors 75 and 84 may be provided to determine uniformity of planarization (for example, to determine whether the surface is flat is may be desirable to place multiple sensors at various radii from the center of substrate 25).

After sensing of layer thickness is performed, if additional planarization is required to achieve the desired thickness or flatness of the layer, it is performed as shown in FIG. 5(r), and additional sensing may be done to verify the result as shown in FIG. 5(s), possibly in an iterative fashion. In FIG. 5(t), a layer having a final desired thickness and flatness has been produced, with surface 77 serving as substrate for subsequent layer depositions. After the layer is planarized, a small region 79 of material 65 may remain on the periphery of the deposited area. This completes the formation of a single layer of a multi-layer structure, according to some embodiments of the invention.

Formation of a second layer, according to some embodiments of the invention, begins with a process of patterning a mold material, analogous to that already described in FIGS. 5(h)-(m), but typically using a different photomask pattern representing the second cross-section of the multi-layer structure, which in general is different from that used to pattern the first layer. Different mold material may also be used.

In FIG. 5(u), a patternable mold material 83 (here assumed to be a liquid photoresist, but it may be, for example, a dry film photoresist or an electrodeposited photoresist as well) has been applied to layer surface 77. In some embodiments the resist is applied on top of an antireflection coating 81 to avoid distortions that may be encountered when an area where a feature is to be patterned overlies two or more materials on a previous layer. The problem results from the fact that the two or more underlying materials may each have a different reflectivity and/or may each have a different surface finish. As a result, the patternable mold material overlying the materials in which the feature is patterned may have varying amounts of exposure due to the varying reflection of light from the underlying materials. This may result in a distorted feature. The use of the antireflection coating 81 may reduce such distortion by allowing for a more uniform exposure of the patternable mold material.

If a liquid or electrodeposited photoresist is used, a baking step may be required to dry the liquid photoresist or to consolidate particles in the case of an electrodeposited photoresist. If a carrier is used or if the substrate is thick, a hot plate may be insufficient to perform this baking step. Thus, some embodiments of the invention bake the photoresist using, for example, an oven or infrared or microwave radiation. Whether a hot plate, oven or radiation method is used to bake the photoresist, it may be cooled by placing it on a cool plate, in a refrigerated chamber, or in a flowing stream of air. Such methods may also be used to cool dry film photoresist and laminated substrates after lamination.

Material 83 may be applied by spinning carrier 1 (as assumed here) or by other methods, resulting in an excess thickness 86 (i.e., an edge bead). In FIG. 5(v) excess material thickness 86 has been removed, for example, by chemical dissolution, typically along with some underlying material 83 and material 83 is soft-baked if necessary or otherwise processed to prepare it for exposure. Cover 7 has also been removed to expose patterns 35 and 36.

In FIG. 5(w), carrier is affixed to stage 40 such that photomask 85 (consisting of substrate 86 and non-transmitting coating 87) is above material 83. Photomask 85 is preferably arranged with coating 87 in close proximity to material 83. Photomask 85 may be coated with a non-adherent film to avoid material 83 from adhering to it. To reduce diffraction and improve resolution, a liquid may be provided in the gap between photomask 85 and material 83 to more closely match refractive index. Coating 87 and the surface of material 31 are adjusted to be highly parallel, as before.

In FIG. 5(x), photomask 85 and carrier 1 have been brought into alignment as before with photomask 42 and carrier 1. Carrier 1 is also raised on stage 40 so that coating 87 is in contact with material 83 prior to exposing material 83.

In FIG. 5(y), material 83 is being exposed to light (for example, ultraviolet) that is preferably highly-collimated and which passes through photomask 85 as before. In FIG. 5(z), photomask 85 has been removed and material 83 has been developed to yield a pattern corresponding to that of coating 87 as before. Note that in the example illustrated, material 83 behaves as a negative-working resist, becoming insoluble to the developer in those regions exposed to light; a material with the opposite (positive-working) characteristics may also be used.

If all of material 83 is not removed in regions 90 (for example, a thin residue remains), this may be removed by methods such as plasma etching (for example, in an oxygen plasma), mechanical abrasion, etc. such that material 89 may be electrodeposited onto the previous layer (comprising materials 63 and 65) and excellent adhesion obtained, as shown in FIG. 5(aa). After complete removal of material 83 as before, material 91 is deposited in its place, as before. In FIG. 5(aa), planarization of material 89 and 91 has been performed, and a third layer, comprising materials 92 and 94 has been fabricated as before.

FIGS. 17(a)-(h) illustrate a method for achieving both small positive and negative features in the same layer when the patternable mold material (for example, photoresist or solder mask) cannot produce small features of both types equally well at least according to some embodiments of the invention. In the example illustrated, it is assumed that positive features in the mold material are more easily produced. In FIG. 17(a), patternable mold material 117 is patterned (for example, if a photoresist, by use of a photomask, developing, etc., by laser direct imaging, a pattern generator and the like or, a combination of these methods) and first material 120 (for example, copper) is deposited (for example, by electrodeposition). In FIG. 17(b), patternable mold material 117 is removed. In FIG. 17(c), patternable mold material 117 is deposited over first material 120. In FIG. 17(d), patternable mold material 117 is patterned and it is assumed that the remaining region of mold material 117 as shown in FIG. 17(d) is narrower than a negative feature that could have been formed for example in obtaining the state of the process shown in FIG. 17(a).

In FIG. 17(e), a second material 121 (for example, nickel) is deposited (for example, by electrodeposition). In FIG. 17(f), patternable mold material 117 is removed. In FIG. 17(g), first material 120 is blanket deposited over second material 121. In FIG. 17(h), the layer has been planarized to a sufficient depth to establish a layer of the desired thickness, flatness, and surface finish. It will be understood by one skilled in the art that a similar process for achieving both small positive and negative features in the same layer as that described above in reference to FIGS. 17(a)-(h) may be performed when a patternable mold material that more easily produces small features that are negative is used on a layer.

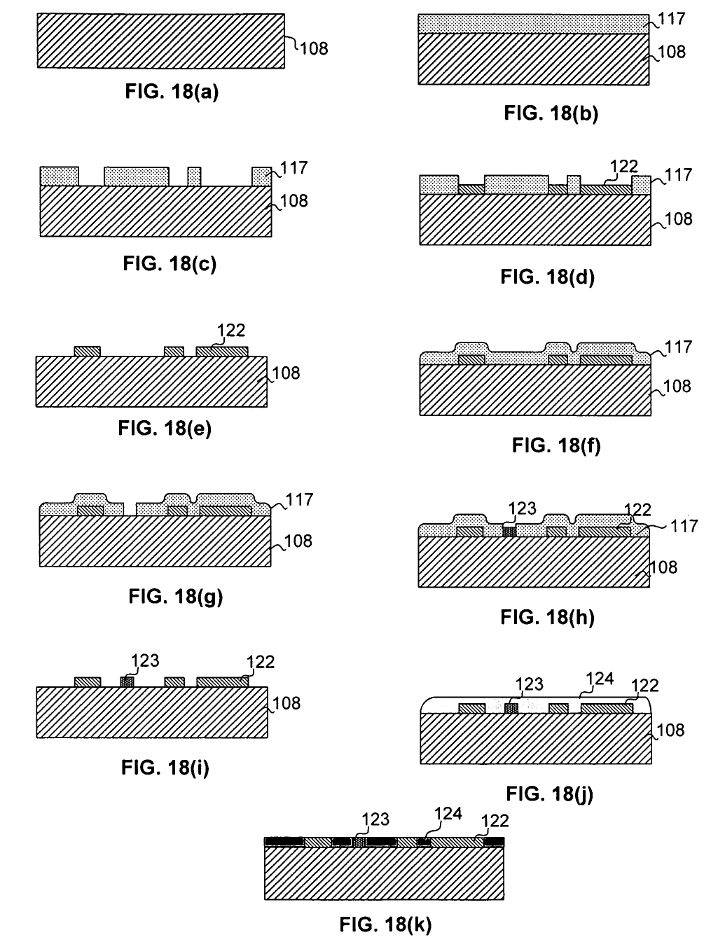

It may desirable to deposit more than two materials on a single layer. FIGS. 18(a)-(k) show a process for depositing more than two materials on a single layer, according to some embodiments of the invention. In FIG. 18(a), a substrate 108 is shown, onto which patternable mold material 117 (for example, photoresist or solder mask) has been deposited as shown in FIG. 18(b). In FIG. 18(c), material 117 has been patterned (for example, if a photoresist, by use of a photomask, developing, etc., by laser direct imaging, a pattern generator and the like or, a combination of these methods) to produce apertures. In FIG. 18(d), first material 122 (for example, a metal such as copper) has been deposited into the apertures (for example, by electrodeposition).

In FIG. 18(e), material 117 has been removed (for example, by use of a chemical stripper) to expose regions of the substrate 108 which are not covered with first material 122. In FIG. 18(f), material 117 (or an alternative patternable mold material) is deposited over first material 122 and patterned (FIG. 18(g)). In FIG. 18(h), second material 123 (for example, a metal such as nickel) has been deposited. In FIG. 18(i), material 117 is removed. In FIG. 18(j), a third material 124 (for example, silver) has been blanket deposited over materials 122 and 123. In FIG. 18(k), the layer has been planarized to a sufficient depth to remove all of second material 124 overlying first material 122 and second material 123, and also to establish a layer of the desired thickness, flatness, and surface finish.

Various alternatives to the embodiment of FIGS. 18(a)-18(k) are possible. For example, in some alternative embodiments, it may possible to planarize materials 122 and 117 of FIG. 18(d) to a desired height (e.g. equal to or greater than the layer thickness or bounding height of the layer) prior to removal of material 117 as shown in FIG. 18(e). In addition, or alternatively, it may be possible to planarize material 117 deposited in FIG. 18(f) prior to patterning it to obtain the void in material 117 as shown in FIG. 18(g). The planarization may or may not cause material 122 to become exposed but it is anticipated that the planar surface of material 122 may allow more accurate patterning of material 117 in obtaining the result of FIG. 18(g) particularly if the void or voids to be formed in material 117 are near or adjacent to the deposits of material 122. Such planarization may allow the materials to be pattern deposited adjacent to or in proximity to one another. It is believed that these alternatives will work satisfactorily when the patternable material, for example is a photoresist of the dry film or liquid type, so long as it is adequately located within corners between material 122 and the substrate or previously formed layer of material. In still other alternative embodiments, it may be possible to further pattern the first deposited patternable masking material instead of removing it which was shown FIG. 18(e) such that depositing a second patternable material as shown in FIG. 18(f) becomes unnecessary.

Additional embodiments where three or more materials per layer will be deposited are possible. Some of these additional embodiments are focused on alternative techniques for allowing patterned deposition of two or more materials adjacent to one another. Detailed examples of such alternative embodiments are set forth herein next as the first through third exemplary embodiments.

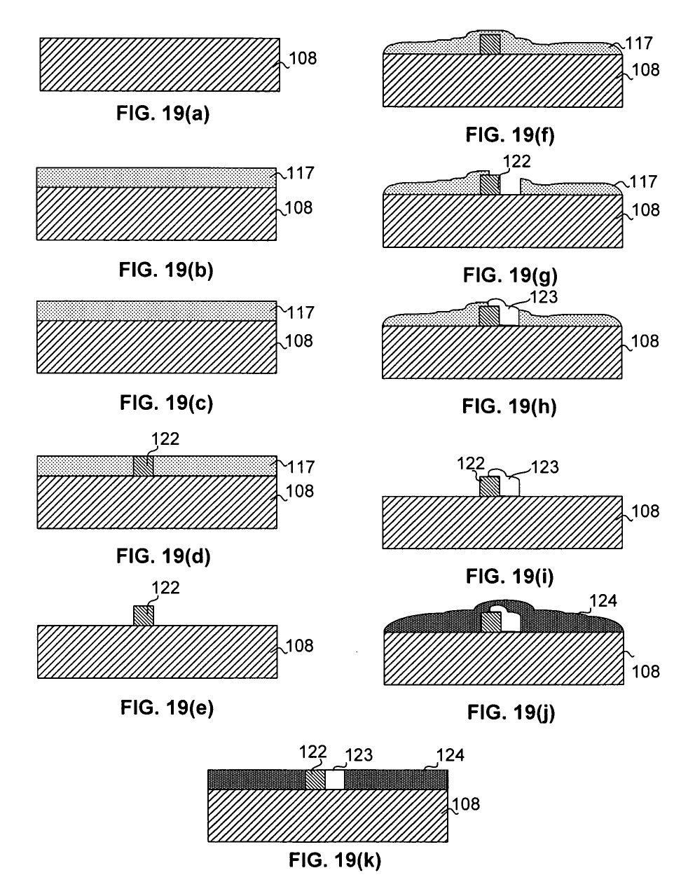

Referring to FIGS. 19(a)-(k), a first exemplary embodiment is shown for depositing more than two materials on the same layer wherein two or more different materials (for example, metals) need to be pattern deposited adjacent to each other. In FIG. 19(a), a substrate 108 is shown, onto which patternable mold material 117 (for example, photoresist or solder mask) has been deposited as shown in FIG. 19(b). In FIG. 19(c), material 117 has been patterned (for example, if a photoresist, by use of a photomask, developing, etc., by laser direct imaging, a pattern generator and the like or, a combination of these methods) to produce an aperture. In FIG. 19(d), first material 122 (for example, a metal such as copper) has been deposited into the aperture (for example, by electrodeposition).

In FIG. 19(e), material 117 has been removed exposing portions of the substrate 108 not covered by first material 122. In FIG. 19(f), another layer of material 117 is deposited over substrate 108 and first material 122. In FIG. 19(g), material 117 (or an alternative patternable mold material) is patterned to produce an aperture adjacent to first material 122, as well as to expose a top portion of first material 122. In FIG. 19(g), it is shown that an edge of the material 117 that is formed over first material 122 is not aligned with an edge of first material 122, i.e., a portion of the top surface of first material 122 is exposed. In FIG. 19(h), second material 123 (for example, nickel) is deposited into the aperture and over the exposed portion of first material 122. In FIG. 19(i), material 117 is removed. In FIG. 19(j), third material 124 (for example, silver) is blanket deposited over substrate 108, first material 122 and second material 123. In FIG. 19(k), the layer has been planarized to a sufficient depth to establish a layer of the desired thickness, flatness, and surface finish. It can be seen in FIG. 19(k) that the portion of second material 123 that was deposited over first material 122 has been removed. Thus, it was not necessary that the edge of the material 117 that is formed over first material 122 be aligned with an edge of first material 122. Therefore, some embodiments of the invention purposely do not align the edge, as shown in FIG. 19(g). This may be beneficial in that precise mask alignment is not necessary.

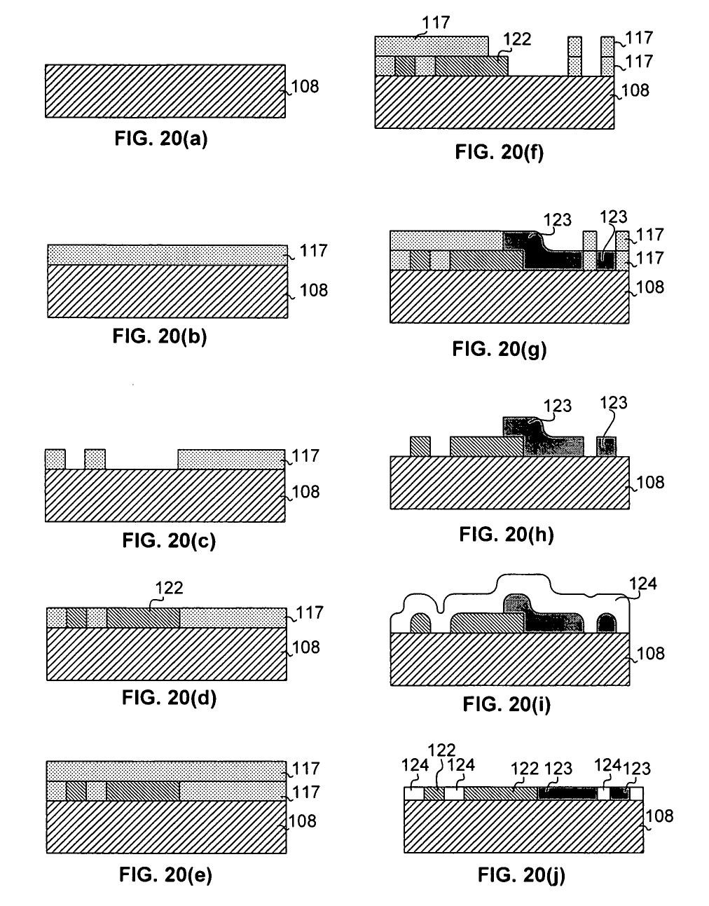

Referring to FIGS. 20(a)-(j), a second exemplary embodiment is shown for depositing more than two materials on the same layer wherein two or more different materials (for example, metals) are adjacent to each other. In FIG. 20(a), a substrate 108 is shown, onto which patternable mold material 117 (for example, photoresist or solder mask) has been deposited as shown in FIG. 20(b). In FIG. 20(c), material 117 has been patterned (for example, if a photoresist, by use of a photomask, developing, etc., by laser direct imaging, a pattern generator and the like or, a combination of these methods) to produce apertures. In FIG. 20(d), first material 122 (for example, a metal such as copper) has been deposited into the apertures (for example, by electrodeposition) to a thickness substantially similar to that of material 117. In FIG. 20(e), a second layer of material 117 (or an alternative patternable mold material) is deposited without stripping the first layer of material 117 so that the first layer provides support for the second layer. It is assumed in the present embodiment that material 117 is a patternable mold material that may be patterned more than once.

In FIG. 20(f), the two layers of material 117 have been patterned to form apertures (including an aperture adjacent to first material 122) and to expose a top portion of first material 122. In FIG. 20(g), a second material (for example, nickel) is deposited over the exposed areas of substrate 108 and first material 122. In FIG. 20(h), material 117 is removed. In FIG. 20(i), a third material 124 (for example, silver) is blanket deposited over substrate 108, first material 122 and second material 123. In FIG. 20(j), the layer has been planarized to a sufficient depth to establish a layer of the desired thickness, flatness, and surface finish.

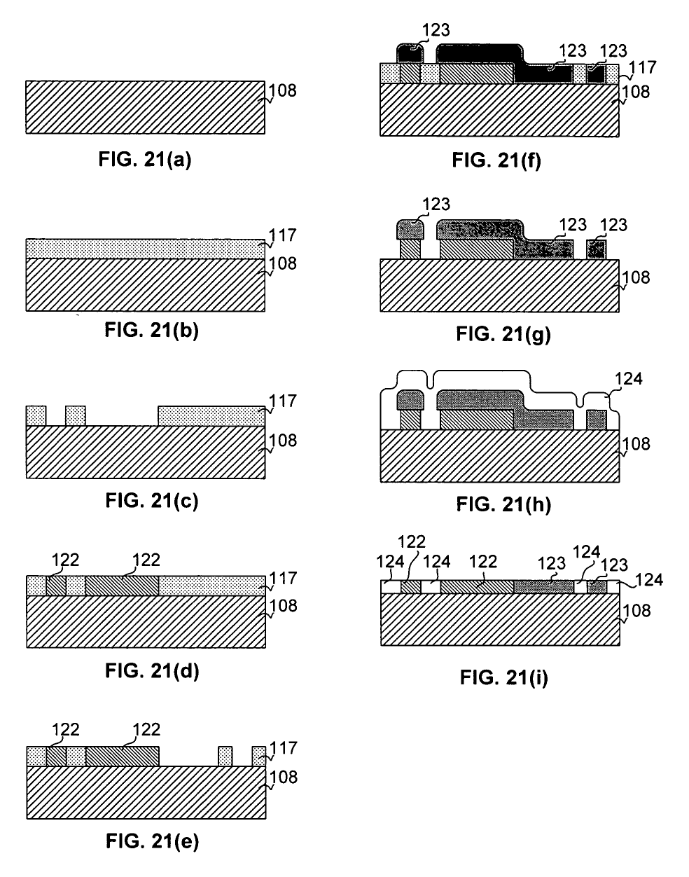

Referring to FIGS. 21(a)-(i), a third exemplary embodiment is shown for depositing more than two materials on the same layer wherein two or more different materials (for example, metals) are adjacent to each other. In FIG. 21(a), a substrate 108 is shown, onto which patternable mold material 117 (for example, photoresist or solder mask) has been deposited as shown in FIG. 21(b). In FIG. 21(c), material 117 has been patterned (for example, if a photoresist, by use of a photomask, developing, etc., by laser direct imaging, a pattern generator and the like or, a combination of these methods) to produce apertures. In FIG. 21(d), first material 122 (for example, a metal such as copper) has been deposited into the apertures (for example, by electrode position).

In FIG. 21(e), material 117 is patterned again to produce additional apertures. It is assumed in the present embodiment that material 117 is a patternable mold material that may be patterned more than once. In FIG. 21(f), second material 123 (for example, a metal such as nickel) is deposited into the additional apertures (for example, by electrodeposition). In FIG. 21(g), material 117 is removed. In FIG. 21(h), a third material 124 (for example, silver) is blanket deposited over substrate 108 and second material 123. In FIG. 21(i), the layer has been planarized to a sufficient depth to establish a layer of the desired thickness, flatness, and surface finish.

Thus, unlike in the second embodiment discussed above, according to the third embodiment, a second layer of patternable mold material 117 is not used. Instead, the first layer of material 117 is patterned twice in order to deposit two or more different materials that are adjacent to each other on the same layer. As a result, the second-deposited material deposits over the first-deposited material, making the entire thickness of deposit greater and more planarization necessary to achieve the final layer thickness. In comparison, the second embodiment discussed above, where the second layer of mold material covers up much of the second-deposited material, reduces this overall thickness.

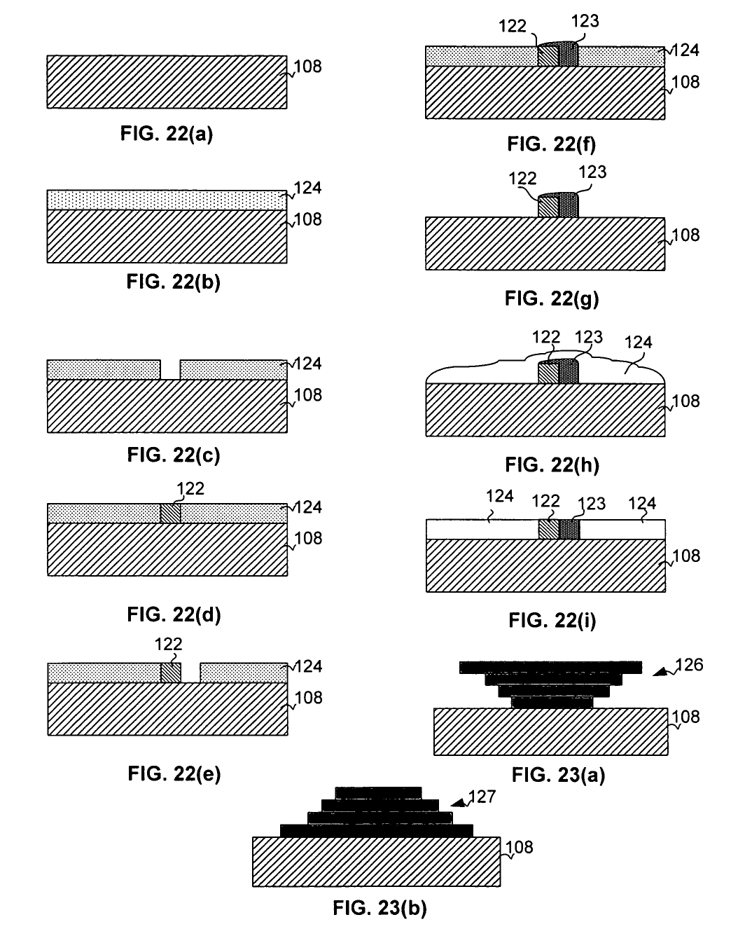

Referring to FIGS. 22(a)-(i), a fourth exemplary embodiment is shown for including two or more different materials (for example, metals) that may be adjacent to each other on the same layer. In FIG. 22(a), a substrate 108 is shown, onto which an ablatable material 125 is deposited, as shown in FIG. 22(b). Ablatable material 125 may be any suitable material that is ablatable by, for example, ultraviolet lasers. Examples of suitable ablatable materials include, but are not limited to, polyimide, polyurethane, and the like. In FIG. 22(c), material 125 is ablated to produce an aperture. In FIG. 22(d), first material 122 (for example, a metal such as copper) has been deposited into the apertures (for example, by electrodeposition).

In FIG. 22(e), material 125 is again ablated to produce an additional aperture adjacent to first material 122. Ablation of material 125 adjacent to material 122 may slightly reduce the thickness of material 122 if the radiation used for ablation overlaps material 122; however, by making material 122 thicker than the desired ultimate layer thickness, this can be tolerated. Moreover, by selecting the wavelength and/or intensity of such radiation, selective ablation of material 125 with little effect on material 122 may be achieved. In FIG. 22(f), second material 123 (for example, nickel) has been deposited (for example, by electrodeposition) into the additional aperture and over the exposed portion of first material 122. Assuming a total of three materials on this layer, material 125 can now be completely removed (for example, by ablation) as shown in FIG. 22(g) and—as shown in FIG. 22(h), a third material 124 (for example, silver) can be blanket deposited over substrate 108, first material 122 and second material 123. In FIG. 22(i), the layer has been planarized to a sufficient depth to establish a layer of the desired thickness, flatness, and surface finish.

According to some embodiments of the invention, multiple layers may be patterned using a single plating step to build an expanding geometrical structure 126 on a substrate 108 such as that shown in FIG. 23(a), or a contracting geometrical structure 127 on a substrate 108 such as that shown in FIG. 23(b).

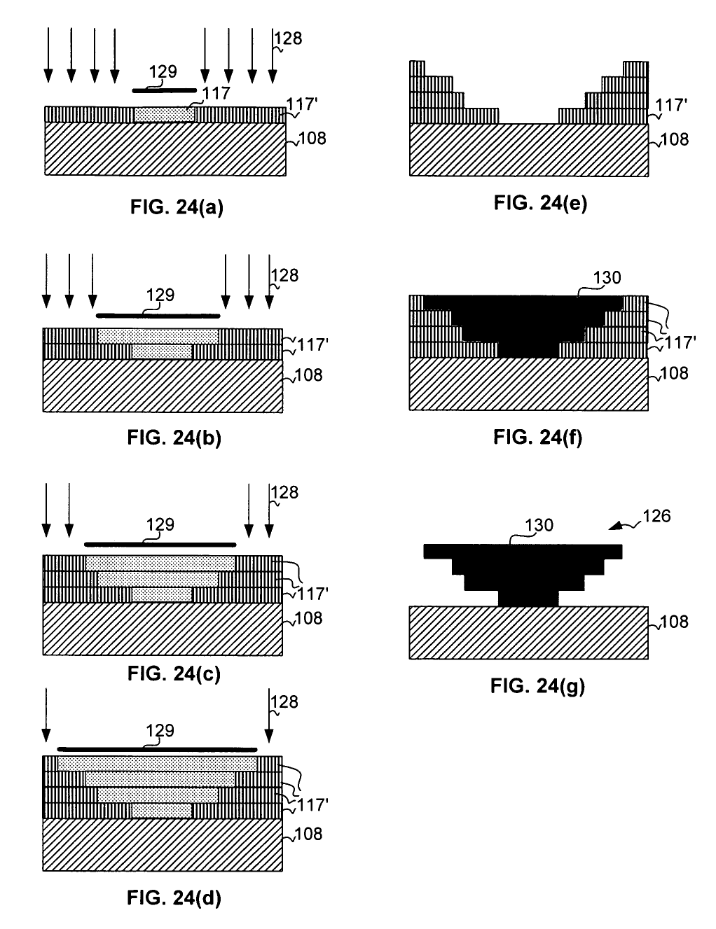

FIGS. 24(a)-(f) illustrate an embodiment of a process for forming the expanding geometrical structure 126 shown in FIG. 23(a). In FIG. 24(a), a substrate 108 is shown, onto which patternable mold material 117 (for example, photoresist or solder mask) has been deposited. Material 117 is being exposed to light 128 (for example, ultraviolet) that is preferably highly-collimated and which passes through photomask 129 in clear regions of the mask to produce exposed areas of patternable mold material 117′.

When an expanding geometry like that shown in FIG. 23(a) is formed, some preferred embodiments of the invention use a negative patternable mold material, i.e. one that becomes insoluble to the developer in those regions exposed to light. By using a negative patternable mold material, precise exposure control is not required (i.e., precise control of depth of penetration of light 128, exposure time, and the like). This is because exposure of the current layer does not expose previously unexposed areas of the layers below it due to the dark area of mask 129. Other embodiments may use a positive resist and exercise precise exposure control.

Succeeding layers of the structure 126 are exposed in a similar manner, as shown in FIGS. 24(b)-(d). In FIG. 24(e), the unexposed portion of the material 117 is removed. In FIG. 24(f), a single plating step is performed which fills the pattern left by the removal of material 117′ with a material 130 (for example, a metal). The patternable mold material acts as a mold for forming structure 126. In FIG. 24(g), the exposed portions 117′ are removed, leaving structure 126.

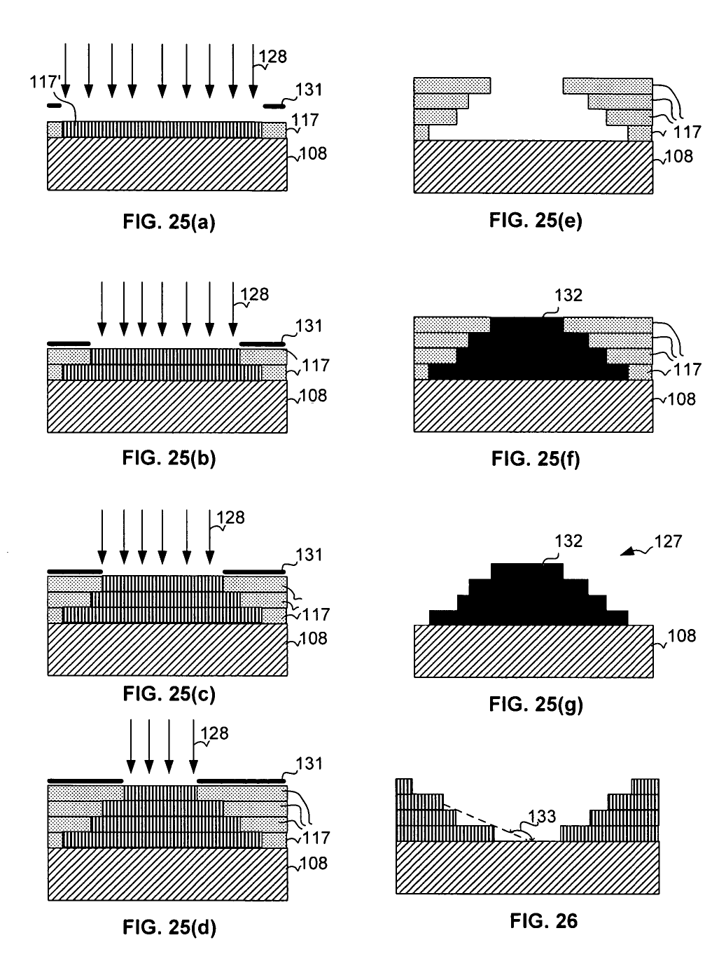

FIGS. 25(a)-(g) illustrate an embodiment of a process for forming the contracting geometrical structure 127 shown in FIG. 23(b). In FIG. 25(a), a substrate 108 is shown, onto which patternable mold material 117 (for example, photoresist or solder mask) has been deposited. Material 117 is being exposed to light 128 (for example, ultraviolet) that is preferably highly-collimated and which passes through photomask 131 in clear regions of the mask to produce exposed areas of patternable mold material 117′.

When an contracting geometry like that shown in FIG. 23(b) is formed, some preferred embodiments of the invention use a positive patternable mold material, i.e. one that becomes soluble to the developer in those regions exposed to light. By using a positive patternable mold material, precise exposure control is not required (i.e., precise control of depth of penetration of light 128, exposure time, and the like). This is because exposure of the uppermost layer does not expose previously unexposed areas of the layers below the uppermost layer due to the dark area of mask 131. Other embodiments may use a negative resist and exercise precise exposure control.

Succeeding layers of the structure 127 are exposed in a similar manner, as shown in FIGS. 25(b)-(d). In FIG. 25(e), the exposed portion of the material 117 is removed. In FIG. 25(f), a single plating step is performed which fills the pattern left by the removal of material 117′ with a material 132 (for example, a metal). The patternable mold material acts as a mold for forming structure 127. In FIG. 24(g), the exposed portions 117′ are removed, leaving structure 127.

According to other embodiments of the invention, both the expanding geometric structure and the contracting geometric structure processes described above may develop the patternable mold material after each exposure. In this case, preferred embodiments may use a dry film resist as the patternable mold material. The dry film resist is used such that the resist will “tent” over apertures formed in the layers.

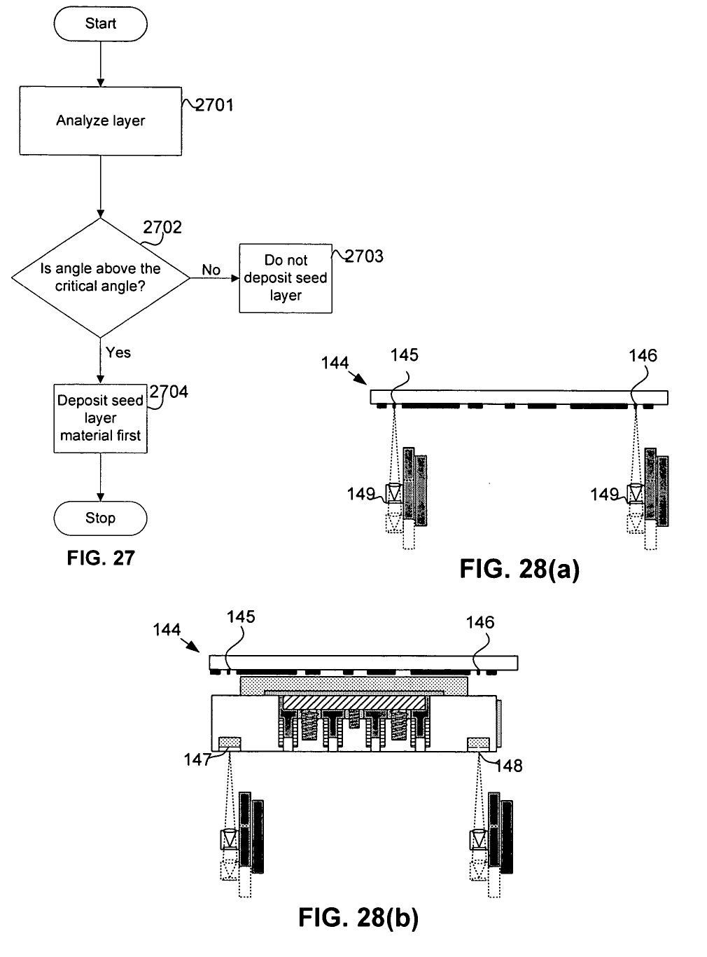

According to some embodiments of the invention, when multiple layers are patterned using a single plating step, a seed layer may first be deposited before the plating step if an angle (such as the exemplary angle 133 shown in FIG. 26) is above a critical angle 133. As shown in the flowchart of FIG. 27, some embodiments of the invention may analyze features on a layer (S2701) to determine whether any angle of a feature is above a critical angle (S2701). If an angle of a feature is not above the critical angle, no seed layer will need to be deposited (S2703). However, if the angle is above the critical angle, a seed layer will need to be deposited (S2704) to ensure that material can be plated over the mold material (by ‘mushrooming’ in some cases). The angle analysis may be performed, for example, by a suitable processing device running a suitable software program, or may be performed by hardware, firmware or a combination thereof.

Referring now to FIG. 5(bb), carrier 1 and all that is attached to it has been placed on a fixture such that pins 93 enter into holes 15. In addition, material 59 has been removed (for example, by dissolution). In FIG. 5(cc), material 23 has been melted (preferably by activation of elements 17) such as to release substrate 25. Alternatively, material 23 may also be removed chemically. In FIG. 5(dd), carrier 1 has been pushed down further onto pins 93 such that substrate 25 is entirely free of carrier 1 and material 31 has either delaminated from carrier 1 or has become torn as shown. The spaces left by the removal of material 59 enables easier delamination of the carrier 1 because there is no buildup of the layer materials in the space occupied by material 59.

In FIG. 5(ee), substrate 25 has been removed from the carrier 1 and placed on support 93 (for example, dicing tape). In FIG. 5(ff), kerfs 95 have been cut through all deposited materials as well as through substrate 25 to singulate individual portions of substrate 25 into individual die. According to other embodiments, the kerfs may be cut prior to removal of substrate 25 from carrier 1. Such kerfs may be cut, for example, by resin or metal-bonded diamond dicing saw blades, by toothed dicing saw blades, or by using a laser or high-pressure fluid jet. Scrap die 99, including regions of structural materials such as 79, no longer connect to die 97 and may now be separated from die 97.

In FIG. 5(gg), materials 63, 89, and 92 have been removed (for example, by chemical dissolution selective to materials 65, 91, and 94. In FIG. 5(hh), material 31 has been removed using a timed etching step such that it is removed from most of substrate 25 but remains substantially under features of material 65, though with some undercutting 100 of said features. Finally, in FIG. 5(ii), support 93 has been removed from die 97, and die 97 have been separated from one another. If desired, these removal processes may be performed prior to dicing substrate as described above.

In previously described embodiments, the alignment targets may be attached to a carrier to which the EFAB substrate is affixed. Other embodiments of the invention provide methods of providing alignment targets in the substrate itself, in case a carrier is not used, or the carrier is not sufficiently large relative to the substrate, or it is not desired to incorporate the targets in the carrier for other reasons. According to some embodiments of the invention, the targets can be located in a variety of locations on the substrate. For example, the targets may be located in unused die sites, near the edge of the wafer outside the functional die, in the dicing lanes, and the like.

As in the previous embodiments, the embodiments described below align all newly-added layers again and again to the same alignment targets rather than align each new layer to an alignment target formed in the previous layer. However, according to these embodiments, the alignment targets are located on the substrate rather than on the carrier, as in the previously described embodiments. Aligning to targets on the substrate or carrier instead of to targets in the previous layer avoids the accumulation of errors, including the error produced by alignment targets on each new layer not being identical in shape or size to that of others on previous layers.

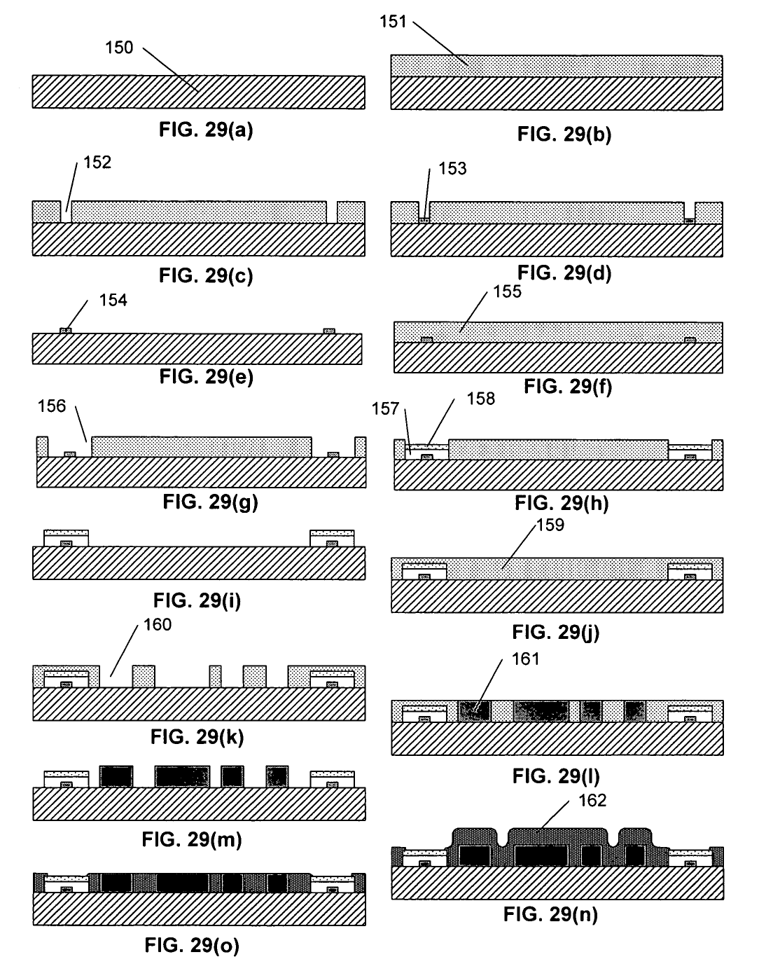

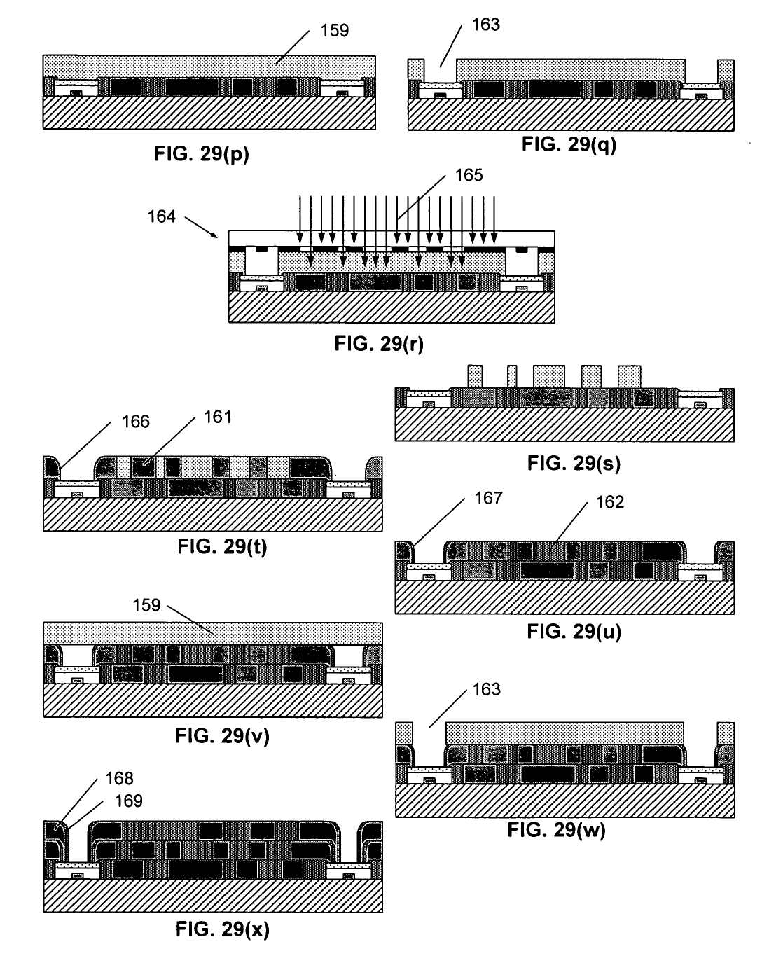

According to some embodiments of the invention, as shown in FIGS. 29(a)-(x), the targets may be formed by electrodepositing or otherwise depositing material onto the substrate (for example, by sputtering). The targets may also be formed using lift-off approaches, etching and the like. The targets are then covered with a dielectric material so as to avoid plating over them (which would obscure the targets as layers are added). FIG. 29(a) shows a substrate 150 which has been coated with a patternable mold material 151 (for example, a photoresist) in FIG. 29(b). In FIG. 29(c), material 151 has been patterned to form apertures such as 152 into which material 153 is then deposited (for example, by sputtering, vacuum deposition, electrophoretic deposition, and the like) as shown in FIG. 29(d) to form targets 154 as shown in FIG. 29(e).

In FIG. 29(e), material 151 has been removed. In FIG. 29(f), a resist or other patternable material 155 has been applied and in FIG. 29(g) material 155 has been patterned to form an aperture 156 wider than and fully including target 154. Aperture 156 is made large enough such that ‘mushrooming’ of deposited materials which might occur while forming subsequent layers of the electrochemically-fabricated device cannot optically obscure targets 154. In FIG. 29(h), dielectric material 157 has been deposited into aperture 156 and non-adherent material 158 (for example, Teflon®, SYTOP® or parylene) has preferably been deposited on top of dielectric material 157 (if material 157 is itself non-adherent material 158 may be omitted).

According to some embodiments of the invention, the total thickness of materials 157 and 158 may be made small enough that neither may come into contact with the lapping or polishing plate during planarization of the first layer and therefore will not be damaged or altered; this is the approach assumed in FIG. 29. Alternatively, material 158 (or material 157 if material 158 is not used) may be deposited to a thickness that ensures that it will be lapped and/or polished (for example, along with the first layer of the electrochemically-fabricated device). The planarization operation then would be performed so as to provide an optically smooth and transparent surface.

If materials 154, 157, and 158 are not electrodeposited, portions of these materials would also be deposited onto materials 151 and 155, respectively, but these would be removed upon removal of materials 151 and 155 (for example, during a lift-off process). Also note that materials 154, 157, and 158 might also be deposited in a blanket fashion and then patterned using etching (for example, using a photoresist).

In FIG. 29(i), material 155 has been removed and fully-encapsulated, non-conductive, non-adherent alignment target 154 remains behind. The EFAB process can now begin. The remaining FIGS. 29(j)-(r) assume an EFAB process based on photoresist or other adherent patternable material (hereinafter assumed to be resist). However, embodiments they are equally applicable to an EFAB process using an INSTANT MASK™.

In FIG. 29(j), resist 159 has been applied. In FIG. 29(k), resist 159 has been patterned to produce apertures 160. In FIG. 29(l), material 161 has been electrodeposited into apertures 160, and in FIG. 29(m) resist 159 has been stripped. In FIG. 29(n) material 162 has been electrodeposited onto the substrate, filling the apertures left behind by the removal of resist 159, and not depositing over material 158 due to its insulating nature. However, due to the ability of electrodeposits to ‘mushroom’ over the edges of insulators, material 162 slightly overlaps the edges of material 158 as shown. In FIG. 29(o), the layer of materials 161 and 162 has been planarized (in the case shown, the planarization plane is above the surfaces of materials 157 and 158), completing the first EFAB layer.

In FIG. 29(p), resist 159 has been applied to the first layer and in FIG. 29(q) regions of resist 159 have been removed mechanically (especially for dry film resist) or by chemical stripping (for any type of resist) to form windows 163. According to some embodiments of the invention, if electrodeposited resist is used, targets 154 (since they are coated with at least one insulating material) will not accumulate resist and thus no removal of resist covering targets 154 is required. In some embodiments, mechanical removal might involve use of a punch or cutting blade, possibly combined with a vacuum or mechanical tweezers to extract loosened pieces, especially of dry film resist. The non-adherent nature of material 158 helps in this removal process, especially for dry film resist. According to some embodiments, resist 159 may be applied so as not to fill in windows 163. According to other embodiments, resist 159 may be left filling windows 163, if it is sufficiently transparent and non-distorting to not have a detrimental effect on targets 154.

Referring to FIG. 29(r), photomask 164 has been aligned to targets 154 visible through windows 163 and resist 159 is exposed to UV light 165. In FIG. 29(s), resist 159 is developed to yield apertures which are then electrodeposited with material 161 in FIG. 29(t). At this time, material 161 is also deposited slightly over material 158 to form a mushroomed region 166, slightly reducing the size of windows 163. In FIG. 29(u), material 162 has been deposited and materials 161 and 162 have been planarized to yield the second EFAB layer. Material 162 has been deposited over region 166, further reducing the size of windows 163 and forming a mushroomed region 167. It should be noted the none of the FIGS. are to scale and that normally electrodeposited material mushrooms much more isotropically than is shown in the FIGS.

In FIG. 29(v), resist 159 has been applied to the second layer and in FIG. 29(w) regions of resist 159 have again been removed so as not to cover windows 163. Finally, in FIG. 29(x), materials 161 and 162 have been deposited as with previous layers, again using windows 163 to allow alignment between photomask targets and targets 154. Also, materials 161 and 162 have been planarized to yield the third EFAB layer. Materials 161 and 162 have formed mushroomed regions 168 and 169, respectively, further reducing the size of windows 163. Additional layers can be built in a similar fashion, preferably continuing to use targets 154 for alignment so long as they are not obscured by mushroomed regions of deposited materials.

In a variation of the embodiment shown in FIGS. 29(a)-(x), material 153 may be the same as material 161 or 162 and the two deposited together (however, material 161 or 162 in the region of targets 154 needs to be deposited to a lower height so that it is below the planarization plane for the first layer. In another variation of this embodiment, materials 157 and 158 may be solid materials (for example, Teflon®-coated glass) that are placed over targets 154 and secured (for example, by gluing or by the mushrooming effect of subsequent plating). According to some embodiments of the invention, such solid material may intentionally be planarized to establish a smooth optical surface reasonably parallel to substrate 150 if desired. In another variation of this embodiment, targets 154 may be formed by etching features into substrate 150 in lieu of by depositing material 153.

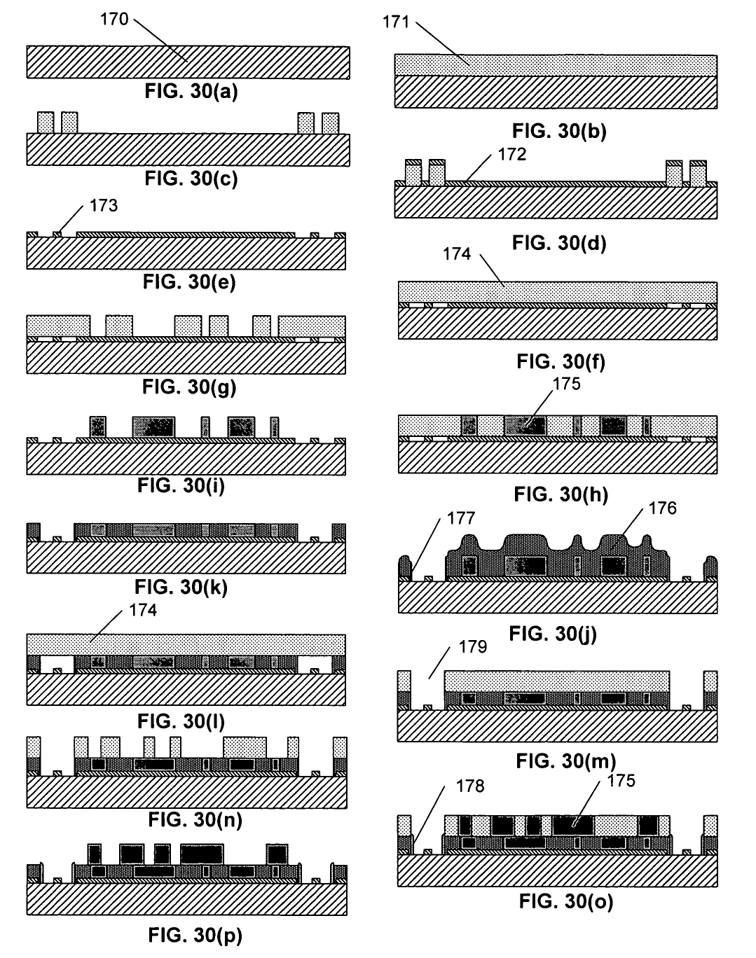

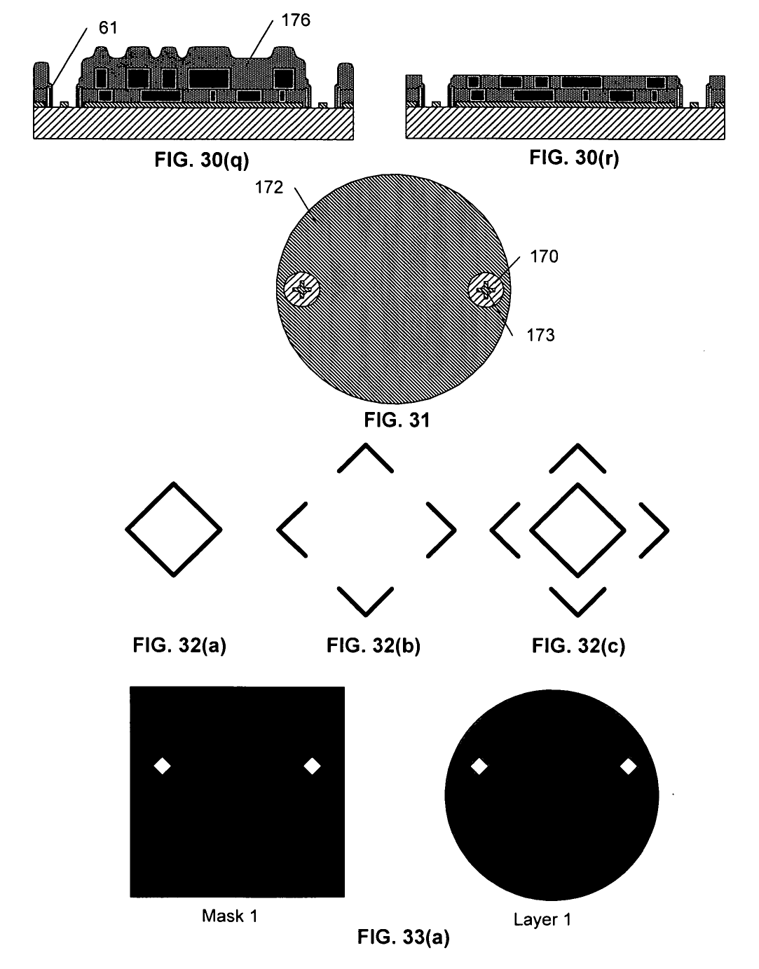

FIGS. 30(a)-(r) illustrate another embodiment of the invention, which can be used with dielectric substrates or else with metal substrates on which the area of the alignment target is insulating or is covered with an insulating material. In this embodiment, the alignment targets are formed, for example, in the adhesion and/or seed layers (for example, Ti and Au, respectively) that coat the dielectric substrate, and the targets are electrically isolated from the surrounding metal layers by an insulating gap so that they are not able to be plated onto.

FIGS. 30(a)-(r) assume the alignment targets are patterned using a lift-off approach, but other approaches may be used in other embodiments. Etching of blanket-deposited adhesion and/or seed layers using a photoresist or similar material is one such approach. Another approach is to plate the targets on top of the adhesion and/or seed layers and then etch these layers back using a time-controlled etch such that the material of the plated targets avoids excessive undercutting of the adhesion and/or seed layers.

Dielectric substrate 170 shown in FIG. 30(a) is covered with resist 171 (FIG. 30(b)) which is patterned (FIG. 30(c)), preferably with sidewalls having a negative slope (undercut), as is the norm in lift-off patterning. In FIG. 30(d) metal(s) have been deposited to form an adhesion/seed layer 172. In FIG. 30(e) resist 171 has been removed, leaving patterned layer 172. The patterning operation both patterns alignment targets 173 and disconnects them electrically from the remainder of the layer 172.

FIG. 31 shows a top view of substrate 170, layer 172, and targets 173. The bare area of substrate 170 surrounding targets 173 is made large enough such that ‘mushrooming’ of deposited materials while forming subsequent EFAB layers cannot optically obscure targets 173. Even if dry film resist is used in subsequent processing, this is likely to become laminated to the alignment target in making the first few layers, since the distance to the target is small. Therefore, in some embodiments, targets 173 may be coated with a non-adherent material (not shown) similar to that described above so that resist applied over them can be easily removed.

Referring to FIG. 30(f) resist 174 has been applied to pattern the first EFAB layer. In FIG. 30(g) resist 174 has been patterned to produce apertures and in FIG. 30(h) material 175 has been electrodeposited into these apertures. In FIG. 30(i), resist 174 has been stripped and in FIG. 30(j) material 176 has been blanket-deposited. A mushroomed region 177 has been produced alongside the patterned edge of layer 172.

In FIG. 30(k), materials 175 and 176 have been planarized to yield the first EFAB layer. In FIG. 30(l), resist 174 (dry film resist is assumed in the figure, ‘tenting’ over targets 173) has been applied to the first layer. In FIG. 30(m), the portion of resist 174 over targets 173 has been removed mechanically (especially for dry film resist) or by chemical stripping (for any type of resist) to form windows 179. In embodiments wherein electrodeposited resist is used, targets 173 (since they are electrically isolated) will not accumulate resist and thus no removal of resist covering targets 173 is required. In some embodiments, mechanical removal might involve use of a punch or cutting blade, possibly combined with a vacuum or mechanical tweezers. According to some embodiments of the invention, resist 174 may be applied so as not to fill in windows 179. In some embodiments, resist 174 may also be left filling windows 179, if it is sufficiently transparent and non-distorting to not have a detrimental effect on targets 173.

In FIG. 30(n), resist 174 is patterned by using targets 173 for alignment. In FIG. 30(o), material 175 has been deposited. A mushroomed region 178 has been produced alongside the edge of the first layer, surrounding targets 173.

In FIG. 30(p), resist 174 has been stripped and in FIG. 30(q) material 176 has been blanket deposited. A mushroomed region 180 has been produced over mushroomed region 178. In FIG. 30(r) materials 175 and 176 have been planarized. Additional layers can be built in a similar fashion, preferably continuing to use targets 173 for alignment.

The methods of the above embodiments can also be used to incorporate a human and/or machine-readable identification code (e.g., a bar code or the like) into the surface of the substrate as a method of identifying the substrate, particularly one that is not attached to a carrier bearing an identifying tag. This can be done in the same manner as, and along with, alignment targets that are incorporated as described above, such that deposition of material is substantially prevented from occurring above the identification code and obscuring it from view.

In a variation of the embodiments shown in FIGS. 29 and 30, the targets may be covered by a solid material (for example, a light tack tape such as dicing tape) or ‘plug’ to protect the targets from contact with the resist and allowing the resist to easily be removed from the targets without leaving any residue behind.

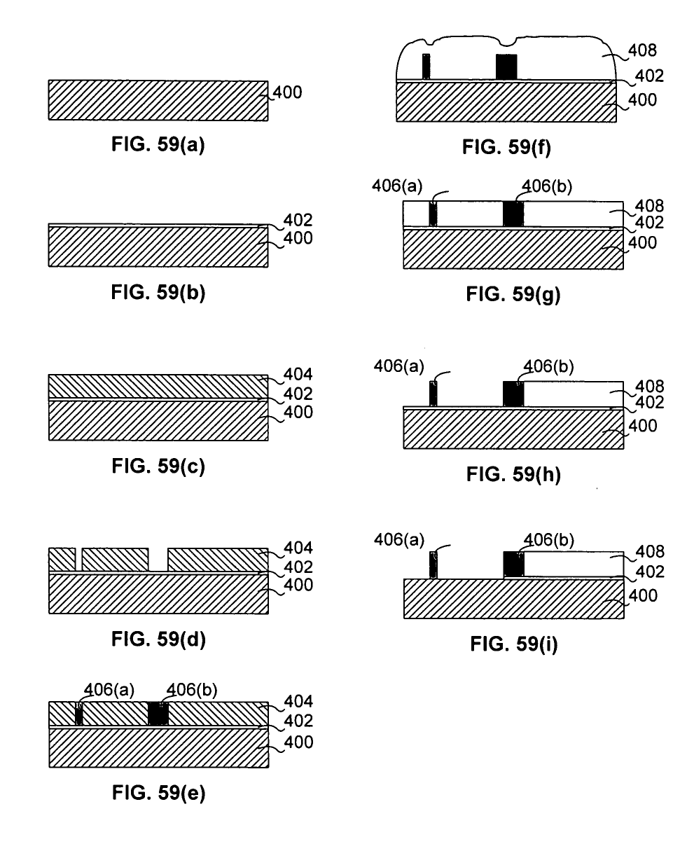

FIGS. 59(a)-(i) show a further embodiment of the invention for forming a target on a substrate. As shown in FIG. 59(a), a substrate 400 is shown, onto which a adhesion/seed layer 402 has been deposited as shown in FIG. 59(b). In FIG. 59(c), patternable mold material 404 (for example, a photoresist) has been deposited. In FIG. 59(d), patternable mold material 404 has been patterned to form apertures. In FIG. 59(e), portions 406(a) and 406(b) comprised of a first material 406 (for example, nickel) have been formed in the apertures. Portion 406(a) will be a target, while 406(b) will be a device or structure.

In FIG. 59(f), a second material has been blanket deposited over adhesion/seed layer 402 and 406(a) and 406(b). In FIG. 59(g), planarization has been performed. In FIG. 59(h), second material 408 surrounding portion 406(a) has been removed, for example by local etching, leaving only the adhesion/seed layer 402 around portion 406(a). In FIG. 59(i), the adhesion/seed layer 402 around portion 406(a) has been removed, for example, by local etching.

Thus, the embodiment for forming a target on a substrate described above first forms a layer of materials on an adhesion/seed layer. Then, at least one of the materials and the adhesion/seed layer is removed to electrically isolate the target by forming an island of non-conductive material around the target. In this manner, the target will not be plated onto during a subsequent plating process. According to some embodiments of the invention, an additional etching and/or polishing step may be performed on the nickel to remove any smearing or scratching that may have resulted from the planarization step.

In previously described embodiments, the alignment targets may be attached to a carrier to which the EFAB substrate is affixed or to an EFAB substrate. Yet other embodiments of the invention provide methods of providing alignment targets in the previous layer for alignment of a photomask to the previous layer. After a layer consisting of structural and sacrificial materials is formed, there may be difficulty in forming high-quality targets because of, for example, smearing of one material into another, poor contrast between various materials (e.g., structural and sacrificial) in the layer, and/or surface roughness. These problems may result from planarization and may be more acute if two or more materials on the layer are close in color. When these problems exist, it may be difficult for a machine vision system (or operator) to identify and accurate locate the targets.

Thus, according to some embodiments of the invention, etching of the area of the targets may be performed to enhance the contrast. Other embodiments may also or in the alternative, polish the area of the targets to remove scratches and smear due to the planarization step. In some cases, the effects of planarization on different targets may be dependent, for example, on a particular target's location on the layer. For example, one target located in a particular area of the layer may be more detrimentally affected by planarization than another target in a different location of the layer. Thus, according to some embodiments of the invention, multiple alignment targets may be located on the layer in order that, for example, the more detrimentally affected targets may be rejected or an average position calculated from among multiple targets.

As stated above, some embodiments of the invention may align a mask to a previous layer based on targets located in the previous layer. An exemplary shape of a target that may be located on a previous layer is shown in FIG. 32(a). An exemplary shape that may be used on a mask to align to the target is shown in FIG. 32(b). FIG. 32(c) shows the shapes of FIGS. 32(a) and 32(b) as they would appear with proper alignment of the mask to the previous layer.

Some embodiments of the invention provide masks that include both shapes that are used to align the photomask to a target on a previous layer (“alignment shapes”) and shapes that are used to form new targets on the layer currently being patterned (“new target shapes”) in preparation for alignment of the subsequent layer.

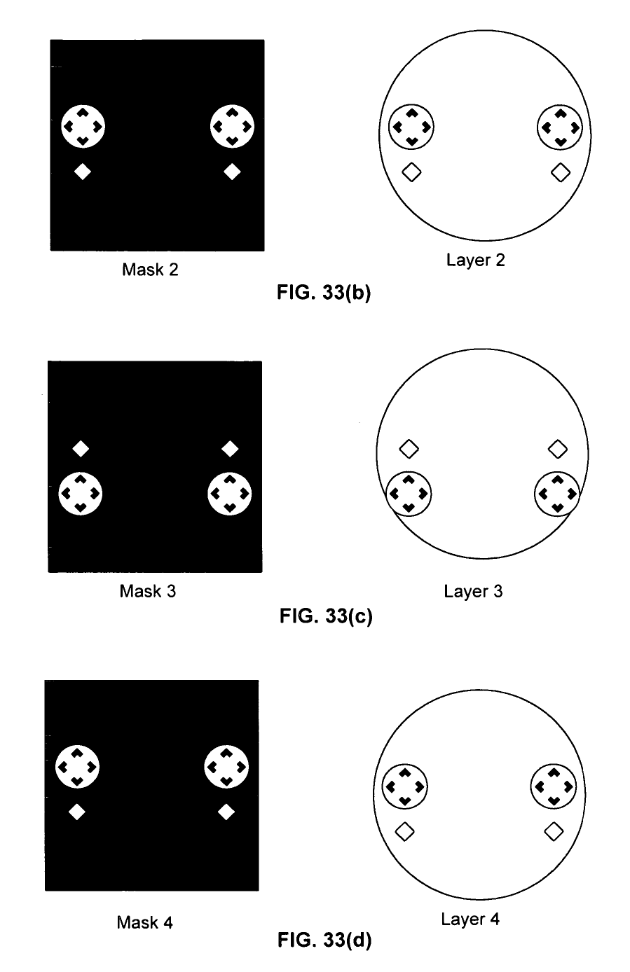

Referring to FIGS. 33(a)-(d), some embodiments of the invention provide odd and even layer masks that have alternating patterns of alignment shapes and new target shapes. FIG. 33(a) shows a first mask (Mask 1) having shapes that are used to form new targets on a first layer (layer 1). Also shown in FIG. 33(a) is a first layer (Layer 1) showing a completed two-material layer after patterning of the first material using Mask 1.

FIG. 33(b) shows a second mask (Mask 2) having both alignment shapes used to align the photomask to the targets previously patterned on the first layer and new target shapes for forming new targets on a second layer (Layer 2). Layer 2 also shows the layer produced using Mask 2. It can be seen that when the alignment shapes on the second mask are properly aligned with the targets to be patterned on the first layer, new targets may also be formed on the second layer using the new target shapes on the second mask.

FIG. 33(c) shows a third mask (Mask 3) having both alignment shapes used to align the photomask to the targets previously patterned on the second layer and new target shapes for forming new targets on a third layer (Layer 3). Layer 3 also shows the layer produced using Mask 3. It can be seen that when the alignment shapes on the third mask are properly aligned with the targets to be patterned on the second layer, new targets may also be formed on the third layer using the new target shapes on the third mask.

FIG. 33(d) shows a fourth mask (Mask 4) having both alignment shapes used to align the photomask to the targets previously patterned on the third layer and new target shapes for forming new targets on a fourth layer (Layer 4). Layer 4 also shows the layer produced using Mask 4. It can be seen that when the alignment shapes on the fourth mask are properly aligned with the targets to be patterned on the third layer, new targets may also be formed on the fourth layer using the new target shapes on the fourth mask. In addition to alignment shapes and new target shapes, masks may contain vernier-type shapes to allow the accuracy of alignment to be evaluated. The positions of such shapes would also change from even to odd layers on alternating masks.

It may be desirable to reduce the number of photomasks required to build a structure through methods of mask minimization already described in U.S. Pat. No. 6,027,630. The method described in this patent for reusing photomasks may be modified according to some embodiments of the invention using software algorithms such that an existing or planned photomask for an even layer can be used in lieu of generating a new photomask for an even layer, but not for an odd layer, and vice-versa, in the case that alignment targets, verniers, or other alternating structures are needed as described above.

Generally, a photomask is used to build structures across an entire substrate. However, there may be cases (e.g., the fabricate of prototype quantities) where only a quarter or a half of the substrate is needed for the structures. For example, it may be desirable to build a multiple layer structure while only using, for example, one quarter or one half of the substrate. Conventionally one might choose to build on a smaller substrate and perhaps use smaller (and less costly) photomasks as a result. However, this approach requires specialized tooling and possibly equipment for processing a substrate of smaller size, and does not ensure that the processing conditions and thus behavior of the devices produced on the smaller substrate will be identical to those produced (typically in larger quantity) on the larger substrate. Conventionally, a different photomask may be necessary for each layer of the structure, adding significantly to the cost of fabricating the structure, even if only a small quantity of devices are needed.

In order to reduce the cost involved in using multiple photomasks, particularly when producing small or prototype quantities, some embodiments of the invention advantageously place multiple patterns (each pattern for exposing a different layer of the same structure located on some portion of the substrate) onto a single photomask.

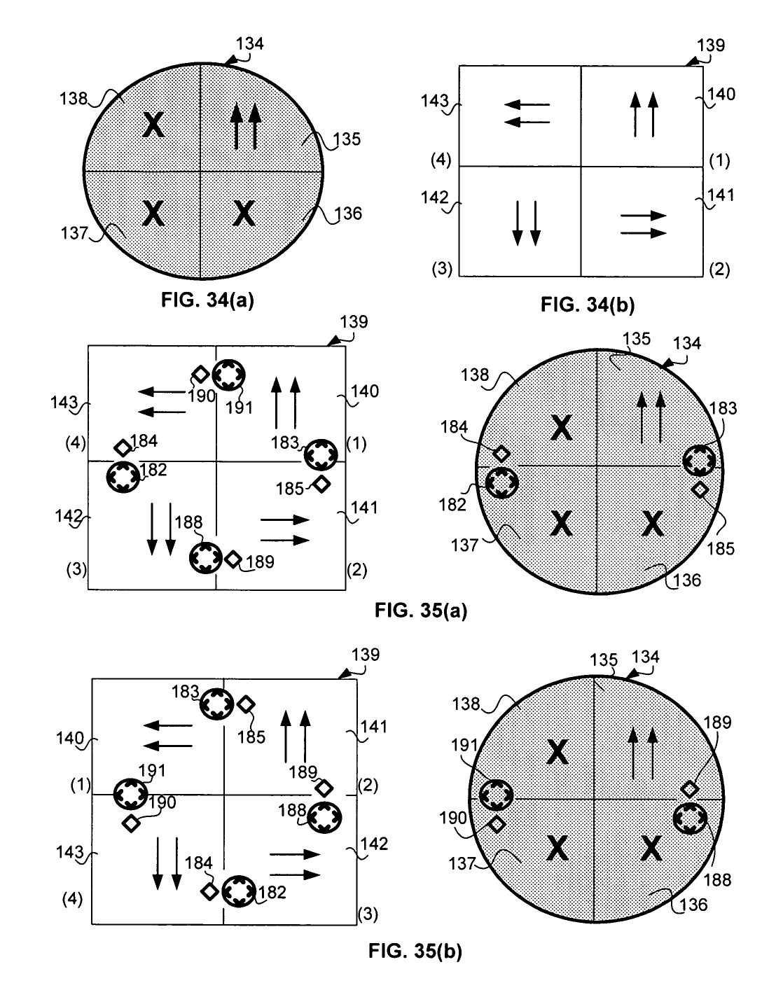

Referring to FIG. 34(a), according to some embodiments of the invention, substrate 134 is shown as having four quadrants 135, 136, 137 and 138. The two arrows shown in quadrant 135 of substrate 134 represent an particular orientation of a layer to be exposed. The X in the remaining quadrants 136, 137 and 138 represents a “don't care” condition. In other words, the only portion of the substrate 134 intended to yield usable structures is quadrant 135.

Referring to FIG. 34(b), according to some embodiments of the invention, photomask 139 is also shown as having four quadrants 140, 141, 142 and 143, each having two arrows that represent a pattern having a particular orientation. Each of quadrants 140-143 are used to expose an individual successive layer of a structure that is to be fabricated in quadrant 135 of substrate 134. Also, each quadrant is shown with a number 1-4 representing the order in which the photomask is applied for four individual successive layers to be exposed in quadrant 135.

When the photomask 139 is used to expose the layers in quadrant 135, quadrant 140 (1) of the photomask is used in patterning the first of the four successive layers. This is because quadrant 140 has the pattern on the photomask that is initially in the correct orientation relative to quadrant 135 of substrate 134.

Then, according to some embodiments of the invention, the photomask 139 is rotated (in this example, counterclockwise) by 90 degrees, such that the pattern in quadrant 141 (2) is in the correct orientation relative to quadrant 135 of substrate 134. The photomask is then used to pattern the second of the four successive layers.

The same process is repeated for quadrants 142 (3) and 143 (4) in order to pattern the third and fourth of the four successive layers, respectively. It is apparent from FIGS. 34(a)-(b) that the “don't care” quadrants 136, 137 and 138 will have no value since the layers will not be in the correct thickness and moreover (if different layers are fabricated with different thicknesses) will not necessarily have the correct thicknesses. However, generally speaking, substrates such as substrate 134 are less costly than a set of photomasks such as photomask 139. Thus, even though a portion of the substrate 134 is not used, the economical use of the photomask leads to an overall cost savings for the fabrication process.

Although the embodiment described above divided the substrate and the photomask into quadrants, other embodiments may divide the substrate and the photomask into halves, with half of the substrate yielding usable structures. In this case, two layers could be patterned using the photomask, with a 180 degree rotation of the photomask being performed after the first layer is patterned and before patterning the second layer. Other embodiments may use other divisions of the substrate and photomask, with appropriate rotation and/or translation in an appropriate direction after each successive layer.

When using the above embodiments it may be desirable to cut the substrate so as to remove the “don't care” quadrants or “don't care” half prior to releasing the structures; otherwise corrupted structures in these quadrants may become detached from the substrate while in the etchant bath and become entangled with or otherwise damage the desired structures. In some embodiments the photomask quadrants or halves may not be used successively (i.e., quadrants 140-143 used to pattern layers in strict sequence).

If it is desired to fabricate more than a single quadrant or half of a substrate that yields usable structures, the above embodiments can be modified by incorporating a secondary mask which blocks light from passing through the photomask in some regions, and performing multiple exposures for each layer. For example, if the photomask is divided into quadrants, the secondary mask would normally be designed so as to prevent three out of four of the substrate quadrants from being exposed. The secondary mask would then be rotated in synchronization with the photomask, and up to three more exposures would then be made, thus exposing more of substrate completely to the correct pattern for a given layer (structures would be oriented differently depending on which substrate quadrant they were located in).

More generally, the embodiments described above may be used to reduce the number of photomasks required, with a more arbitrary assignment of photomask quadrants to device layers (e.g., quadrant 140 patterning layer 6, quadrant 141 patterning layer 2, etc.). However, it may still be necessary to pay attention (due to the need for alignment shapes and target shapes in particular locations) to which layer patterns are in which quadrants. For example, instead of placing the patterns for layers 1, 2, 3, and 4 on a first photomask and the patterns for layers 5, 6, 7, and 8 on a second photomask, one might put the patterns for layers 1, 4, 7, 2 (in that order of clockwise or counterclockwise rotation) on the first photomask and the patterns for 3, 8, 5, 6 (in that order) on the second photomask: such an arrangement would preserve the layout of even-and odd-numbered layer patterns.

In addition, although the embodiment described above used photoresist as an example of a patternable mold material, the embodiments discussed above would also be applicable to INSTANT MASKS™ and other suitable patternable mold materials. Also, although the embodiment described above rotated the photomask while the substrate remained fixed, a reverse process is also possible, i.e., the substrate may be rotated a suitable amount (for example, 90 degrees) while the photomask remains fixed.

According to some embodiments of the invention, additional alignment targets are used in proportion to the number of rotations required. Using these additional alignment targets, some embodiments of the invention as described below allow multiple odd and even layers to be patterned using a single mask by rotating of the mask to produce alternating layouts of alignment shapes and new target shapes.

As an example, FIG. 35(a) shows photomask 139 from FIG. 34(b) as having four quadrants with 90 degree differences in orientation as described above. Each of quadrants 140-143 are used in patterning an individual successive layer of a structure that is to be fabricated in quadrant 135 of substrate 134. Also, each quadrant is shown with a number 1-4 representing the order in which the photomask is applied for four individual successive layers to be patterned in quadrant 135.

In FIG. 35(b), photomask 139 is also shown as having two pairs of alignment shapes used to align the photomask to the targets on a previous layer on substrate 134 and two pairs of new target shapes for forming new targets on the layer currently being patterned on substrate 134.

As discussed above, according to some embodiments of the invention, a first quadrant 140 of photomask 139 is used in patterning a first layer in quadrant 135 of substrate 134. It is assumed in the present embodiment that a layer formed previous to the current layer to be patterned included alignment targets that may be aligned with alignment shapes 182 and 183. According to some embodiments of the invention, during the same patterning step, new target shapes 184 and 185 are used in patterning new targets in the layer currently being patterned in quadrant 135.

After patterning the layer having the pattern of quadrant 140 of photomask 139, photomask 139 may be rotated a particular amount and direction (90 degrees in a counterclockwise direction in the current embodiment) such that the pattern in quadrant 141 (2) is in the correct orientation relative to quadrant 135 of substrate 134 in order to pattern a succeeding layer in quadrant 135, as illustrated in FIG. 35(b). FIG. 35(b) shows the position of photomask 139 relative to substrate 134 after such rotation. Alignment shapes 188 and 191 may now be aligned with the targets formed on the previously patterned layer by new target shapes 184 and 185. According to some embodiments of the invention, during the same patterning step, new target shapes 189 and 190 are used to pattern new targets in the layer currently being patterned in quadrant 135. It should also be noted that other pairs of alignment shapes and target shapes are available 90 degrees from those discussed above and these may also be used for alignment if accessible to the mask aligner.

Thus, it can be seen that some embodiments of the invention as described above allow multiple odd and even layers to be patterned using a single mask wherein rotation of the mask produces alternating patterns of alignment shapes and new target shapes, thus resulting in a reduction in the number of photomasks required to produce structures and a corresponding reduction in the cost of fabrication. In the case in which two patterns (vs. four) are incorporated into the photomask and a 180 degree (vs. 90 degree) is used, the alignment shapes and target shapes would be positioned typically symmetrically about the centerline of the mask as shown in the photomask of, for example, FIG. 33(b). Rotation by 180 degrees of such a photomask relative to the substrate would automatically create the alignment shapes and target shape layout of, for example, FIG. 33(c).

According to other embodiments of the invention, mask usage may be minimized through using both a single photomask to expose a layer and, in addition, using laser direct imaging, a pattern generator or other suitable means for modifying the exposure that has or will be performed using the photomask. In this manner, for example, an initial pattern for forming a desired final feature—but varying slightly from the desired final feature—may be initially patterned in a patternable mold material using only a single photomask. Then, the initial pattern may be slightly modified using, for example, laser direct imaging to produce the desired final feature. According to some embodiments of the invention, an analysis may be performed, for example, on a layer by layer basis to determine areas on a layer where such modification techniques would be possible and desirable in lieu of creating a new mask in order to achieve the desired pattern of exposure. This analysis may be performed, for example, by a suitable processing device running a suitable software program, or may be performed by hardware, firmware or a combination thereof.

According to further embodiments of the invention, foreign objects may be incorporated within layers formed on a substrate. Examples of foreign objects may include, but are not limited to, ball bearings, integrated circuits, lenses, mirrors, fiber optic strands, needle probes or other objects that cannot easily be manufactured during an EFAB process due to geometry limitations or materials limitations.

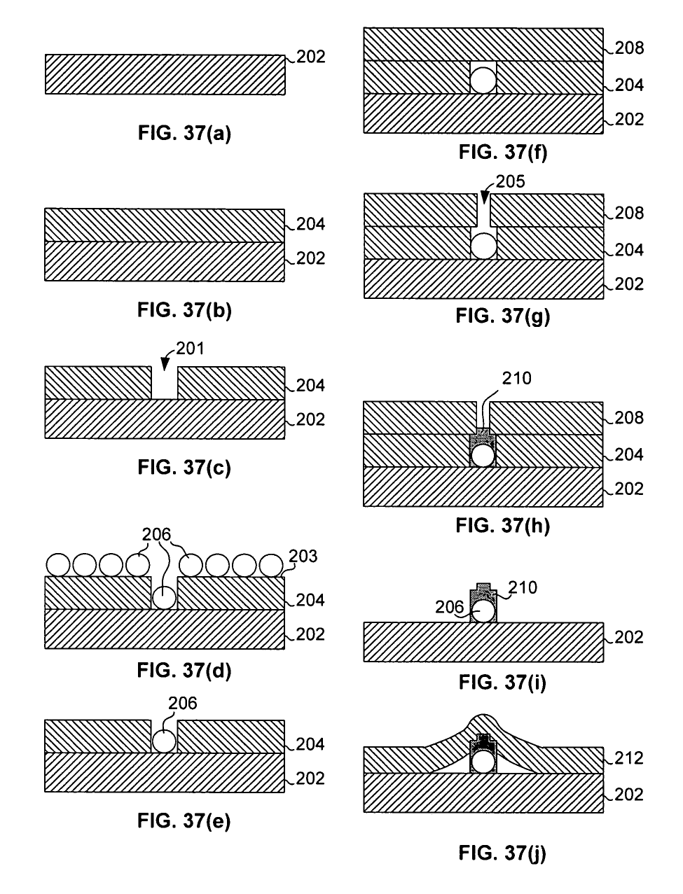

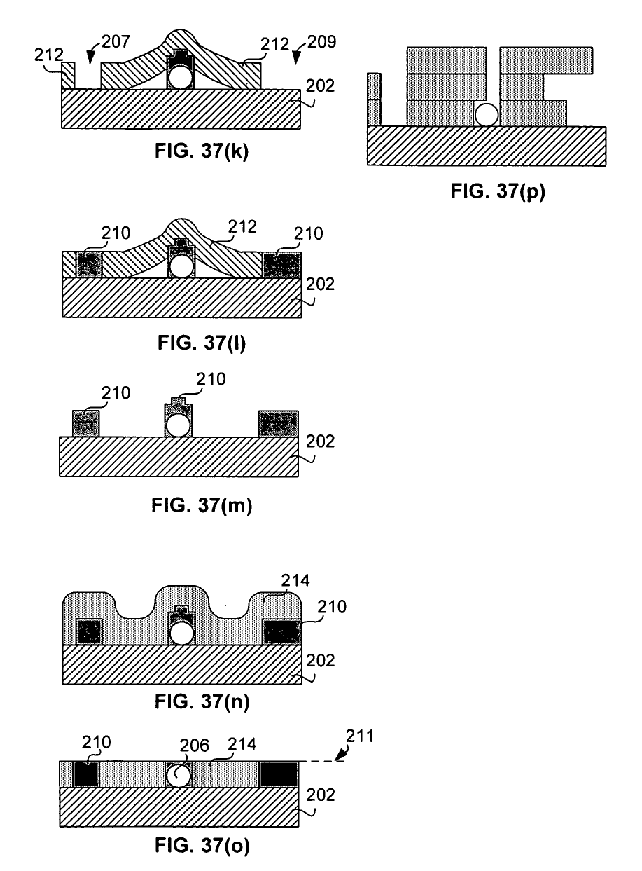

FIGS. 37(a)-(p) show a process for incorporating objects within layers formed on a substrate, according to some embodiments of the invention. As shown in FIG. 37(a), a substrate 202 is shown, onto which patternable mold material 204 (for example, photoresist or solder mask) has been deposited as shown in FIG. 37(b). In FIG. 37(c), material 204 has been patterned (for example, if a photoresist, by use of a photomask, developing, etc., by laser direct imaging, a pattern generator and the like or, a combination of these methods) to produce aperture 201. In FIG. 37(d), one or more objects 206 (in the present example objects 206 are balls) are made to fall into aperture 201, for example by flowing the objects 206 onto the surface 203 of patternable mold material 204, for example in a liquid medium. According to other embodiments, where objects 206 are balls or other spherical objects, the objects may be rolled onto the surface 203. Alternatively, objects 206 may be poured onto the surface 203, and those objects not falling into an aperture may be squeegeed off the surface 203 or otherwise removed as shown in FIG. 37(e). Other embodiments may use other methods for placing objects 206 into apertures such as aperture 201. For example, a pick and place machine or other suitable machine may be used to place the objects into the apertures.

In FIG. 37(f), another patternable mold material 208 has been deposited in order to cap the object 206, i.e., to secure object 206 within aperture 201. According to some embodiments, material 208 may be a dry film resist. According to other embodiments, patternable mold material 208 may be the same type of material as patternable mold material 204 or some other suitable patternable mold material. According to some embodiments, forming patternable mold material 208 over object 206 may be unnecessary if, for example, sufficient care is used such that the object 206 does not fall out of aperture 201.

In FIG. 37(g), patternable mold material 208 has been patterned to produce aperture 205. In FIG. 37(h), a first material 210 (for example, a metal such as copper) has been formed (for example by electrodeposition through aperture 205) in aperture 201 to at least partially encase and secure the object 206 within aperture 201. First material 210 is a sacrificial material, according to the embodiment of the invention shown in FIG. 37. In FIG. 37(i), patternable mold material 204 has been removed (for example, by use of a chemical stripper) to expose regions of the substrate 202 which are not covered with first material 210. In FIG. 37(j), a patternable mold material 212 has been deposited over substrate 202 and material 210. Patternable mold material 212 may be, for example, a dry film resist or a suitable liquid resist.

In FIG. 37(k), patternable mold material 212 has been patterned to produce apertures 207 and 209. First material 210 is then deposited into apertures 207, 209, as shown in FIG. 37(l). Although according to the present embodiment first material 210 is deposited as shown in FIG. 37(l), according to other embodiments a material different from first material 210 (for example, a different metal) may be deposited instead. In FIG. 37(m), patternable mold material 212 has been stripped. In FIG. 37(n), second material 214 has been blanket deposited (for example by electrodeposition) to fill apertures 207, 209. Second material 214 may be a material different from first material 210 (for example, a different metal).

In FIG. 37(o), materials 210 and 214 have been planarized to a sufficient depth to remove all of second material 214 overlying first material 210, and also to establish a layer of the desired thickness, flatness, and surface finish. As shown in FIG. 37(o), the level of planarization 211 may be set to be above the upper level of object 206. Alternatively, in other embodiments, it may be desirable to planarize to some level below the upper level of object 206. In that case, an upper portion of the object itself may be planarized.

FIG. 37(p) shows an exemplary product of the above-described process after additional layers have been formed on the substrate 202 and first material 210 has been removed, according to some embodiments of the invention. Thus, as shown in FIG. 37(p), multiple layers of second material 214 remain to form a structure on substrate 202 that has object 206 incorporated in a layer of the structure.

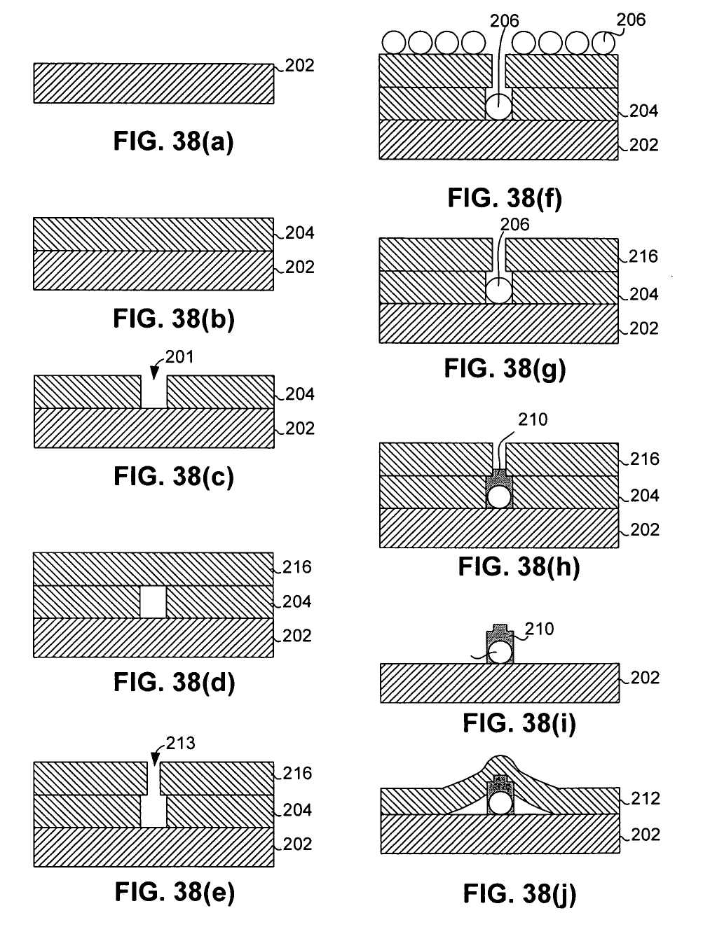

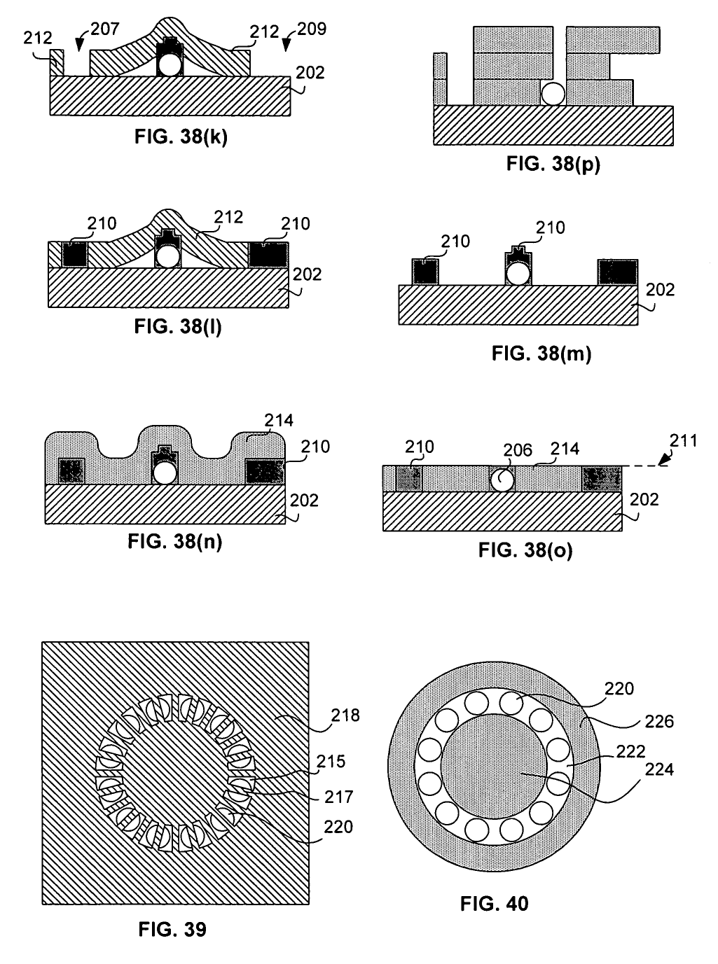

FIGS. 38(a)-(p) show another embodiment of the invention for incorporating foreign objects within layers formed on a substrate. The exemplary process shown in FIGS. 38(a)-38(c) and 38(h)-38(p) are identical to the corresponding process steps shown in FIGS. 37(a)-(c) and 37(h)-(p) and described above. Thus, these process steps will not be described further. The exemplary process shown in FIG. 38 differs from that shown in FIG. 37 only as shown in FIGS. 38(d)-(g), as will be described below.

As shown in FIG. 38(d), after aperture 201 is formed in patternable mold material 204, a second patternable mold material 216 is formed over patternable mold material 204 and aperture 201. Patternable mold material 216 may be, for example, a photoresist that is deformable. According to some embodiments, patternable mold material 216 may preferably be an elastic or semi-elastic material. In FIG. 38(e), aperture 213 is formed in patternable mold material 216. In FIG. 38(f), objects 206 are flowed or otherwise deposited onto the surface 203 patternable mold material 216.

In FIG. 38(g), one or more objects 206 are forced into aperture 201 through the aperture 213 formed in the deformable patternable mold material 216 and remains secured in the aperture by patternable mold material 216. Thus, some embodiments of the invention as shown in FIG. 38 differ from those shown in FIG. 37 in that the second layer of patternable mold material 216 is formed before objects 206 are incorporated into a layer and an object 206 is inserted through an aperture 213 formed in the patternable mold material 216 into aperture 201.

FIG. 39 shows a top view of a step in the formation of a ball bearing structure formed according to some embodiments of the invention. FIG. 39 shows patternable mold material 218 formed over apertures 215 to secure balls 220 within the apertures 215. Patternable mold material 218 has been patterned to include stripes 217 that prevent the balls 220 from falling out of apertures 215, but allow deposition of a material into apertures 215 on either side of stripes 217. FIG. 40 shows a completed ball bearing structure formed according to some embodiments of the invention. Balls 220 move freely in a track 222 that is formed between inner structural material 224 and outer structural material 226.

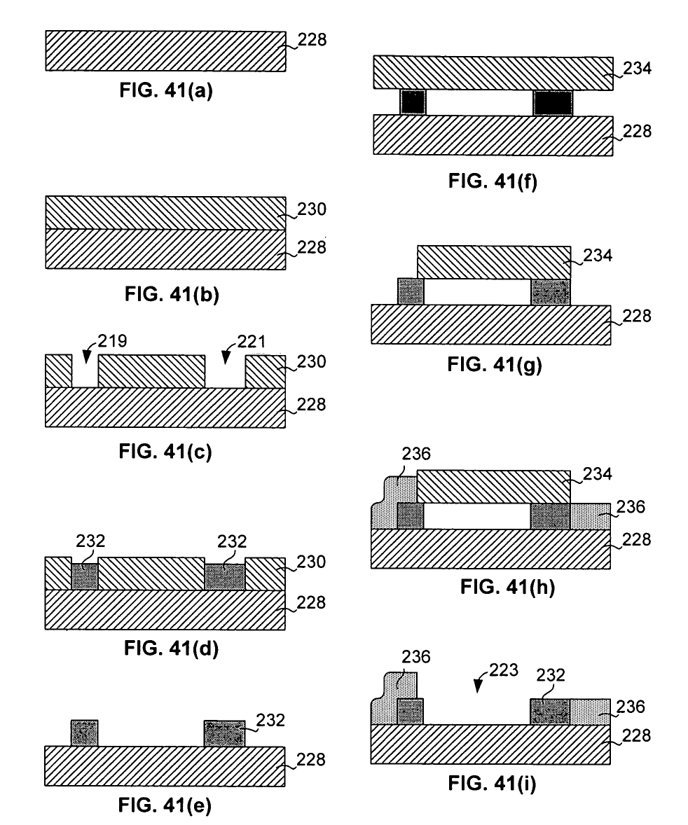

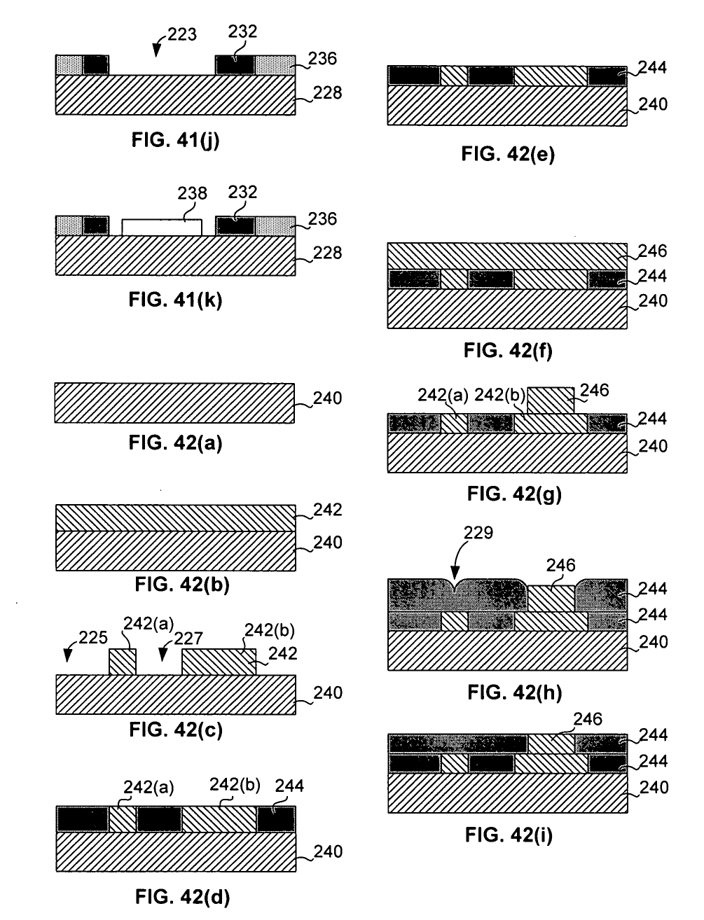

FIGS. 41(a)-(k) show another embodiment of the invention for incorporating foreign objects within layers formed on a substrate. As shown in FIG. 41(a), a substrate 228 is shown, onto which patternable mold material 230 (for example, photoresist or solder mask) has been deposited as shown in FIG. 41(b). In FIG. 41(c), material 230 has been patterned (for example, if a photoresist, by use of a photomask, developing, etc., by laser direct imaging, a pattern generator and the like or, a combination of these methods) to produce apertures 219 and 221. In FIG. 41(d), a first material 232 (for example, a metal such as copper) has been formed (for example by electrodeposition) in apertures 219, 221. In FIG. 41(e), patternable mold material 230 has been stripped. In FIG. 41(f), a patternable mold material 234 has been formed over first material 232. Patternable mold material 234 may be, for example, a dry film resist or a suitable liquid resist.

In FIG. 41(g), patternable mold material 234 has been patterned to expose areas of substrate 228 and first material 232. In FIG. 41(h), a second material 236 (for example, a metal such as nickel) has been formed (for example by electrodeposition) on the exposed areas of substrate 228 and first material 232. In FIG. 41(i), patternable mold material 234 has been removed (for example, by use of a chemical stripper), leaving a cavity 223. In FIG. 41(j), materials 232 and 236 have been planarized to a sufficient depth to remove all of second material 236 overlying first material 232, and also to establish a layer of the desired thickness, flatness, and surface finish. In FIG. 41(k), object 238 has been placed inside cavity 223.

Thus, it can be seen that according to the embodiment of the invention described above, a cavity is created by patterning two layers of patternable mold material. First, a layer of patternable mold material is patterned for the deposit of the first material. The first material is deposited. The first patternable mold material is removed to form a cavity. Then, a second layer of patternable mold material is formed and patterned for the deposit of the second material. The second layer of patternable mold material protects the cavity from deposition of the second material. The second material is then deposited, and the second layer of patternable mold material is removed. The object is then placed in the cavity. Although the object is shown as being placed into the cavity after the formation of a first layer according to some embodiments of the invention, other embodiments may form additional layers while maintaining the cavity. Once the desired number of layers has been formed or at some intermediate point in the formation of layers, the object may be inserted in the cavity. According to some embodiments of the invention, additional material may be deposited over the object to secure it in place; if desired the layer may be planarized again after this deposition step. According to some embodiments of the invention, first material 232 may be a sacrificial material while second material 236 may be a structural material. In other embodiments, the reverse may also be true. When first material 232 is the sacrificial material, etching efficiency of the sacrificial material may be improved due to the sacrificial material being adjacent to the cavity, thus allowing the etchant to more easily gain access to the sacrificial material. Indeed, the method shown in FIG. 41 can be used without the addition of an object in order to create structures in which one or more regions of sacrificial material contain a cavity to improve etching. In addition, during a planarization step, it may be advantageous to have the sacrificial material adjacent to the structural material as shown in FIG. 41(i), such that the structural material may smear less on its corners.

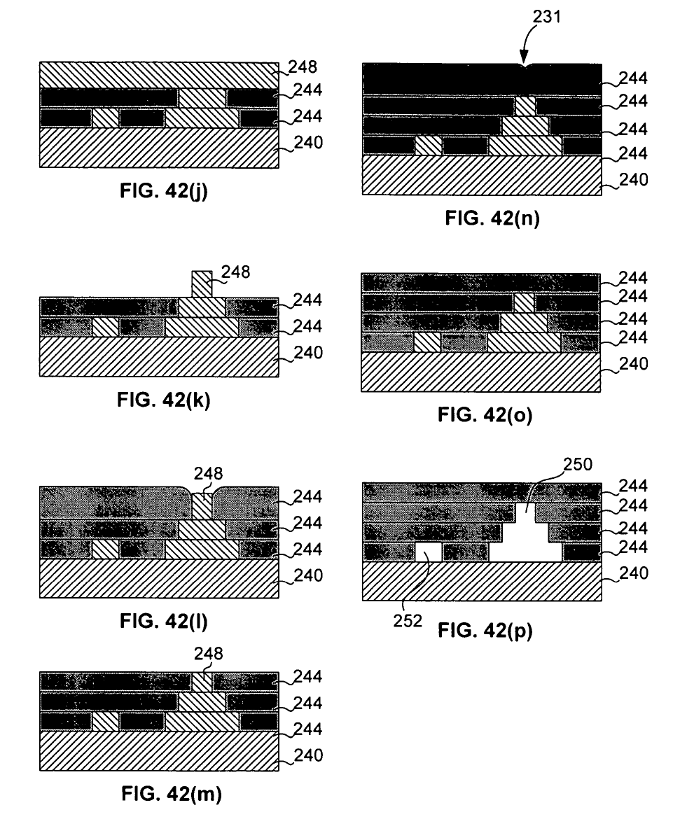

According to further embodiments of the invention, as shown in FIGS. 42(a)-42(p), the patternable mold material may be used as the sacrificial material in order to form channels or other hollow shapes within layers formed on a substrate. As shown in FIG. 42(a), a substrate 240 is provided, onto which patternable mold material 242 (for example, photoresist or solder mask) has been deposited as shown in FIG. 42(b). In FIG. 42(c), material 242 has been patterned (for example, if a photoresist, by use of a photomask, developing, etc., by laser direct imaging, a pattern generator and the like or, a combination of these methods) to produce apertures 225 and 227 and patternable mold material portions 242(a) and 242(b). In FIG. 42(d), a structural material 244 (for example, a metal such as gold) has been formed (for example by electrodeposition) in apertures 225, 227. According to some embodiments, planarization may then be performed, if necessary, as shown in FIG. 42(e). In FIG. 42(f), a second layer of patternable mold material 246 has been formed over patternable mold material 242 and structural material 244 and patterned as shown in FIG. 42(g). In FIG. 42(h), another layer of structural material 244 has been formed over the first layer of structural material 244, by, for example, electrodeposition.

It can be seen in FIG. 42(h) that the second layer of structural material 244 is formed over the first layer of structural material 244. Structural material 244 also mushrooms over onto the narrow portion 242(a) of patternable mold material from both sides (as indicated by reference number 229 in FIG. 42(h)) such that portion 242(a) is completely covered by structural material 244. The dimensions of the patternable mold material 246 that has been patterned to remain over wide portion 242(b), as shown in FIG. 42(h), may be chosen such as to fill a space that it has been predetermined will approximately exist as a result of the mushrooming of structural material 244 over the wide portion 242(b). The amount of mushrooming that may occur for a given deposited material may be determined based on factors such as, for example, the thickness of the deposited material, the type of plating bath used, the amount of agitation within the plating bath and other plating parameters. In FIG. 42(i), planarization has been performed.

In FIG. 42(j), a third layer of patternable mold material 248 has been formed over the second layer of structural material 244 and patternable mold material 246. Patternable mold material 248 is then patterned. In FIG. 42(k), a third layer of structural material 244 has been formed over the second layer of structural material 244 and patternable mold material 246. Again, the dimensions of the patternable mold material 248 that has been patterned to remain over patternable mold material 246, as shown in FIG. 42(k), may be chosen such as to fill a space that it has been predetermined will approximately exist as a result of the mushrooming of structural material 244 over patternable mold material 246. In FIG. 42(m), planarization has again been performed.

In FIG. 42(n), a fourth layer of structural material 244 has been formed over the third layer of structural material 244 and patternable mold material 248. The dimensions of the patternable mold material 248 that has been patterned to remain over patternable mold material 246 are now such that mushrooming of structural material 244 from both sides (as indicated by reference number 231 in FIG. 42(n)) completely covers patternable mold material 248. In FIG. 42(o), planarization has again been performed. In FIG. 42(p), the sacrificial patternable mold material has been removed, leaving channels 250 and 252.

As described above, some embodiments of the invention advantageously use a patternable mold material as the sacrificial material to form structures with only the patternable mold material and a structural material. In this manner, an additional metal sacrificial material is not required to build structures. In addition, structures that might be difficult to etch using a metal sacrificial material are possible when using a patternable mold material as the sacrificial material, according to some embodiments of the invention as described above. For example, if the patternable mold material is a polymer material, etching may be performed using plasma, which penetrates into narrow cavities more easily than a liquid etchant can. According to some embodiments of the invention, structural material 244 may be the same material on each layer or may be two or more different materials. According to some embodiments of the invention, software may be used to automatically modify the original geometry so as to allow structures to be fabricated using a patternable mold material as the sacrificial material. For example, the channel on the right side of FIG. 42(p) may have been originally designed with a rectangular shape similar to the channel on the right, but wider. In this case the software—having been provided with information about the maximum width of mold material that may be bridged by mushrooming structural material (as a function of various parameters)—may have modified the rectangular geometry to yield the domed geometry shown in FIG. 42(p) to enable fabrication.

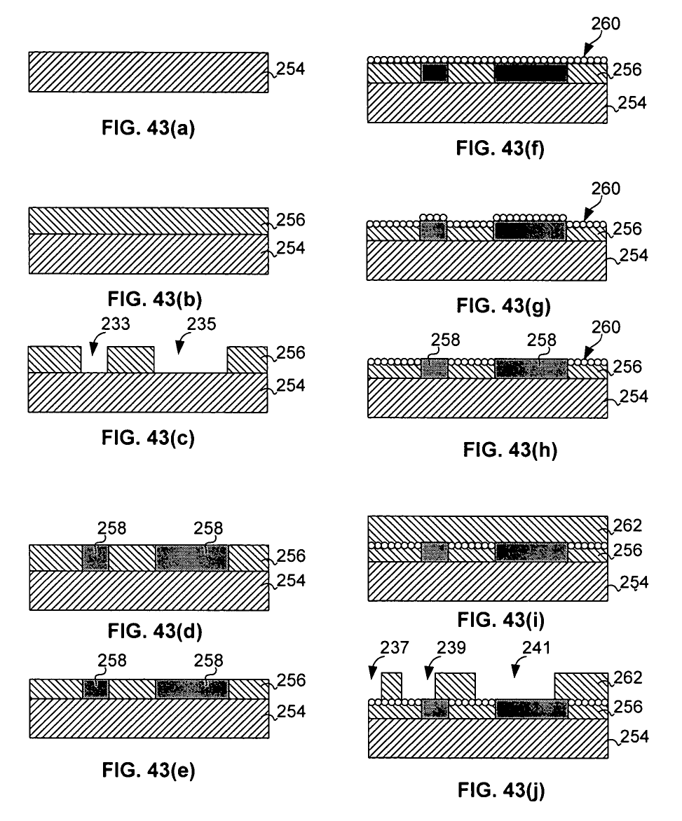

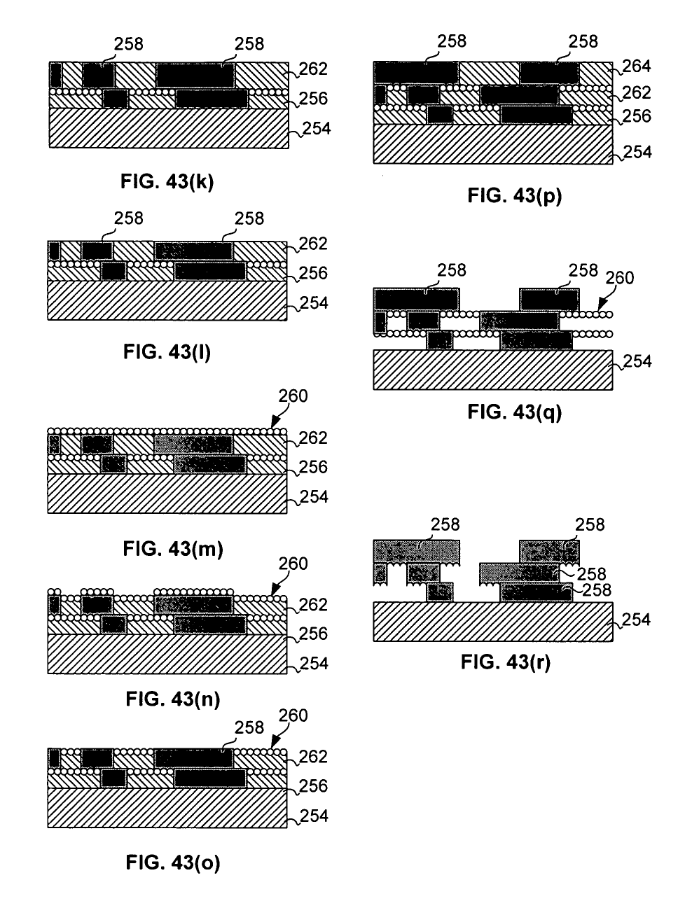

FIGS. 43(a)-(r) show an alternative embodiment for using patternable mold material as the sacrificial material. As shown in FIG. 43(a), a substrate 254 is shown, onto which patternable mold material 256 (for example, photoresist or solder mask) has been deposited as shown in FIG. 43(b). In FIG. 43(c), material 256 has been patterned (for example, if a photoresist, by use of a photomask, developing, etc., by laser direct imaging, a pattern generator and the like or, a combination of these methods) to produce apertures 233 and 235. In FIG. 43(d), a material 258 (for example, a metal such as copper) has been formed (for example by electrodeposition) in apertures 233, 235. In FIG. 43(e), planarization has been performed.

In FIG. 43(f), in order to make the top surface of the patternable mold material 256 conductive, a coating of fine particles 260 are applied to the top surface of patternable mold material 256. According to some embodiments of the invention, the particles 260 may be applied as a slurry within a liquid carrier such as, but not limited to, alcohol. The carrier then evaporates, leaving behind the particles 260. According to alternative embodiments, the particles 260 may be airborne particles that are “dusted” onto the surface of material 258 and patternable mold material 256. According to further alternative embodiments, the particles 260 may be applied onto the surface of material 258 and patternable mold material 256 using a electrostatic attraction. Particles 260 are chosen such that they do not adhere strongly to the surface of the material 258 and may easily be washed away or otherwise removed. In one embodiment, particles 260 may be, for example, copper particles.

In FIG. 43(g), patternable mold material 256 has been made softer and/or tackier by, for example, heating and/or through the use of a suitable solvent in order to secure the particles 260 using the patternable mold material 256. If heating is used, it may be done in an oven, for example, or may be done using infrared light or other suitable method of heating. In some embodiments, in addition, or in the alternative, pressure may be applied (for example, with a conformable pad) to the particles 260 in order to push them into the patternable mold material 256. According to still further embodiments, a patternable mold material may be used that has selectively tacky areas for receiving the particles and other areas that are not tacky and will not receive the particles.

Then, as shown in FIG. 43(h), a removal process (e.g., a rinse, application of a stream of air and the like) has been performed to remove the particles 260 that are above the material 258, such that the particles 260 remain only over the patternable mold material 256 which was softened and made tackier by the process described above to receive and secure them. According to some embodiments of the invention, the particles may be washed away using, for example, alcohol or other suitable material.

The particles 260 may be applied close enough together that they form a continuous conductive film over patternable mold material 256 and material 258. In other embodiments, after application of the particles 260, they may be consolidated by melting during, for example, a heating step. The heating step may be a heating step as described above for softening patternable mold material 256.

As a result, as shown in FIG. 43(h), assuming material 258 is conductive (for example, a metal), a completely conductive surface now exists due to the linking together of portions of material 258 by conductive particles 260. Thus, a plating base exists for plating of a subsequent layer. In some embodiments, small gaps between the particles 260 may be acceptable in forming a plating base, as bridging of material 258 may occur across the gaps between individual particles 260. In FIG. 43(i), a second layer of patternable mold material 262 has been formed over material 258 and particles 260. In FIG. 43(j), patternable mold material 262 has been patterned to form apertures 237, 239 and 241. In FIG. 43(k), a second layer of material 258 has been deposited into apertures 237, 239 and 241. In FIG. 43(l), planarization may be performed, if necessary.

In FIG. 43(m), a second layer of particles 260 are applied to the top surface of the second layer of material 258 and patternable mold material 262 to form a conductive plating base, as described above. In FIG. 43(n), the particles 260 have been secured to patternable mold material 256, as described above. In FIG. 43(e), a removal process has been performed to remove particles 260 that are above the material 258, such that the particles 260 remain only over the patternable mold material 262. In FIG. 43(p), a third layer of patternable mold material 264 and a third layer of material 258 have been formed in the same manner as that described above. Additional layers may be formed in the same manner if desired.

In FIG. 43(q), patternable mold material 256, 262 and 264 has been removed. According to some embodiments of the invention, particles 260 may also be a sacrificial material (i.e., may be removed to form a final structure). In that case, particles 260 may be removed using an additional removal step suitable to the material used to form particles 260. As shown in FIG. 43(q), particles 260 may be removed by, for example, a liquid etchant. The liquid etchant may easily access and remove the particles 260 due to the open channels that are formed by the removal of the patternable mold material. In FIG. 43(r), an exemplary final structure formed from material 258 is shown. According to some embodiments of the invention, material 258 may be the same material on each layer or may be two or more different materials. In addition, in some embodiments, it may be desirable to leave particles 260 in the final structure such that the final structure would be as shown in FIG. 43(q).

According to some alternative embodiments of the invention, instead of applying particles 260 in the step shown in FIG. 43(f), the particles 260 may be applied to exposed areas of patternable mold material 256 after the second layer of patternable mold material 262 is formed and patterned as shown in FIG. 43(j). The particles 260 may then be secured in the patternable mold material 256 using a process as described above.

According to other alternative embodiments of the invention, a patternable mold material may be used to form a pattern for the deposition of a material such as material 258. After material 258 has been deposited, the patternable mold material may then be removed and replaced with a tacky material that is suitable for receiving particles 260 without an additional heating step or the use of a solvent. According to further alternative embodiments, a patternable mold material may be used to form a pattern for the deposition of a material such as material 258. The patternable mold material may then be removed and replaced with a conductive material other than a metal to form a continuous plating base with the deposited material. Such a non-metal conductive material (for example, a conductive polymer such as a conductive epoxy) may have the advantage of being more easily removable than a metal. Particles 260 are preferably small to minimize any potential roughness (as indicated in FIG. 43(r) on surfaces facing substrate 254.

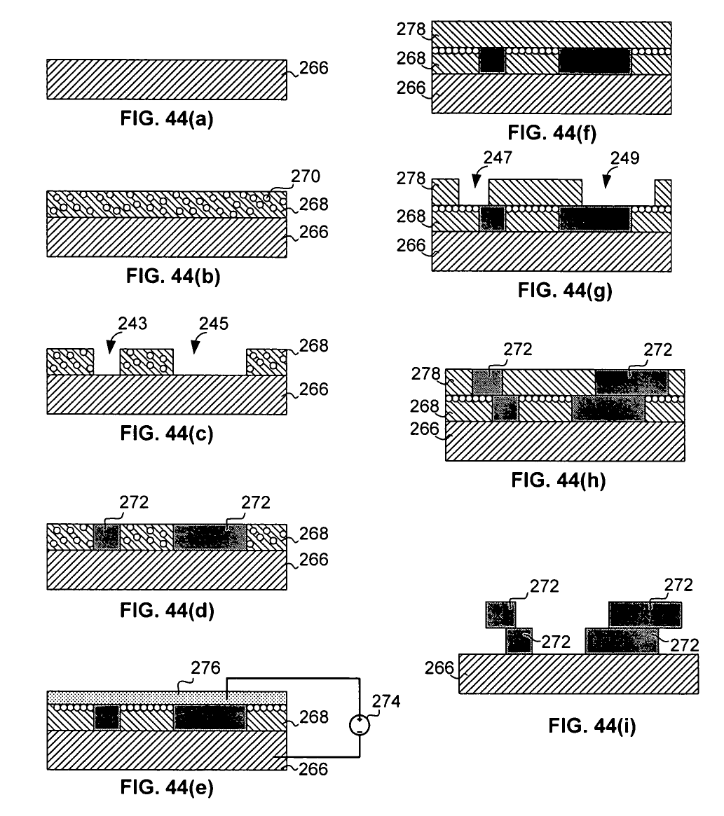

FIGS. 44(a)-(i) show another alternative embodiment for using patternable mold material as the sacrificial material. As shown in FIG. 44(a), a substrate 266 is shown, onto which patternable mold material 268 (for example, photoresist or solder mask) has been deposited as shown in FIG. 43(b). Patternable mold material 268 may be applied, for example, using a spin-on process, using a curtain coater or any other suitable method to apply the patternable mold material. Patternable mold material 268 comprises conductive particles 270 that are initially dispersed at a low density throughout the patternable mold material 268. The low density dispersion of particles 270 allows light to be passed through the patternable mold material 268 so that it may be patterned to form apertures 243 and 245 without significant interference from particles 270, as shown in FIG. 44(c).

In FIG. 44(d), material 272 has been formed in apertures 243 and 245. In FIG. 44(e), power supply provides an electric field for driving particles 270 to the upper surface of patternable mold material 268 to form a plating surface for a subsequent layer of material 272. An electrode having one polarity is positioned above an upper surface of patternable mold material 268 and substrate 266 serves as an electrode of opposite polarity such that a resulting electric field drives the conductive particles 270 to the upper surface of the patternable mold material 268.

Other alternative methods for driving particles 270 to the upper surface of patternable mold material 268 include, but are not limited to, applying a magnetic field to magnetically attract the particles 270 to the upper surface of patternable mold material 268; applying a centrifugal force to induce the particles 270 to migrate to the upper surface of patternable mold material 268; lowering a viscosity of the patternable mold material 268 such that the particles migrate (e.g., if buoyant) to the upper surface of patternable mold material 268; and vibrating the substrate 266 and patternable mold material 268 such that the particles 270 to migrate to the upper surface of patternable mold material 268; or any combination of the above.

According to some alternative embodiments of the invention, the driving of the particles 270 the upper surface of the patternable mold material may be performed at times in the process other than as has been already described. For example, the driving step may be performed at some point after the patternable mold material 268 has been patterned, as shown in FIG. 44(c), but before the second layer of material 272 is deposited, as shown in FIG. 44(h). According to some embodiments of the invention, material 272 may be the same material on each layer or may be two or more different materials.

In FIG. 44(f), after the particles 270 have been positioned along the upper surface of the patternable mold material 268 to form a plating surface, a second layer of patternable mold material 278 has been formed and patterned to produce apertures 247 and 249, as shown in FIG. 44(g). In FIG. 44(h), a second layer of material 272 has been formed in apertures 247, 249 and planarized if necessary. In FIG. 44(i), patternable mold material 268, 278 and particles 270 have been removed and a final structure formed from material 272 remains.

In other alternative embodiments, the patternable mold material may be used as a sacrificial material along with two or more structural materials or along with a second sacrificial material. In still other embodiments, the patternable mold material may be used as one of two or more structural materials with or without a sacrificial material, or it may be used as a structural material along with a sacrificial material (e.g. an electrodeposited metal) that will be removed. In still other embodiments seed layers may be applied in a variety of ways to the patternable mold material to allow more geometric freedom in terms of the structures that can be formed. Various alternative techniques for applying and removing seed layer materials may be found in concurrently filed U.S. patent application Ser. No. ______ (corresponding to Microfabrica Docket No. P-US099-A-MF) referenced in the table to follow and incorporated herein by reference. In some embodiments, seed layers may be applied in a planar manner and as necessary undesired portions may be removed after patterning a desired material on the seed layer. In some embodiments seed layers may be applied in a selective or blanket manner (e.g. a non-planar manner) over an initially applied dielectric or conductive material so it is only located on desired portions of a previously formed layer and such that planarization operations may be used to remove it from undesired regions (e.g. above the dielectric or previously applied conductive material). In still other embodiments, a combination of these approaches may appropriate.

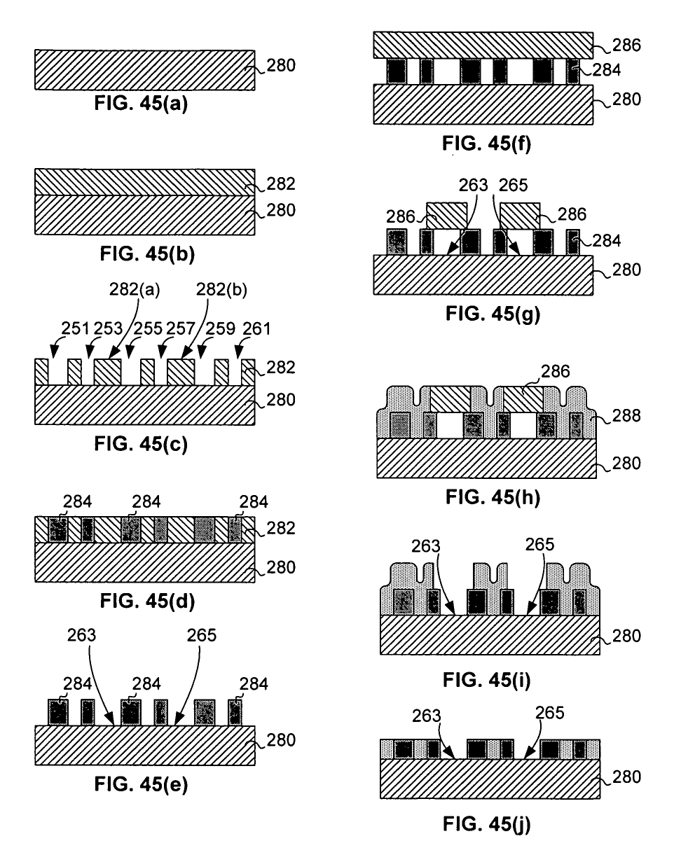

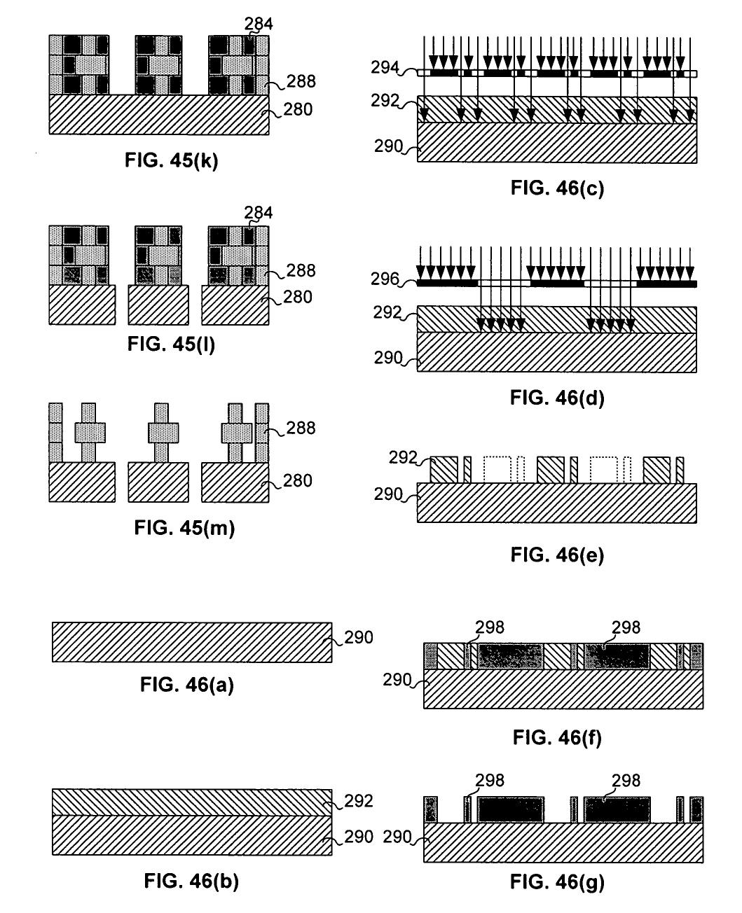

FIGS. 45(a)-(m) show an embodiment of the invention for building layers on large substrates in such a manner as to minimize stresses to a large substrate that may result from deposited materials (which may be exhibit residual stress) deforming the substrate, causing cracking of deposited materials, separation between deposited materials, and so forth. Stresses due to thermal expansion of deposited materials as a result of heating or cooling the deposited materials and/or substrate (the deposited materials may have different coefficients of thermal expansion) can also be minimized by some embodiments of the invention. In addition, some embodiments of the invention may facilitate dicing of large substrates into smaller pieces.

According to exemplary EFAB processes, a selective deposition of a first material is performed. Then a blanket deposition of a second material is performed. Thus, if a wafer including many devices is being fabricated, the devices are usually constructed of a structural material confined to particular dies on the wafer. Sacrificial material would then be blanket deposited everywhere else on the wafer. This ‘ocean’ of sacrificial material may mechanically couple together all the devices. Any stresses that may be associated with the sacrificial or structural material may thus be disadvantageously coupled across the entire wafer and may cause, for example, cracking of the deposited materials and/or distortion (such as bowing) of the wafer.

In order to minimize such problems, some embodiments of the invention restrict the area where the sacrificial material is deposited by forming regions free of sacrificial material during the fabrication process and doing a second pattern deposit of the material rather than a blanket deposit. In this manner, the sacrificial material is only placed where it is needed and any cracking, bowing or other distortion of the wafer is minimized. These regions may correspond to the dicing lanes between individual die, as is assumed in the description shown in FIG. 45, or may be formed in any other pattern as required.

As shown in FIG. 45(a), a substrate 280 is shown, onto which patternable mold material 282 (for example, photoresist or solder mask) has been deposited as shown in FIG. 45(b). In FIG. 45(c), material 282 has been patterned (for example, if a photoresist, by use of a photomask, developing, etc., by laser direct imaging, a pattern generator and the like or, a combination of these methods) to produce apertures 251, 253, 255, 257, 259 and 261 between portions of patternable mold material 282(a) and 282(b) that will later be removed to form dicing lanes. Apertures 251 and 253 belong to a first die on the substrate. Apertures 255 and 257 belong to a second die on the substrate. Apertures 259 and 261 belong to a third die on the substrate. In FIG. 45(d), a first material 284 (for example, a metal such as nickel) has been selectively formed (for example by electrodeposition) in apertures 251, 253, 255, 257, 259 and 261 and planarization, if necessary, has been performed.

In FIG. 45(e), patternable mold material 282 has been removed and dicing lanes 263 and 265 are formed. In FIG. 45(f), a second layer of patternable mold material 286 has been deposited over material 282. Patternable mold material 286 may be, for example, a dry film resist, a liquid resist, or any other suitable patternable mold material. In FIG. 45(g), patternable mold material 286 has been patterned to form protective barriers over dicing lanes 263 and 265 that are located between the three dies. A dry film resist may tent over apertures 255 and 257, as shown in FIG. 45(g). If a liquid or electrodeposited resist is used, it may fill apertures 255 and 257. According to some embodiments of the invention In FIG. 45(h), a second material 288 has been deposited over exposed portions of first material 284 and substrate 280. In FIG. 45(i), patternable mold material 286 has been removed. In FIG. 45(j), planarization has been performed. It can be seen in FIG. 45(j) that dicing lanes 263, 265 are not filled with second material 288.

According to some alternative embodiments of the invention, patternable mold material 286 may be removed during the planarization step rather than in a separate step. Where a liquid resist is used, a portion of the resist left in apertures 255 and 257 after planarization may remain during the build process (though it may ultimately be removed). The patternable mold material filling apertures 255 and 257 may be beneficial during the planarization process for, as an example, minimizing smearing of the metals.

In FIG. 45(k), three layers of first material 284 and second material 288 have been built on substrate 280 in the manner described above. In FIG. 45(l), dicing of substrate 280 has been performed. It can be seen from FIG. 45(l) that the dicing may be performed without having to cut through the first and second materials. This may be beneficial in that deposited metals have a tendency to negatively affect tools such as dicing saws that are used to perform the dicing (e.g., clogging the saw blade due to their relative softness), whereas the substrate may not do so. In FIG. 45(m), the first material 284 has been removed, leaving a structure formed from the second material 288.

Thus, it can be seen that some embodiments of the invention as described above may minimize deleterious effects such as cracking and distortion. Because the dicing lanes of the substrate do not receive the second material when it is deposited, individual dies are de-coupled from each other and stresses on the substrate are minimized. According to some alternative embodiments of the invention, if the die layout of a particular substrate is known a generic mask (such as a conformable contact mask) for masking out the dicing lanes may be used to prevent deposition into the dicing lanes.

Arrays of structures are often fabricated to fulfill a particular function. For example, an array of probe tips may be desirable for probing a wafer. As a result, a set of photomasks may be created to pattern a first array of probes on a first wafer having particular devices at particular locations on the first wafer. If a second wafer has devices located at different locations than the first wafer, it may be necessary to create a new set of photomasks for patterning a new array of probes suitable for the second wafer. Thus, it may be required to create a new set of photomasks for patterning an array of devices such as probes each time the layout of the probes changes.

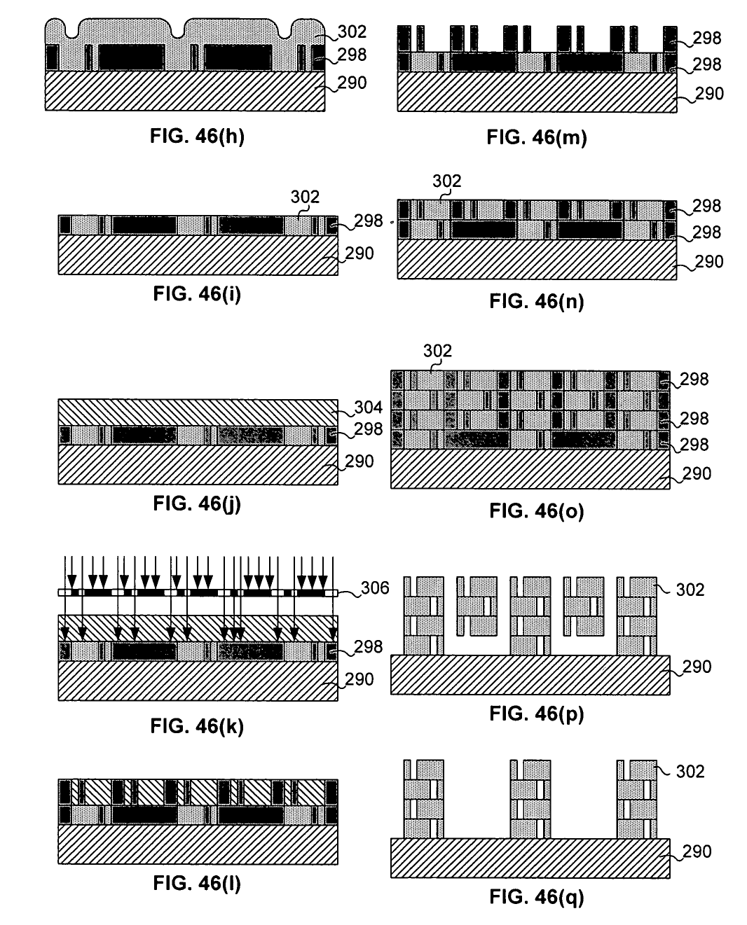

FIGS. 46(a)-(q) show an embodiment of the invention for fabricating customized arrays of devices without needing to use an entirely new set of photomasks for each customized array configuration. Instead, according to some embodiments of the invention, a first set of photomasks may be used to create a full array of structures that may be used with many different device layouts. Depending on a particular device layout, a second photomask may be used to select particular ones of the structures in the full array that will be removed from the full array in order to form a “customized array”. According to some embodiments of the invention, the structures selected for removal from the full array may be removed during the fabrication process by creating a delamination condition for the selected structures. In this manner, rather than creating a new set of photomasks having a new desired array of structures, only one new photomask is required.

As shown in FIG. 46(a), a substrate 290 is shown, onto which positive patternable mold material 292 (for example, a positive photoresist) has been deposited as shown in FIG. 46(b). In FIG. 46(c), photomask 294 is used to expose patternable mold material 292 in a manner that would pattern a full array of five sets of portions of the patternable mold material that would be used to form five devices if no additional exposures of the patternable mold material 292 were to occur (See FIG. 46(e)). The number of devices has been arbitrarily chosen to be five for simplicity. Some embodiments of the invention are also applicable to arrays having different numbers of devices.

According to some embodiments of the invention, in FIG. 46(d), a second photomask 296 is used to again expose patternable mold material 292 such that two of the five sets of portions of the patternable mold material that would result from the first exposure with photomask 294 will not be formed. (According to other embodiments, the sequence of exposure by the first and second photomasks may be reversed.) In FIG. 46(e), the pattern of the array of devices is shown. It can be seen in FIG. 46(e) that only three of the five sets of portions of the patternable mold material have been patterned. Two of the sets (shown by phantom lines) have not been patterned as a result of the second exposure of the patternable mold material 292 using photomask 296. In FIG. 46(f), first material 298 (for example, nickel) has been formed in apertures resulting from the patterning of patternable mold material 292. In FIG. 46(g), patternable mold material 292 has been removed. In FIG. 46(h), a second material 302 (for example, copper) has been blanket deposited over exposed portions of substrate 290 and first material 298. In FIG. 46(i), planarization has been performed.

In FIG. 46(j), a second layer of positive patternable mold material 304 is formed over first material 298 and second material 302. As shown in FIG. 46(k), photomask 306 is used to pattern patternable mold material 304 in order to form an array of five devices. According to the exemplary embodiment, a second masking step is not performed on the second layer of devices, as was done on the first layer. However, according to other embodiments such a second masking step may be performed with a custom photomask if desired. In FIG. 46(l), a second layer of first material 298 has been formed in the apertures that have been patterned in patternable mold material 304 and a planarization step has been performed if necessary. In FIG. 46(m), patternable mold material 304 has been removed. In FIG. 46(n), a second layer of second material 302 has been formed and planarization has been performed. In FIG. 46(o), two additional layers of first material 298 and second material 302 have been formed in the same manner.

In FIG. 46(p), first material 298 has been removed, including portions on which the two devices patterned for removal during the second exposure step (shown in FIG. 46(d)) have been formed. Because the portions of first material 298 supporting these two devices are removed, the devices themselves will also be separated from substrate 290, as shown. In FIG. 46(q), an array of devices having a selected configuration has been formed.

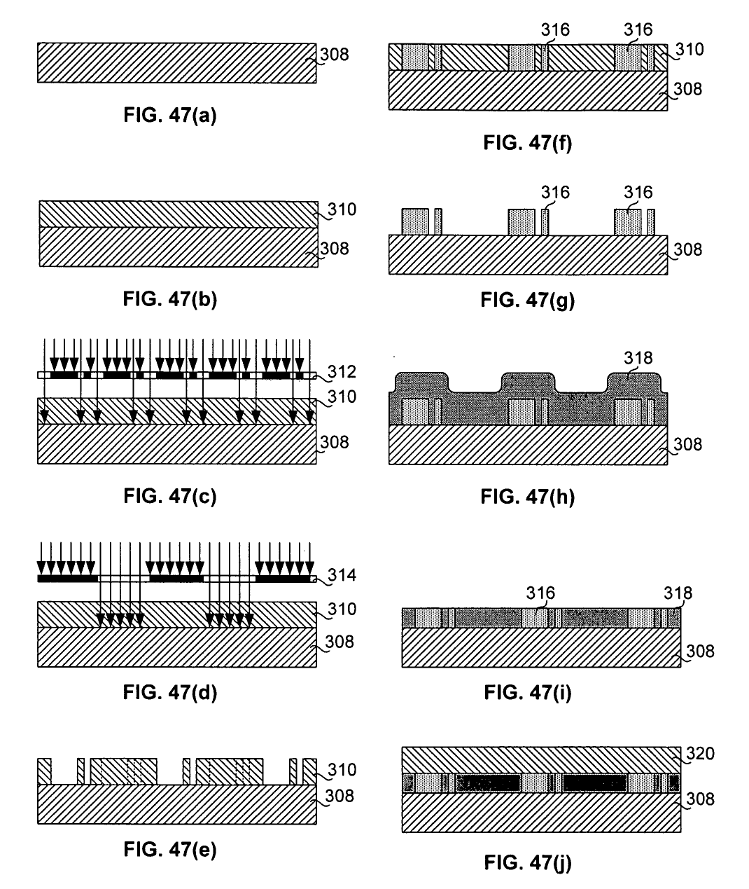

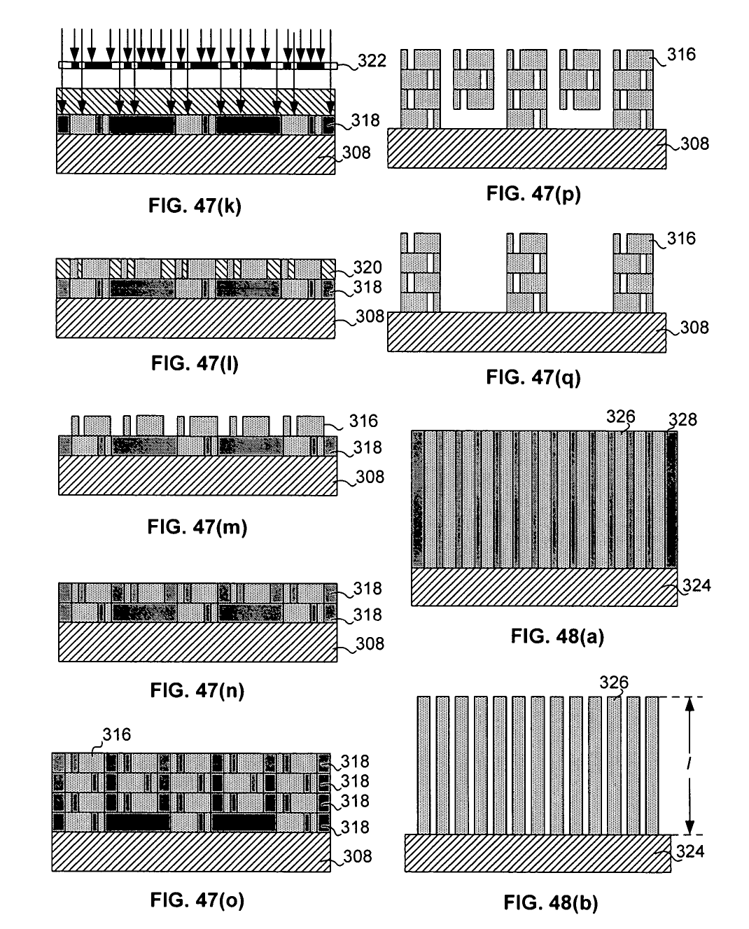

FIGS. 47(a)-(j) show another embodiment of the invention for fabricating customized arrays of devices without needing to use a different set of photomasks for each customized array configuration. The embodiment described below differs from the embodiment previously described in that a negative patternable mold material is used rather than a positive patternable mold material. Also, in the embodiment described below the structural material is deposited first and the sacrificial material is deposited second, whereas the reverse was true for the previously described embodiment.

As shown in FIG. 47(a), a substrate 308 is shown, onto which a negative patternable mold material 310 (for example, a negative photoresist) has been deposited as shown in FIG. 47(b). In FIG. 47(c), photomask 312 is used to expose patternable mold material 310 to form sets of apertures for forming a full array of five devices. Again, some embodiments of the invention are applicable to arrays having any number of devices. In FIG. 47(d), a second photomask 314 is used to again expose patternable mold material 310 such that two of the sets of apertures (shown by phantom lines in FIG. 47(e)) will not be formed. In FIG. 47(f), a first material 316 (e.g., nickel) has been formed in the apertures patterned in patternable mold material 310 and planarization has been performed if necessary. In FIG. 47(g), patternable mold material 310 has been removed. In FIG. 47(h), a second material 318 (e.g., copper) has been blanket deposited over exposed portions of substrate 308 and first material 316. In FIG. 47(i), planarization has been performed. In FIG. 47(j), a second layer of negative patternable mold material 320 has been deposited. As shown in FIG. 47(k), photomask 322 is used to pattern patternable mold material 320 in order to form an array of five devices. According to the exemplary embodiment, a second masking step is not performed on the second layer of devices, as was done on the first layer. However, according to other embodiments such a second masking step may be performed with a custom photomask if desired. In FIG. 47(l), a second layer of first material 316 has been formed in the apertures that have been patterned in patternable mold material 320 and a planarization step has been performed if necessary. In FIG. 47(m), patternable mold material 320 has been removed. In FIG. 47(n), a second layer of second material 318 has been formed and planarization has been performed. In FIG. 47(o), two additional layers of first material 316 and second material 318 have been formed in the same manner.

In FIG. 47(p), second material 318 has been removed, including portions on which the two devices patterned for removal during the second exposure step (shown in FIG. 47(d)) have been formed. Because the portions of second material 318 supporting these two devices are removed, the devices themselves will also be separated from substrate 290, as shown. In FIG. 47(q), an array of devices having a selected configuration has been formed.

Thus, according to some embodiments of the invention, a first set of photomasks is used to fabricate a full array of structures. A second photomask is then used to selectively remove particular ones of the structures from the full array by creating a delamination condition for the selected structures by forming the selected structures on a sacrificial material that will be removed from the substrate. When the sacrificial material is removed, the selected structures are removed from the full array of structures.

According to some alternative embodiments of the invention, rather than double exposing the patternable mold material, a simultaneous exposure may be performed in which one or more photomasks of the set used to fabricate a full array of structures is exposed in series with a second photomask. In this case, the two masks may be aligned to each other as well as to the substrate. To do this, one mask may be put into the mask aligner (not shown) as is normally done. The other mask may then be put onto the substrate chuck (not shown) in order to align the two masks with one another. The two masks may be put in contact with one another and then clamped in the mask aligner. According to yet other alternative embodiments of the invention, in lieu of a double exposure or simultaneous exposure using two photomasks to pattern the mold material for a given layer of a group of structures, a single customized photomask may be used to pattern a patternable mold material wherein the single photomask is used to pattern only the desired configuration of devices, again creating a delamination condition for selected structures.

FIG. 48(a) shows a substrate 324 on which a structural material 326 and a sacrificial material 328 have been formed. As shown in FIG. 48(b), when the sacrificial material 328 is removed, the remaining structural material 326 forms structures having a certain length l. According to some embodiments of the invention described above for fabricating customized arrays of devices, an interruption at a particular length in selected ones of the structures may be brought about through the use of the methods described above for creating customized arrays of devices.

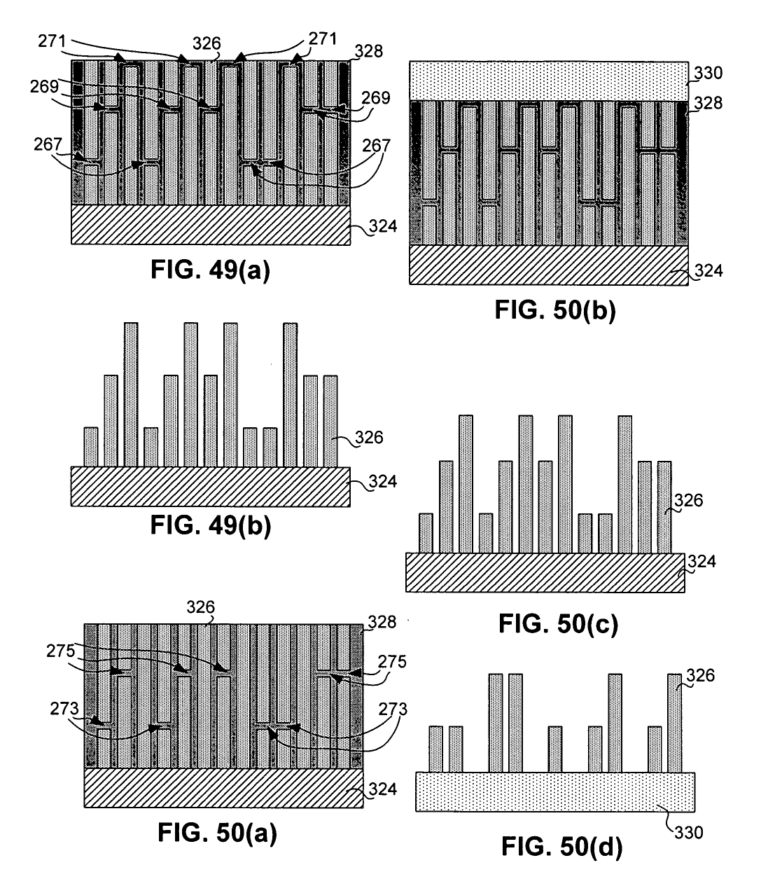

FIG. 49(a) shows a substrate 324 on which a structural material 326 and a sacrificial material 328 have been formed. According to some embodiments of the invention, interruptions are formed in the structural material using one or more of the methods described above for creating customized arrays of devices. As shown in FIG. 49(a), a first group of interruptions 267 is formed by patterning a first layer using either double exposure with two masks, simultaneous exposure with two masks, or a single mask customized for the layer, as described above. Then a second group of interruptions 269 is formed by patterning a second layer using one of the methods described above. Finally, a third group of interruptions 271 is formed by patterning a third layer using one of the methods described above. In FIG. 49(b), sacrificial material 328 has been removed, leaving behind structures of material 326 having varying lengths.

According to the embodiment of the invention shown in FIGS. 49(a)-(b), the portions of the structures that are removed may be discarded if attachment to a substrate is required for usability. According to an alternative embodiment shown in FIGS. 50(a)-(d), the portions removed may be preserved. FIG. 50(a) shows a substrate 324 on which a structural material 326 and a sacrificial material 328 have been formed. Interruptions are formed in the structural material using one or more of the methods described above for creating customized arrays of devices. As shown in FIG. 50(a), a first group of interruptions 273 is formed by patterning a first layer using either double exposure with two masks, simultaneous exposure with two masks, or a single mask customized for the layer, as described above. Then a second group of interruptions 275 is formed by patterning a second layer using one of the methods described above.

In FIG. 50(b), a second substrate 330 is added on a side of the build of layers opposite from the substrate 324 before sacrificial material 328 is removed. In FIG. 50(c), substrate 324 is shown after removal of sacrificial material 328 and has structures of varying length. In FIG. 50(d), substrate 330 is shown after removal of sacrificial material 328 and has structures of varying length. The structures on substrate 330 are complementary to those on substrate 324.

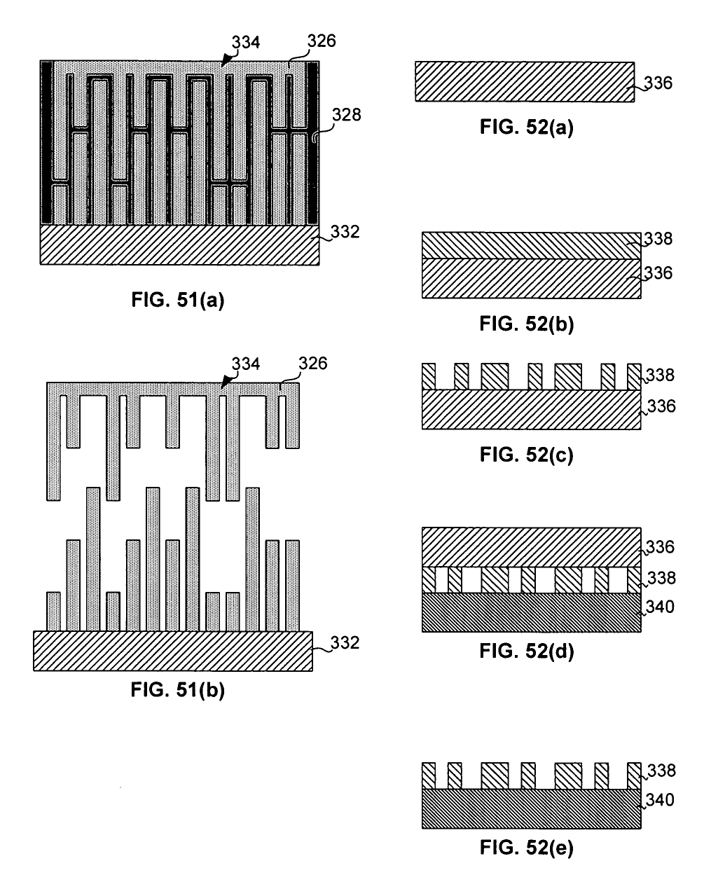

According to some embodiments of the invention shown in FIGS. 51(a)-(b), a tie may be formed in the structural material to hold together the portions of the structural material that are removed. FIG. 51(a) shows a substrate 332 on which a structural material 326 and a sacrificial material 328 have been formed. According to some embodiments of the invention, a tie 334 is formed in at least one layer (e.g., a final layer as shown here) of the build of layers such that when the sacrificial material 328 is removed as shown in FIG. 51(b), the tie 334 holds together what would have otherwise been individual portions of the structural material 326. This may be advantageous in preventing individual portions of the removed structural material 326 from becoming tangled with portions remaining on substrate 332 during the process for removing the sacrificial material 328. A chuck such as a vacuum chuck or a magnetic chuck may be attached to the tie 334 either before or after removal of sacrificial material 328 in order to pull away the removed structural material 326.

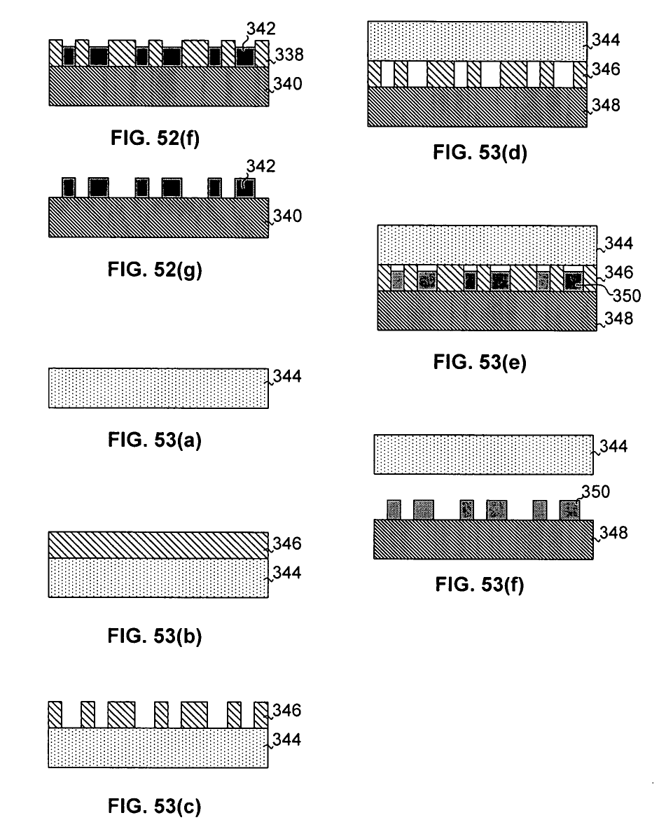

FIGS. 52(a)-(g) show an embodiment of the invention for pre-patterning a patternable mold material on a temporary substrate before using the temporary substrate to form a pattern for depositing other materials on a separate substrate. FIG. 52(a) shows temporary substrate 336. Patternable mold material 338 is formed on temporary substrate 336, as shown in FIG. 52(b). In FIG. 52(c), patternable mold material 338 has been patterned. In FIG. 52(d), temporary substrate 336 and patternable mold material 338 have been turned over and bonded (for example, by adhesion or re-lamination) to a separate substrate 340. In FIG. 52(e), temporary substrate 336 has been removed (e.g., by peeling off or dissolving). In FIG. 52(f), material 342 is formed in apertures resulting from the patterning of patternable mold material 338. In FIG. 52(g), patternable mold material 338 has been removed.

Thus, according to the above-described embodiment, a pattern may be transferred from a temporary substrate to a substrate on which layers will be built by temporarily bonding a patternable mold material to the temporary substrate and then bonding the patternable mold material to the build substrate and removing the temporary substrate. According to some embodiments of the invention, the patternable mold material may be a dry film resist that will mechanically interlock with and/or chemically bond with a surface of the temporary substrate and the build substrate. The temporary substrate may be chosen such that it does not have good adhesion properties with respect to the patternable mold material used. The temporary substrate may be, for example, teflon®, SYTOP® or polypropylene or may be a sacrificial material that may be dissolved. According to embodiments wherein the patternable mold material is a dry film resist, the backing material of the dry film resist may be adhered to the temporary substrate or may serve as the temporary substrate while the dry film resist is exposed and developed. Then, the backing may be removed, along with any additional temporary substrate used.

FIGS. 53(a)-(f) show another embodiment of the invention for transferring a pattern from a temporary substrate to a build substrate. FIG. 53(a) shows temporary substrate 344. Temporary substrate 344 is a permeable substrate. Patternable mold material 346 is formed on temporary substrate 344, as shown in FIG. 53(b). In FIG. 53(c), patternable mold material 346 has been patterned. In FIG. 53(d), temporary substrate 344 and patternable mold material 346 have been turned over and bonded (for example, by adhesion or re-lamination) to a build substrate 348. In FIG. 53(e), material 350 has been formed through permeable temporary substrate 344 in apertures resulting from the patterning of patternable mold material 346. As shown in FIG. 53(e), according to some embodiments, material 350 may not completely fill the apertures in order to avoid welding the material 350 to the temporary substrate 344. In FIG. 53(f), temporary substrate 344 has been removed by dissolving or otherwise removing patternable mold material 346. The patternable mold material 346 may be removed, for example, by a stripper that passes through the permeable temporary substrate 344.

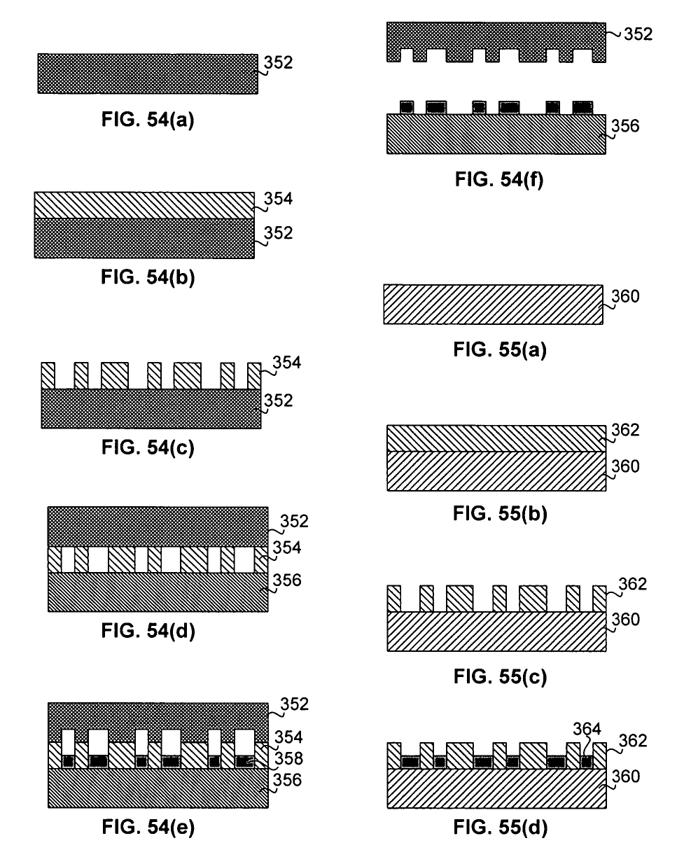

FIGS. 54(a)-(f) show another embodiment of the invention for transferring a pattern from a temporary substrate to a build substrate. FIG. 54(a) shows temporary substrate 352. Temporary substrate 352 may be a sacrificial anode formed from, for example, solid copper, or may have a coating of material such as copper. Patternable mold material 354 is formed on temporary substrate 352, as shown in FIG. 54(b). In FIG. 54(c), patternable mold material 354 has been patterned. In FIG. 54(d), temporary substrate 352 and patternable mold material 354 have been turned over and bonded (for example, by adhesion or re-lamination) to a build substrate 356.

In FIG. 54(e), material 358 has been formed in apertures resulting from the patterning of patternable mold material 354 during a plating step wherein the temporary substrate 352 and build substrate 356 may be immersed in an electrodeposition tank (not shown) during a plating step. Material 358 is formed from the erosion of temporary substrate 352 during the plating step, as shown in FIG. 54(e). In FIG. 54(f), temporary substrate 352 has been removed after the plating step by removing patternable mold material 354. The patternable mold material 354 may be dissolved, for example, by a stripper applied to the sides of the build. According to alternative embodiments, temporary substrate 352 may be removed during a planarization step.

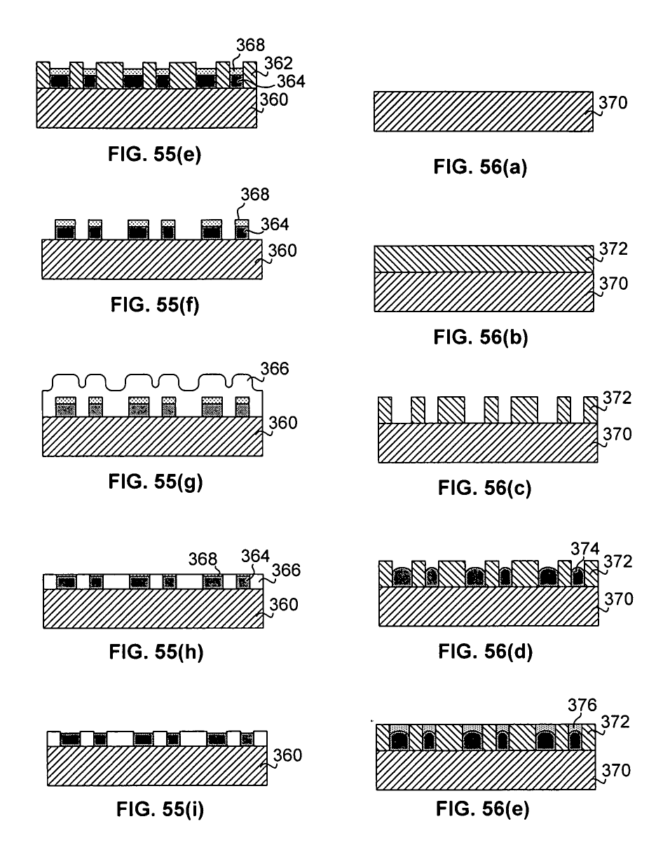

FIGS. 55(a)-(i) show an embodiment of the invention for depositing more than one material in an aperture formed in a patternable mold material such that a layered deposit of materials are formed on a single layer.

As shown in FIG. 55(a), a substrate 360 is shown, onto which patternable mold material 362 (for example, photoresist or solder mask) has been deposited as shown in FIG. 55(b). In FIG. 55(c), material 362 has been patterned (for example, if a photoresist, by use of a photomask, developing, etc., by laser direct imaging, a pattern generator and the like or, a combination of these methods) to produce apertures. In FIG. 55(d), a first material 364 is formed in the apertures resulting from the patterning step. In FIG. 55(e), a second material 368 is formed in the apertures over the first material 364. In FIG. 55(f), patternable mold material 362 has been removed. In FIG. 55(g), third material 366 is blanket deposited over exposed areas of substrate 360, first material 364 and second material 368. In FIG. 55(h), planarization has been performed.

According to some embodiments of the invention, first material 364 may be a soft material (for example, tin), while second material 368 may be a material that is harder than first material 364 (for example, nickel). In this manner, some embodiments of the invention allow a planarization step to be performed such that the second material 368 is planarized until just before the first material 364 is reached, as shown in FIG. 55(h). This advantageously allows the use of a softer material as the first material. The softer material will not be subjected to the rigors of planarization (which may lead to excessive smearing of the softer material, inclusions of abrasive, etc.) because it is coated with a harder material such that the harder material is planarized and not the softer material. After planarization, an etching step, for example, may be used to remove the remainder of the harder material, as shown in FIG. 55(i), leaving the softer material unexposed to planarization.

Although two materials are shown as being formed in the apertures in FIG. 55(e), some embodiments of the invention are equally applicable to forming any number of materials in the apertures before the patternable mold material is removed. Other applications for some embodiments of the invention for depositing more than one material in an aperture formed in a patternable mold material include, but are not limited to, forming devices having a superlattice of different materials, and forming alloys by using heat to inter-diffuse multiple materials deposited one above the above.

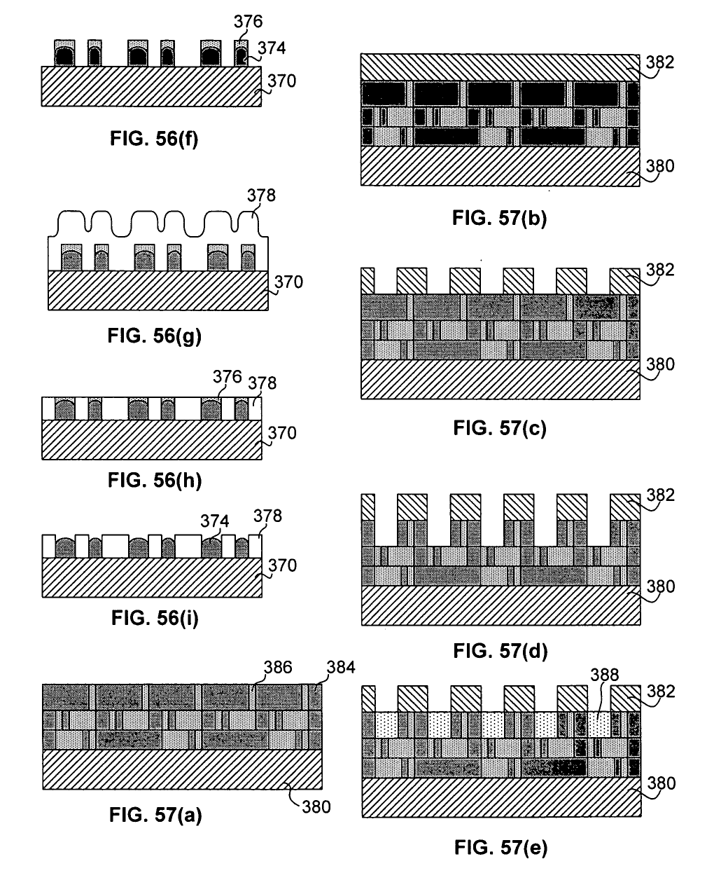

FIGS. 56(a)-(i) show an alternative embodiment of the invention for depositing more than one material in an aperture formed in a patternable mold material such that a layered deposit of materials are formed on a single layer. According to some embodiments of the invention, a first material may be deposited into an aperture and may have a top surface having a geometric shape or particular composition or microstructure which it is desirable to preserve during subsequent fabrication processes. Thus, a second material may be deposited into the aperture to coat the fist material and preserve the shape or composition of the first material during subsequent fabrication processes.

As shown in FIG. 56(a), a substrate 370 is shown, onto which patternable mold material 362 (for example, photoresist or solder mask) has been deposited as shown in FIG. 56(b). In FIG. 56(c), material 372 has been patterned (for example, if a photoresist, by use of a photomask, developing, etc., by laser direct imaging, a pattern generator and the like or, a combination of these methods) to produce apertures. In FIG. 56(d), a first material 374 is formed in the apertures resulting from the patterning step. It is assumed that first material 374 has a top surface that it is desirable to preserve for some reason, for example, one of the reasons discussed above. Therefore, in FIG. 56(e), a second material 376 is formed in the apertures over the first material 374. In FIG. 56(f), patternable mold material 372 has been removed. In FIG. 56(g), third material 378 is blanket deposited over exposed areas of substrate 370, first material 374 and second material 376. In FIG. 56(h), planarization has been performed. In FIG. 56(i), second material 376 has been removed, again exposing the first material 374 after the planarization step.

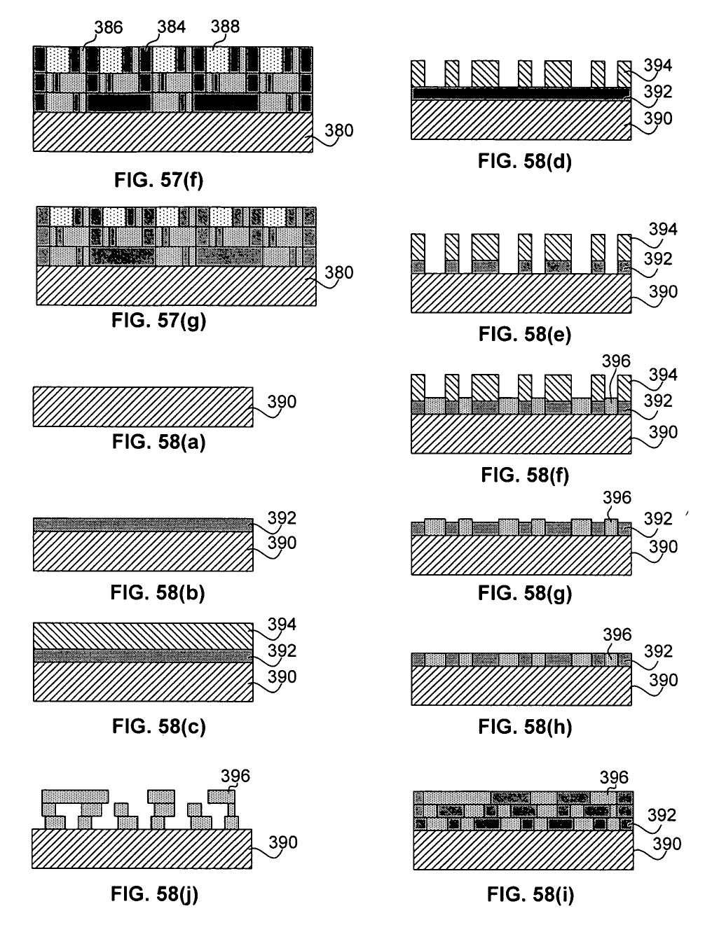

FIGS. 57(a)-(g) show an embodiment of the invention that uses a patternable mold material to perform a patterned etch. FIG. 57(a) shows three layers of two materials 384, 386 built on a substrate 380. The uppermost layer of the build is shown thicker than the first two layers because planarization has not yet been performed on the uppermost layer. In FIG. 57(b), patternable mold material 382 has been formed over the uppermost layer of the build. In FIG. 57(c), patternable mold material 382 has been patterned to form apertures. In FIG. 57(d), the apertures are used for etching cavities into a previously deposited material, which may be a sacrificial material or a structural material. In FIG. 57(e), the cavities are filled with a third material 388. In FIG. 57(f), patternable mold material 382 has been removed. In FIG. 57(g), planarization has been performed, if necessary.

Thus, some embodiments of the invention as described above may be used to perform a patterned etch of an existing material on a layer such that another material may be added to the layer. As shown in FIGS. 57(d)-(e), the patternable mold material 382 may be used both to etch the cavities and to define the deposition of the third material 388, which minimizes the amount of third material 388 that must be removed during planarization. According to other embodiments of the invention, patternable mold material 382 may be removed after the etching step. If electrodeposition is used to deposit the third material 388, any of the third material 388 formed above the upper level of the cavities may be removed in during planarization.

FIGS. 58(a)-(j) show an embodiment of the invention for using a patternable mold material both to etch a pattern in a first material and to plate a second material in the etched pattern.

As shown in FIG. 58(a), a substrate 390 is shown, onto which a first material 392 has been deposited as shown in FIG. 58(b). In FIG. 58(c), a patternable mold material 394 (for example a photoresist) has been deposited. In FIG. 58(d), material 394 has been patterned (for example, if a photoresist, by use of a photomask, developing, etc., by laser direct imaging, a pattern generator and the like or, a combination of these methods) to produce apertures. In FIG. 58(e), the apertures are used to etch first material 392, as shown. In FIG. 58(f), a second material 396 is formed in the cavities that have been etched in first material 392. Again, the patternable mold material may be used both to etch the cavities and to define the deposition of the third material so as to minimize the amount of third material that must be removed during planarization. In FIG. 58(g), patternable mold material 394 has been removed. In FIG. 58(h), planarization has been performed, if necessary.

It will be understood by those of skill in the art or will be readily ascertainable by them that various additional operations may be added to the processes set forth herein. For example, between performances of the various deposition operations, the various etching operations, and various planarization operations cleaning operations, activation operations, and the like may be desirable.

The patent applications and patents set forth below are hereby incorporated by reference herein as if set forth in full. The teachings in these incorporated applications can be combined with the teachings of the instant application in many ways: For example, enhanced methods of producing structures may be derived from some combinations of teachings, enhanced structures may be obtainable, enhanced apparatus may be derived, and the like.

| U.S. patent application Ser. No., Filing Date | |
|---|---|
| US App Pub No, Pub Date | Inventor, Title |
| 09/493,496 - Jan. 28, 2000 | Cohen, “Method For Electrochemical Fabrication” |
| 10/677,556 - Oct. 1, 2003 | Cohen, “Monolithic Structures Including Alignment |
| | and/or Retention Fixtures for Accepting Components” |
| 10/830,262 - Apr. 21, 2004 | Cohen, “Methods of Reducing Interlayer |
| | Discontinuities in Electrochemically Fabricated Three- |
| | Dimensional Structures” |
| XX/XXX,XXX - May 7, 2004 | Lockard, “Methods for Electrochemically Fabricating |
| (Docket P-US099-A-MF) | Structures Using Adhered Masks, Incorporating |
| | Dielectric Sheets, and/or Seed layers That Are |
| | Partially Removed Via Planarization” |
| 10/271,574 - Oct. 15, 2002 | Cohen, “Methods of and Apparatus for Making High |
| 2003-0127336A - Jul. 10, 2003 | Aspect Ratio Microelectromechanical Structures” |
| 10/697,597 - Dec. 20, 2002 | Lockard, “EFAB Methods and Apparatus Including |
| | Spray Metal or Powder Coating Processes” |
| 10/677,498 - Oct. 1, 2003 | Cohen, “Multi-cell Masks and Methods and Apparatus |
| | for Using Such Masks To Form Three-Dimensional |
| | Structures” |
| 10/724,513 - Nov. 26, 2003 | Cohen, “Non-Conformable Masks and Methods and |
| | Apparatus for Forming Three-Dimensional Structures” |
| 10/607,931 - Jun. 27, 2003 | Brown, “Miniature RF and Microwave Components and |
| | Methods for Fabricating Such Components” |
| XX/XXX,XXX - May 7, 2004 | Cohen, “Electrochemical Fabrication Methods |
| (Docket P-US093-A-MF) | Including Use of Surface Treatments to Reduce |
| | Overplating and/or Planarization During Formation of |
| | Multi-layer Three-Dimensional Structures” |
| 10/387,958 - Mar. 13, 2003 | Cohen, “Electrochemical Fabrication Method and |
| 2003-022168A - Dec. 4, 2003 | Application for Producing Three-Dimensional |
| | Structures Having Improved Surface Finish” |
| 10/434,494 - May 7, 2003 | Zhang, “Methods and Apparatus for Monitoring |
| 2004-0000489A - Jan. 1, 2004 | Deposition Quality During Conformable Contact Mask |
| | Plating Operations” |
| 10/434,289 - May 7, 2003 | Zhang, “Conformable Contact Masking Methods and |
| 20040065555A - Apr. 8, 2004 | Apparatus Utilizing In Situ Cathodic Activation of a |
| | Substrate” |
| 10/434,294 - May 7, 2003 | Zhang, “Electrochemical Fabrication Methods With |
| 2004-0065550A - Apr. 8, 2004 | Enhanced Post Deposition Processing Enhanced Post |
| | Deposition Processing” |
| 10/434,295 - May 7, 2003 | Cohen, “Method of and Apparatus for Forming Three- |
| 2004-0004001A - Jan. 8, 2004 | Dimensional Structures Integral With Semiconductor |
| | Based Circuitry” |
| 10/434,315 - May 7, 2003 | Bang, “Methods of and Apparatus for Molding |
| 2003-0234179 A - Dec. 25, 2003 | Structures Using Sacrificial Metal Patterns” |
| 10/434,103 - May 7, 2004 | Cohen, “Electrochemically Fabricated Hermetically |
| 2004-0020782A - Feb. 5, 2004 | Sealed Microstructures and Methods of and Apparatus |
| | for Producing Such Structures” |
| XX/XXX,XXX - May 7, 2004 | Thompson, “Electrochemically Fabricated Structures |
| (Docket P-US104-A-MF) | Having Dielectric or Active Bases and Methods of and |
| | Apparatus for Producing Such Structures” |
| 10/434,519 - May 7, 2003 | Smalley, “Methods of and Apparatus for |
| 2004-0007470A - Jan. 15, 2004 | Electrochemically Fabricating Structures Via Interlaced |
| | Layers or Via Selective Etching and Filling of Voids” |
| XX/XXX,XXX - May 7, 2004 | Cohen, “Multi-step Release Method for |
| (Docket P-US105-A-MF) | Electrochemically Fabricated Structures” |

Various other embodiments exist. Some of these embodiments may be based on a combination of the teachings herein with various teachings incorporated herein by reference. Some embodiments may not use any blanket deposition process and/or they may not use a planarization process. Some embodiments may involve the selective deposition of a plurality of different materials on a single layer or on different layers. Some embodiments may use blanket depositions processes that are not electrodeposition processes. Some embodiments may use selective deposition processes on some layers that are not even electrodeposition processes. Some embodiments may use one or more structural materials (for example nickel, gold, copper, or silver). Still other processes may use other materials whether or not electrodepositable. Some processes may use one or more sacrificial materials (for example copper). Some embodiments may use copper as the structural material with or without a sacrificial material. Some embodiments may remove a sacrificial material while other embodiments may not. Some embodiments may use conformable contact masks with different patterns so as to deposit different selective patterns of material on different layers and/or on different portions of a single layer.

In view of the teachings herein, many further embodiments, alternatives in design and uses are possible and will be apparent to those of skill in the art. As such, it is not intended that the invention be limited to the particular illustrative embodiments, alternatives, and uses described above but instead that it be solely limited by the claims presented hereafter.

1. A process for forming a multilayer three-dimensional structure, comprising:
(a) forming and adhering a layer of material to a substrate or previously formed layer; and
(b) repeating the forming and adhering operation of (a) a plurality of times to build up a three-dimensional structure from a plurality of adhered layers, where successive layers are adhered to previously formed layers;
wherein the formation of at least one layer comprises:
(i) forming and adhering a desired pattern of masking material on the substrate or previously formed layer, wherein the patterning of the masking material results in at least one void in the material that exposes a portion of the substrate or of a previously formed layer;
(ii) depositing a conductive material into the at least one void in the masking material; and
wherein the masking material comprises a dry film photoresist.

2. A process for forming a multilayer three-dimensional structure, comprising:
(a) forming and adhering a layer of material to a substrate or previously formed layer; and
(b) repeating the forming and adhering operation of (a) a plurality of times to build up a three-dimensional structure from a plurality of adhered layers, where successive layers are adhered to previously formed layers;
wherein the formation of at least one layer comprises:
(i) forming and adhering a desired pattern of masking material on the substrate or previously formed layer, wherein the patterning of the masking material results in at least one void in the material that exposes a portion of the substrate or of a previously formed layer;
(ii) depositing a conductive material into the at least one void in the masking material; and
wherein the formation of the at least one layer additionally comprises removing the masking material, depositing a second material, and planarizing the deposited first and second materials to a desired height.

3. A process for forming a multilayer three-dimensional structure, comprising:
(a) forming and adhering a layer of material to a substrate or previously formed layer; and
(b) repeating the forming and adhering operation of (a) a plurality of times to build up a three-dimensional structure from a plurality of adhered layers, where successive layers are adhered to previously formed layers;
wherein the formation of at least one layer comprises:
(i) forming and adhering a desired pattern of masking material on the substrate or previously formed layer, wherein the patterning of the masking material results in at least one void in the material that exposes a portion of the substrate or of a previously formed layer;
(ii) depositing a conductive material into the at least one void in the masking material; and
wherein the formation of the at least one layer additionally comprises removing the masking material and depositing a dielectric material, and wherein the formation of a subsequent layer comprises depositing a seed layer on at least a portion of the at least one layer.

4. A process for forming a multilayer three-dimensional structure, comprising:
(a) forming and adhering a layer of material to a substrate or previously formed layer; and
(b) repeating the forming and adhering operation of (a) a plurality of times to build up a three-dimensional structure from a plurality of adhered layers, where successive layers are adhered to previously formed layers;
wherein the formation of at least one layer comprises:
(i) forming and adhering a desired pattern of masking material on the substrate or previously formed layer, wherein the patterning of the masking material results in at least one void in the material that exposes a portion of the substrate or of a previously formed layer;
(ii) depositing a conductive material into the at least one void in the masking material; and
wherein the formation of the at least one layer additionally comprises depositing a seed layer on the substrate, or previously formed layer, which comprises only conductive material, prior to forming and adhering the mask material.

5. A process for forming a multilayer three-dimensional structure, comprising:
(a) forming and adhering a layer of material to a substrate or previously formed layer; and
(b) repeating the forming and adhering operation of (a) a plurality of times to build up a three-dimensional structure from a plurality of adhered layers, where successive layers are adhered to previously formed layers;
wherein the formation of at least one layer comprises:
(i) forming and adhering a desired pattern of masking material on the substrate or previously formed layer, wherein the patterning of the masking material results in at least one void in the material that exposes a portion of the substrate or of a previously formed layer;
(ii) depositing a conductive material into the at least one void in the masking material; and
wherein the at least one layer, after it is completed, comprises at least three different materials located in different lateral positions on the layer.

6. A process for forming a multilayer three-dimensional structure, comprising:
(a) forming and adhering a layer of material to a substrate or previously formed layer; and
(b) repeating the forming and adhering operation of (a) a plurality of times to build up a three-dimensional structure from a plurality of adhered layers, where successive layers are adhered to previously formed layers;
wherein the formation of at least one layer comprises:
(i) forming and adhering a desired pattern of masking material on the substrate or previously formed layer, wherein the patterning of the masking material results in at least one void in the material that exposes a portion of the substrate or of a previously formed layer;
(ii) depositing a conductive material into the at least one void in the masking material; and
wherein the formation of the at least one layer additionally comprises optically aligning a position of the patterning of the dielectric material by using a focused image of an alignment mark that is located at on least one of (1) the substrate, (2) a carrier on which the substrate sits, or (3) previously deposited material that is located on the substrate.

7. A system for electrodepositing layers of material on a substrate, the system comprising:
an electrodeposition tank having electrodeposition bath therein;
a carrier acting as a first electrode having a first polarity, the carrier having a carrier body to which the substrate is electrically connected, the substrate being immersed in the electrodeposition tank;
a second electrode having a second polarity opposite from the first polarity, the second electrode being immersed in the electrodeposition tank; and
a power source electrically connected to the carrier and the second electrode such that material from the second electrode is electrodeposited onto the substrate through the electrodeposition bath.

8. The system of claim 7, wherein the substrate is affixed to the carrier body.

9. The system of claim 8, wherein the substrate is affixed to the carrier body by a solidifiable adhesive material.

10. The system of claim 8, wherein the substrate is affixed to the carrier body by a mechanical bond.

11. The system of claim 7, wherein the carrier body has a surface that provides a reference for controlling a thickness of the one or more layers of material deposited on the substrate.

12. The system of claim 7, wherein the carrier body is perforated by at least one aperture formed through the carrier body, wherein the substrate is bonded to the carrier body by a material formed in the at least one aperture.

13. The system of claim 7, wherein the carrier body comprises a fixed datum surface for measuring a thickness of the one or more layers of material.

14. The system of claim 7, wherein a material previously deposited on portions of the carrier body form a floor of the electrodeposition tank.

15. The system of claim 7, the carrier body comprises a surface having a recess therein for receiving the substrate such that a surface of the substrate is made parallel to the surface of the carrier body.

16. The system of claim 7, wherein the carrier body comprises alignment targets for aligning photomasks used in subsequently patterning the one or more layers of material.

17. The system of claim 7, wherein the carrier body is formed from a conductive material.

18. The system of claim 7, wherein the carrier body comprises a conductive material on at least a portion of the carrier body.

19. The system of claim 7, wherein the substrate is formed from a conductive material.

20. The system of claim 7, wherein the substrate is coated with a conductive material on at least a portion of the substrate.

21. The system of claim 7, wherein the carrier body comprises a contacting member for making electrical contact with the substrate on at least one surface of the substrate.

22. The system of claim 7, wherein a material previously formed on the carrier body forms a seal with the electrodeposition tank which prevents electrodeposition onto any portion the carrier body other than the sealing material.

23. A system for controlling thickness of layers formed on a substrate, comprising:
a carrier for holding the substrate during formation of one or more layers of material on the substrate, the carrier comprising a carrier body having a surface that provides a reference for measuring a thickness of the one or more layers of material formed on the substrate; and
a planarization fixture for supporting the carrier body during planarization of the one or more layers of material, the planarization fixture having at least one surface adapted to mate with the reference surface of the carrier body such that surfaces of the one or more layers of material formed on the substrate are parallel to the reference surface after planarization.

24. The system of claim 23, further comprising measurement indicators for measuring a thickness of the one or more layers of material formed on the substrate based on the reference surface.

25. The system of claim 24, wherein the measurement indicators measure the thickness by comparing a position of the reference surface to a position of a surface of the one or more layers of material formed on the substrate.

26. The system of claim 25, wherein a plurality of measurement indicators are placed at various radii from a center of the substrate to measure the thickness.

27. The system of claim 25, wherein the measurement indicators are sensors.

28. The system of claim 27, wherein the measurement indicators are dial indicators.

29. The system of claim 27, wherein the measurement indicators are LVDT (linear variable differential transformer)-based distance gauges.

30. The system of claim 27, wherein the measurement indicators are non-contact sensors based on at least one of light, eddy currents, and capacitance.

31. The system of claim 27, wherein the planarization fixture comprises:
moveable stages having thereon the at least one surface adapted to mate with the reference surface of the carrier body; and
a planarization plate for planarizing a surface of the one or more layers of material formed on the substrate, the planarization plate being parallel to the carrier body when the carrier body is supported by the moveable stage.

32. The system of claim 31, wherein the moveable stages comprise coplanar stops parallel with the at least one surface adapted to mate with the reference surface such that the surface of the one or more layers of material formed on the substrate becomes parallel to the reference surface after planarization.

33. The system of claim 32, wherein the coplanar stops are supported by the planarization plate.

34. The system of claim 31, wherein the moveable stages are adapted to raise and lower the carrier body in directions perpendicular to the planarization plate.

35. The system of claim 31, wherein the moveable stages comprise two moveable stages located on opposite one another.

36. The system of claim 32, wherein the coplanar stops are aligned to be parallel with the at least one surface adapted to mate with the reference surface using an autocollimator.

37. The system of claim 36, wherein the alignment is done when the carrier body is supported by the at least one surface adapted to mate with the reference surface.

38. The system of claim 31, wherein the planarization plate comprises a lapping plate formed from at least one of copper, tin-antimony, cast iron, and copper-resin composite.

39. A method for aligning targets, comprising:
providing a first imaging device for focusing on a first target to produce a first image;
providing a second imaging device for focusing on a second target to produce a second image; and
comparing the first and second images to determine a degree of misalignment between the first and second targets.

40. The method of claim 39, further comprising recording the first and second images.

41. The method of claim 39, wherein optical axes of the first and second imaging devices are not coaxial.

42. The method of claim 39, wherein comparing the first and second images comprises superimposing the first image on the second image.

43. A method for determining a priority for forming a sacrificial material and a structural material on a substrate, comprising:
(a) analyzing features to be formed on the substrate;
(b) determining whether a feature to be formed on the substrate has a predefined characteristic;
(c) determining whether a feature determined in (b) to have the predefined characteristic is a positive feature or a negative feature;
(d) forming the structural material first if it is determined in (c) that the feature is a negative feature; and
(e) forming the sacrificial material first if it is determined in (c) that the feature is a positive feature.

44. The method of claim 43, wherein the predefined characteristic is a minimum feature size.

45. The method of claim 43, wherein the predefined characteristic is an aspect ratio.

46. A method for forming both small positive and negative features in the same layer of a substrate, comprising:
(a) depositing a first patternable mold material on the layer;
(b) patterning the first patternable mold material to form a first pattern;
(c) depositing a first material in the first pattern formed in (b);
(d) removing the first patternable mold material to expose areas of the layer not having the first material deposited thereon;
(e) depositing a second patternable mold material over the layer;
(f) patterning the second patternable mold material to form a second pattern;
(g) depositing a second material in the second pattern formed in (f);
(h) removing the second patternable mold material to expose areas of the layer not having the first or second materials deposited thereon;
(i) blanket depositing the first material over the second material and the exposed areas of the layer; and
(j) planarizing the layer.

47. The method of claim 46, wherein depositing first and second materials comprises depositing the first and second materials by electrodeposition.

48. The method of claim 46, wherein the first and second materials are metals.

49. The method of claim 46, wherein the first material is copper and the second material is nickel.

50. A method for forming more than two materials on the same layer, comprising:
(a) depositing a first patternable mold material on the layer;
(b) patterning the first patternable mold material to form a first pattern;
(c) depositing a first material in the first pattern formed in (b);
(d) removing the first patternable mold material to expose areas of the layer not having the first material deposited thereon;
(e) depositing a second patternable mold material over the layer;
(f) patterning the second patternable mold material to form a second pattern;
(g) depositing a second material in the second pattern formed in (f);
(h) removing the second patternable mold material to expose areas of the layer not having the first or second materials deposited thereon;
(i) blanket depositing a third material over the second material and the exposed areas of the layer; and
(j) planarizing the layer.

51. The method of claim 50, wherein depositing first, second and third materials comprises depositing the first, second and third materials by electrodeposition.

52. The method of claim 50, wherein the first, second and third materials are metals.

53. The method of claim 50, wherein the first material is copper, the second material is nickel and the third material is silver.

54. A method for preparing a layer having formed thereon a feature consisting of a first material for deposition of a second material adjacent to the first material, comprising:
(a) depositing a patternable mold material over the first material; and
(b) patterning the patternable mold material to form an aperture adjacent to the first material, the aperture exposing a side portion and a top portion of the first material.

55. A method for forming an alignment target on a substrate, comprising:
forming a first patternable mold material on the substrate;
patterning the first patternable mold material to form a first aperture;
forming a first material in the first aperture to form an alignment target within the first aperture;
removing the first patternable mold material;
forming a second patternable mold material on the substrate so as to cover the alignment target; and
forming the second patternable mold material to form a second aperture wider than and fully enclosing the alignment target.

56. The method of claim 55, further comprising forming a non-conductive material in the second aperture such that the alignment target is enclosed in the non-conductive material.

57. The method of claim 56, further comprising forming a non-adherent material over the non-conductive material.

58. The method of claim 55, wherein forming the first material in the aperture comprises forming the first material by electrodeposition.

59. The method of claim 56, wherein forming the non-conductive material comprises forming the non-conductive material by electrodeposition.

60. The method of claim 57, wherein forming the non-adherent material comprises forming the non-adherent material by electrodeposition.

61. The method of claim 56, wherein forming the non-conductive material comprises forming the non-conductive material by blanket depositing and etching the non-conductive material.

62. The method of claim 57, wherein forming the non-adherent material comprises forming the non-adherent material by depositing and etching the non-adherent material.

63. The method of claim 56, wherein forming the first material in the aperture comprises forming the first material by electrodeposition.

64. The method of claim 56, wherein forming the first material in the aperture comprises forming the first material by depositing and etching the non-adherent material.

65. A method for electroplating a layer of material on a substrate, comprising:
forming a conductive layer over a non-conductive surface of the substrate;
forming a target in the conductive layer such that the target is electrically isolated from the remainder of the conductive layer by the non-conductive surface of the substrate; and
electroplating the layer of material over the conductive layer such that the conductive layer is plated and the target is un-plated.

66. A method for patterning odd and even layers of patternable material formed sequentially on a substrate, comprising:
patterning the odd layers using first photomasks having a first layout of alignment shapes and new target shapes, the first layout having a first orientation relative to the substrate; and
patterning the even layers using second photomasks having a second layout of alignment shapes and new target shapes, the second layout having a second orientation relative to the substrate different from the first orientation.

67. The method of claim 66, wherein the second orientation is 180 degrees opposite the first orientation.

68. A method for forming layers on a substrate, comprising:
providing a first patternable mold material of a first type to be used in forming a first layer on the substrate; and
providing a second patternable mold material of a second type used in forming a second layer on the substrate.

69. The method of claim 68, wherein the first type of patternable mold material is a dry film photoresist and the second type of patternable mold material is a liquid photoresist.

70. The method of claim 68, wherein the first type of patternable mold material is a positive photoresist and the second type of patternable mold material is a negative photoresist.

71. A method for forming layers on a substrate, comprising:
forming a first layer of a patternable mold material on the substrate;
forming at least one additional layer of the patternable mold material on the first layer; and
patterning the first layer and the at least one additional layer.

72. A method for forming on a surface a layer of material having an object incorporated therein, the method comprising:
forming a first layer of patternable mold material on a first surface;
forming a first aperture in the first layer of patternable mold material for receiving an object;
placing the object in the first aperture; and
forming a first material in the first aperture such that the first material encases the object.

73. The method recited in claim 72, further comprising:
removing the first layer of patternable mold material;
forming a first layer of second material on the first surface adjacent to the first material encasing the object; and
removing the first material.

74. The method recited in claim 73, further comprising planarizing the first and second materials before removing the first material.

75. The method recited in claim 74, wherein the first and second materials are planarized such that upper surfaces of both the first and second materials are above an upper level of the object.

76. The method recited in claim 74, wherein the first and second materials are planarized to a level such that an upper portion of the object is planarized.

77. The method recited in claim 72, wherein forming a first material in the first aperture comprises:
forming a second layer of patternable mold material over the first layer of patternable mold material;
forming a second aperture in the second layer of patternable mold material; and
depositing the first material through the second aperture into the first aperture.

78. The method recited in claim 72, wherein placing the object in the first aperture comprises flowing the object onto a surface of the first layer of patternable mold material such that the object falls into the first aperture.

79. The method recited in claim 72, wherein placing the object in the first aperture comprises rolling the object onto a surface of the first layer of patternable mold material such that the object falls into the first aperture.

80. The method recited in claim 72, wherein the object comprises one of a plurality of objects and wherein placing the object in the first aperture comprises pouring the plurality of objects onto a surface of the first layer of patternable mold material such that the object falls into the first aperture.

81. The method recited in claim 80, wherein ones of the plurality of objects not falling into the first aperture are removed from the surface of the first layer of patternable mold material.

82. The method recited in claim 72, wherein placing the object in the first aperture comprises using a pick and place machine to place the object into the first aperture.

83. The method recited in claim 72, wherein placing the object in the first aperture comprises:
forming a second layer of patternable mold material over the first layer of patternable mold material;
forming a second aperture in the second layer of patternable mold material; and
forcing the object through the second aperture into the first aperture.

84. The method recited in claim 73, wherein forming a first layer of second material around the first material encasing the object comprises:
forming a second layer of patternable mold material on the first surface;
forming apertures in the second layer of patternable mold material;
forming a third material in the apertures in the second layer of patternable mold material;
removing the second layer of patternable mold material to expose areas of the first surface not covered by the third material; and
depositing the second material over the exposed areas of the first surface, the first material and the third material.

85. The method recited in claim 84, wherein the third material is the same as the first material.

86. The method recited in claim 73, further comprising forming a second layer of second material over the first layer of second material such that the object is secured within the first layer of second material by the second layer of second material.

87. The method recited in claim 72, wherein the object comprises at least one of a sphere, an integrated circuit, a lens, a mirror, a fiber optic strand and a needle probe.

88. A structure formed on a substrate, comprising a plurality of layers of structural material formed one over another, at least one of the plurality of layers having an object incorporated therein.

89. The structure recited in claim 88, wherein the object comprises at least one of a sphere, an integrated circuit, a lens, a mirror, a fiber optic strand and a needle probe.

90. A method for forming a structure on a surface, comprising:
building a plurality of layers on the surface, the plurality of layers including both a structural material and a sacrificial material; and
after building the plurality of layers, removing the sacrificial material from the plurality of layers;
wherein the sacrificial material is a patternable mold material.

91. A method for forming a structure on a surface, comprising:
forming a first layer of patternable mold material;
patterning first apertures in the first layer of patternable mold material;
depositing a first structural material into the first apertures;
forming a second layer of patternable mold material over the first layer of patternable mold material and the first structural material;
patterning second apertures into the second layer of patternable mold material; and
depositing a second structural material into the second apertures.

92. The method recited in claim 91, further comprising removing the first and second layers of patternable mold material.

93. The method recited in claim 91, wherein the first structural material is the same as the second structural material.

94. The method recited in claim 91, further comprising:
forming a third layer of patternable mold material over the second layer of patternable mold material and the second structural material;
patterning third apertures into the third layer of patternable mold material; and
depositing a third structural material into the third apertures.

95. The method recited in claim 94, further comprising removing the first, second and third layers of patternable mold material.

96. The method recited in claim 94, wherein the first structural material, the second structural material and the third structural material are the same material.

97. A method for forming structures and dicing lanes on a substrate, comprising:
forming a first layer of patternable mold material on a surface;
patterning first apertures in the first layer of patternable mold material;
forming a first material in the first apertures; and
removing the first layer of patternable mold material to expose portions of the surface, a plurality of the exposed portions of the surface functioning as dicing lanes.

98. The method recited in claim 97, further comprising:
forming a second layer of patternable mold material over the first material and the exposed portions of the surface;
patterning the second layer of patternable mold material to remove portions of the second layer of patternable mold material not covering the plurality of the exposed portions of the surface functioning as dicing lanes; and
forming a second material on exposed portions of the surface not functioning as dicing lanes.

99. The method recited in claim 98, further comprising removing remaining portions of the second layer of patternable mold material not removed during the patterning of the second layer of patternable mold material.

100. A method for forming an array of structures, comprising:
forming a first layer of patternable mold material on a surface;
exposing the first layer of patternable mold material using a first photomask to form a first pattern of soluble and insoluble portions of the first layer of patternable mold material, the first pattern for forming an array of structures having a first number of structures; and
exposing the first pattern using a second photomask different from the first photomask to form a second pattern of soluble and insoluble portions of the first layer of patternable mold material from the first pattern, the second pattern for forming an array of structures having a second number of structures different from the first number of structures.

101. The method recited in claim 100, further comprising:
removing the soluble portions of the first layer of patternable mold material to form first apertures in the first layer of patternable mold material; and
forming a first material in the first apertures.

102. The method recited in claim 101, further comprising:
removing the insoluble portions of the first layer of patternable mold material to form second apertures; and
forming a second material in the second apertures.

103. The method recited in claim 102, further comprising planarizing the first and second materials.

104. The method recited in claim 100, wherein the patternable mold material is a positive patternable mold material.

105. The method recited in claim 100, wherein the patternable mold material is a negative patternable mold material.

106. The method recited in claim 102, wherein the first material is a structural material and the second material is a sacrificial material.

107. The method recited in claim 102, wherein the first material is a sacrificial material and the second material is a structural material.
